(19) United States
(12) Patent Application Publication
(10) Pub. No.: US 2026/0332741 A1
(43) Pub. Date: Oct. 22, 2026

(54) CONTROL METHOD FOR A DISPLAY MODULE, CONTROL APPARATUS FOR A DISPLAY MODULE, AND NEAR-EYE DISPLAY APPARATUS

(71) Applicant: GYGES LABS PTE. LTD., SINGAPORE (SG)

(72) Inventors: Xiongxiong ZHENG, Shenzhen (CN); Shiwen QIU, Shenzhen (CN); Jieyang JIA, Shenzhen (CN); Xudong DENG, Shenzhen (CN); Xiaosha CHEN, Shenzhen (CN); Yingnan ZHAI, Shenzhen (CN); Yanzhi CHEN, Shenzhen (CN); Yewei XIAO, Shenzhen (CN); Can YE, Shenzhen (CN); Zheng LYU, Shenzhen (CN)

(21) Appl. No.: 19/678,636

(22) Filed: May 15, 2026

Related U.S. Application Data
(63) Continuation of application No. PCT/CN2024/131310, filed on Nov. 11, 2024.

(30) Foreign Application Priority Data
Nov. 17, 2023 (CN) 2023115480693
Nov. 22, 2023 (CN) 2023115809662
Dec. 15, 2023 (CN) 2023117335355
Dec. 29, 2023 (CN) 2023118679567
Dec. 29, 2023 (CN) 2023118680668
Jan. 17, 2024 (CN) 2024201197317
Apr. 30, 2024 (CN) 2024105440675

(51) Int. Cl. H04N 13/398; G06F 1/3234; G06F 3/04842; G06F 3/0488; H04N 13/00; H04N 13/383

(52) U.S. Cl. CPC H04N 13/398; G06F 1/3265; G06F 3/04842; G06F 3/0488; H04N 13/383; H04N 2013/0085; H04N 2213/008

(57) ABSTRACT

A control method for a display module, a control apparatus, and a near-eye display device are provided. The control method for the display module includes: monitoring a motion state of the display module on a currently connected lens; controlling the display module to display a graphical interface corresponding to a target logical function on the lens when a target motion state is detected. The target motion state is preset as a trigger condition for triggering the target logical function.

### CROSS-REFERENCE TO RELATED APPLICATIONS

This disclosure is a continuation of International Patent Application No. PCT/CN2024/131310 filed on Nov. 11, 2024, which claims priority to Chinese Patent Application No. 202311548069.3, filed with China National Intellectual Property Administration on Nov. 17, 2023 and entitled “Near-Eye Display Module and Apparatus”; to Chinese Patent Application No. 202311580966.2, filed with China National Intellectual Property Administration on Nov. 22, 2023 and entitled “Optical Module, Near-Eye Display Apparatus and Processing Method for an Optical Module”; to Chinese Patent Application No. 202311733535.5, filed with China National Intellectual Property Administration on Dec. 15, 2023 and entitled “Control Method for a Display Module, Near-Eye Display Apparatus, Electronic Device and Medium”; to Chinese Patent Application No. 202311868066.8, filed with China National Intellectual Property Administration on Dec. 29, 2023 and entitled “Control Method for a Display Module and Near-Eye Display Apparatus”; to Chinese Patent Application No. 202311867956.7, filed with China National Intellectual Property Administration on Dec. 29, 2023 and entitled “Control Method for a Display Module and Near-Eye Display Apparatus”; to Chinese Patent Application No. 202420119731.7, filed with China National Intellectual Property Administration on Jan. 17, 2024 and entitled “Near-Eye Display Device and Charging Case”; and to Chinese Patent Application No. 202410544067.5, filed with China National Intellectual Property Administration on Apr. 30, 2024 and entitled “Near-Eye Display Apparatus and Control Method, and Near-Eye Display System”, the entire contents of which are incorporated herein by reference.

### TECHNICAL FIELD

The present disclosure belongs to the technical field of near-eye display, and in particular, relates to a control method for a display module, a control apparatus for a display module, and a near-eye display apparatus.

### BACKGROUND

Near-eye display refers to display at a short display distance from the eyes for sensory perception. For example, both Virtual Reality (VR) glasses and Augmented Reality (AR) glasses perform display at a short distance from the eyes. That is to say, near-eye display is a relative concept compared with conventional devices such as televisions and displays. As is generally known, a display distance from a display panel of conventional devices such as televisions and displays to the eyes is much longer than a display distance of near-eye display devices such as VR glasses or AR glasses.

Currently, near-eye display can be divided into VR, AR, Mixed Reality (MR) and Extended Reality (XR).

VR, also known as computer-simulated reality, is an experience created by human-computer interaction and computer-generated three-dimensional simulation. A user may interact with the environment by using virtual reality devices such as headsets and controllers. That is, VR is a computer simulation system capable of creating and enabling the user to experience a virtual world, and it utilizes a computer to generate a simulated environment and immerses the user in the environment.

AR is real-time direct or indirect observation of the physical environment of the real world. It blends content seen by a user in the real environment with digital content generated by computer software to enhance the real environment in which the user is located in a certain manner. An AR system transmits virtual information to a headset, smart glasses or a mobile device in real time via a camera, enabling the user to clearly view 3D images.

MR is the fusion of the real world and the virtual world to generate a new environment and visualization, in which physical objects and digital objects coexist and interact in real time. This means that if a new image is placed in the real space, the new image will interact with real objects in the real environment to a certain extent.

XR refers to the combination of all real and virtual environments generated by computer technology and wearable devices, as well as human-computer interaction. XR enhances human senses through digitization to fuse the real and virtual worlds. In addition, it provides virtual sensor input levels of multiple grades for immersive virtual experience. XR includes the above three emerging technologies, namely VR, AR and MR.

### SUMMARY

In a first aspect of embodiments of the present disclosure, a control method for a display module is provided. The display module is configured to be connected to an optical lens and configured to output image content. The method includes:
monitoring a motion state of the display module on a currently connected lens; and
controlling the display module to display a graphical interface corresponding to a target logical function on the lens when a target motion state is detected; wherein the target motion state is preset as a trigger condition for triggering the target logical function.

In a second aspect of the embodiments of the present disclosure, a control apparatus for a display module is provided. The display module is configured to be connected to a lens of glasses and configured to perform display on the connected lens. The apparatus includes:
a first monitoring module, configured to monitor a motion state of the display module on a currently connected lens; and
a first control module, configured to control the display module to display a graphical interface corresponding to a target logical function on the lens when a target motion state is detected; wherein the target motion state is preset as a trigger condition for triggering the target logical function.

In a third aspect of the embodiments of the present disclosure, a near-eye display device is provided. The near-eye display device includes a processor and a memory, wherein the memory stores a program or an instruction executable on the processor. The program or the instruction, when executed by the processor, causes the processor to perform a control method for a display module. The method includes:
monitoring a motion state of the display module on a currently connected lens; and
controlling the display module to display a graphical interface corresponding to a target logical function on the lens when a target motion state is detected; wherein the target motion state is preset as a trigger condition for triggering the target logical function.

### BRIEF DESCRIPTION OF THE DRAWINGS

To more clearly illustrate the technical solutions of the embodiments of the present disclosure, the accompanying drawings required for the embodiments will be briefly described below. As is generally known, the drawings described below are some embodiments of the present disclosure. For those skilled in the art, other drawings can be obtained based on these drawings without undue experimentation.

FIG. 1 is a schematic diagram showing a connection between a display module and a lens according to an embodiment of the present disclosure;

FIGS. 2 to 3 are schematic diagrams showing various application scenarios of a display module according to an embodiment of the present disclosure;

FIG. 4 is a schematic diagram showing a connection relationship between a display module and a smart terminal according to an embodiment of the present disclosure;

FIG. 5 is a schematic diagram showing a main display interface of a display module according to an embodiment of the present disclosure;

FIG. 6 is a schematic flowchart showing a control method for a display module according to an embodiment of the present disclosure;

FIGS. 7 to 14 are schematic diagrams showing various application scenarios of a display module according to an embodiment of the present disclosure;

FIG. 15 is a schematic flowchart showing a control method for a display module according to an embodiment of the present disclosure;

FIG. 16 is a schematic flowchart showing a control method for a display module according to an embodiment of the present disclosure;

FIG. 17 is a schematic diagram showing an application scenario of a display module according to an embodiment of the present disclosure;

FIG. 18 is a schematic structural diagram showing a control apparatus for a display module according to an embodiment of the present disclosure;

FIG. 19 is a schematic structural diagram showing an electronic device according to an embodiment of the present disclosure;

FIG. 20 is a schematic structural diagram showing an electronic device according to an embodiment of the present disclosure;

FIG. 21 is a schematic structural diagram showing a near-eye display apparatus according to an embodiment of the present disclosure;

FIGS. 22 to 23 are schematic diagrams showing various application scenarios of a display module according to an embodiment of the present disclosure;

FIG. 24 is a schematic flowchart showing a control method for a display module according to an embodiment of the present disclosure;

FIGS. 25 to 30 are schematic diagrams showing various application scenarios of a display module according to an embodiment of the present disclosure;

FIG. 31 is a schematic flowchart showing a control method for a display module according to an embodiment of the present disclosure;

FIGS. 32 to 33 are schematic diagrams showing various application scenarios of a display module according to an embodiment of the present disclosure;

FIGS. 34 to 39 are schematic flowcharts showing respective control methods for a display module according to an embodiment of the present disclosure;

FIG. 40 is a schematic diagram showing a main display interface of a display module according to an embodiment of the present disclosure;

FIG. 41 is a schematic flowchart showing a control method for a display module according to an embodiment of the present disclosure;

FIGS. 42 to 48 are schematic diagrams showing different application scenarios of a display module according to an embodiment of the present disclosure;

FIG. 49 is a schematic structural diagram showing glasses according to an embodiment of the present disclosure;

FIG. 50 is a schematic structural diagram showing a near-eye display module according to an embodiment of the present disclosure;

FIG. 51 is an exploded view of FIG. 50;

FIG. 52 is a schematic structural diagram showing an assembled state of a first connecting portion and a mounting base according to an embodiment of the present disclosure;

FIG. 53 is a top view of FIG. 50;

FIG. 54 is a cross-sectional view taken along line A-A in FIG. 53;

FIG. 55 is a schematic structural diagram showing a first cover according to an embodiment of the present disclosure;

FIG. 56 is a schematic structural diagram showing a second cover according to an embodiment of the present disclosure;

FIG. 57 is a schematic structural diagram showing a near-eye display module according to another embodiment of the present disclosure;

FIG. 58 is a partial exploded view of FIG. 57;

FIG. 59 is a schematic structural diagram showing a second connecting portion according to an embodiment of the present disclosure;

FIG. 60 is a schematic structural diagram showing an optical module according to an embodiment of the present disclosure;

FIG. 61 is a schematic structural diagram showing an optical module according to another embodiment of the present disclosure;

FIG. 62 is a schematic diagram showing contours of respective related surfaces of an optical module according to an embodiment of the present disclosure;

FIG. 63 is a three-dimensional structural schematic diagram showing an optical module according to an embodiment of the present disclosure;

FIG. 64 is a three-dimensional structural schematic diagram showing an optical module according to still another embodiment of the present disclosure;

FIG. 65 is a three-dimensional structural schematic diagram showing an optical module according to still another embodiment of the present disclosure;

FIG. 66 is a three-dimensional structural schematic diagram showing an optical module according to still another embodiment of the present disclosure;

FIG. 67 is a schematic structural diagram showing an optical module with an optical path according to an embodiment of the present disclosure;

FIG. 68 is a schematic structural diagram showing an optical module according to still another embodiment of the present disclosure;

FIG. 69 is a schematic structural diagram showing an optical module with an optical path according to still another embodiment of the present disclosure;

FIG. 70 is a schematic structural diagram showing an optical module according to still another embodiment of the present disclosure;

FIG. 71 is a three-dimensional structural schematic diagram showing an optical module according to still another embodiment of the present disclosure;

FIG. 72 is a schematic structural diagram showing an optical module according to another embodiment of the present disclosure;

FIG. 73 is a schematic structural diagram showing an application scenario of an optical module applied to an eyeball according to an embodiment of the present disclosure;

FIG. 74 is a schematic flowchart showing a processing method for an optical module according to an embodiment of the present disclosure;

FIG. 75 is an overall structural schematic diagram showing a near-eye display device according to an embodiment of the present disclosure;

FIG. 76 is an overall structural schematic diagram showing a near-eye display device without a temple according to an embodiment of the present disclosure;

FIG. 77 is a schematic diagram of the embodiment shown in FIG. 75 from another perspective;

FIG. 78 is an overall structural schematic diagram where a plurality of display modules and a plurality of first coils are provided;

FIG. 79 is a schematic cross-sectional structural diagram of an embodiment in which a display module is provided with a coil bracket;

FIG. 80 is a schematic diagram showing the display module in an embodiment of FIG. 79 provided with a second battery;

FIG. 81 is an exploded structural schematic diagram showing the display module in the embodiment of FIG. 79;

FIG. 82 is a schematic cross-sectional structural diagram showing a display module according to another embodiment;

FIG. 83 is a schematic diagram showing the display module in the embodiment of FIG. 82 provided with a second battery;

FIG. 84 is an exploded structural schematic diagram showing the display module in the embodiment of FIG. 83;

FIG. 85 is an overall structural schematic diagram showing a charging box according to an embodiment of the present disclosure;

FIG. 86 is a schematic structural diagram showing a near-eye display apparatus according to an embodiment of the present disclosure;

FIG. 87 is a schematic structural diagram showing arrangement of a movable area of a lens according to an embodiment of the present disclosure;

FIG. 88 is a schematic structural diagram showing arrangement of a movable area of a lens according to another embodiment of the present disclosure;

FIG. 89 is a schematic structural diagram showing arrangement of a movable area of a lens according to still another embodiment of the present disclosure;

FIG. 90 is a schematic diagram showing display content when a display assembly according to an embodiment of the present disclosure is located in different movable areas;

FIG. 91 is a schematic block diagram showing the structural composition of a display assembly according to an embodiment of the present disclosure;

FIG. 92 is a schematic block diagram showing the structural composition of an output unit according to an embodiment of the present disclosure;

FIG. 93 is a schematic block diagram showing the structural composition of a sensing unit according to an embodiment of the present disclosure;

FIG. 94 is an exploded structural schematic diagram showing a display assembly according to an embodiment of the present disclosure;

FIG. 95 is a schematic block diagram showing the structural composition of a terminal according to an embodiment of the present disclosure;

FIG. 96 is a schematic flowchart showing a control method for controlling a near-eye display apparatus according to an embodiment of the present disclosure;

FIG. 97 is a schematic structural diagram showing a near-eye display system according to an embodiment of the present disclosure.

### DETAILED DESCRIPTION

To make the challenges to be addressed, technical solutions and beneficial effects of the present disclosure clearer, the present disclosure will be described in further detail below with reference to the drawings and embodiments. It should be understood that the specific embodiments described herein are only intended to explain the present disclosure and are not intended to limit the present disclosure.

It should be noted that when an element is referred to as being “fixed to” or “disposed/provided on” another element, it may be directly on the other element or indirectly attached to the other element. When an element is referred to as being “connected to” another element, it may be directly connected to the other element or indirectly connected to the other element.

It should be understood that the terms such as “length”, “width”, “upper”, “lower”, “front”, “rear”, “left”, “right”, “vertical”, “horizontal”, “top”, “bottom”, “inner” and “outer” indicate orientations or positional relationships based on orientations or positional relationships shown in the drawings, which are merely for facilitating the description of the present disclosure and simplifying the description, rather than indicating or implying that the referred apparatus or element must have a specific orientation, or be constructed and operated in a specific orientation. Therefore, they shall not be construed as limitations on the present disclosure.

In addition, the terms “first” and “second” are used for descriptive purposes only, and shall not be interpreted as indicating or implying relative importance or implicitly indicating the number of indicated technical features. Thus, features defined by “first” and “second” may explicitly or implicitly include one or more of such features. In the description of the present disclosure, the term “a plurality of” means two or more, unless otherwise specifically defined. The term “and/or” is used to describe an association relationship between associated objects and represents three possible relationships; for example, A and/or B may represent the presence of A alone, the coexistence of A and B, or the presence of B alone, where A and B may be singular or plural. The symbol “/” generally indicates an “or” relationship between the associated objects preceding and following the symbol. References to “an embodiment” or “some embodiments” and the like in the present disclosure mean that a specific feature, structure or characteristic described in conjunction with the embodiment is included in one or more embodiments of the present disclosure. Thus, phrases such as “an embodiment”, “some embodiments”, “another embodiment” and “further embodiments” appearing in different places in the specification do not necessarily refer to the same embodiment, but mean “one or more but not all embodiments” unless otherwise specifically emphasized. The terms “comprise”, “include”, “have” and variations thereof shall be construed as “including but not limited to”, unless otherwise specifically emphasized.

In the related art, there is a user demand for quick interaction with virtual information. Embodiments of the present disclosure aim to provide a control method for a display module, an electronic device, a near-eye display apparatus, a medium, a chip and a computer program product, so as to independently or semi-independently address, to a certain extent, the challenge that a user cannot quickly interact with virtual information in near-eye display technology. The term “independently solving” refers to providing a hardware structural solution that can operate independently without software cooperation, so as to achieve the effect that the user can quickly interact with virtual information in near-eye display technology. The term “semi-independently solving” refers to providing a hardware structural solution. When cooperating with near-eye display software, for example, software for the user to interact with virtual information, the hardware structural solution can achieve the effect that the user can quickly interact with virtual information in near-eye display technology.

In the embodiments of the present disclosure, a display module for augmented reality display and imaging on a lens of glasses is allowed to move on the connected lens, instead of the display module being fixed to the lens. Motion states executable by the display module are preset as trigger conditions for triggering some logical functions. When it is detected that the motion state of the display module on the connected lens satisfies a trigger condition of a certain logical function, the display module is controlled to display the graphical interface corresponding to the triggered logical function on the lens. Compared with the related art in which the display module is fixed to the lens, a user may control the display module to perform a motion capable of triggering a desired logical function on the connected lens, so as to trigger and start the desired logical function, and further control the display module to display the graphical interface corresponding to the triggered logical function on the lens, allowing the user to quickly interact with virtual information presented by the display module.

Further beneficial technical effects of the present disclosure will be described in the following embodiments.

Embodiments of the present disclosure provide a control method and control apparatus for a display module, a device, a near-eye display apparatus, a storage medium, a chip, and a computer program product, which can effectively address the challenge that a user cannot quickly interact with virtual information in AR or near-eye display technology. The following is described with reference to the drawings. To facilitate (correct) understanding of the embodiments of the present disclosure, technical terms that may be involved in the embodiments of the present disclosure will be first defined and explained below; unless otherwise specified hereinafter, the semantics of the corresponding technical terms shall comply with the definitions herein.

A computer or computing device refers to all electronic devices based on Turing computability theory, von Neumann architecture or Harvard architecture. For example, mobile phones, smart watches, single-chip microcomputer systems and the like are all computers, and are not limited to narrow-sense computers such as Personal Computers (PCs) commonly referred to in daily life.

Application: namely a computer application program (computer program or application software), which is written in a certain programming language and runs on a computer system with a target architecture. The computer application program refers to a coded instruction sequence executable by an apparatus having information processing capability such as a computer for achieving a certain result, or a symbolic instruction sequence or symbolic statement sequence that is automatically convertible into a coded instruction sequence.

Logical function refers to various functions provided by various electronic devices (with independent computing capability), such as near-eye display apparatus, computers or computing devices. Such functions may be user-oriented functions, or may be system-oriented (or device-oriented) functions. For example, user-oriented logical functions may include graphical user interface (GUI) output function, audio output function, main interface or desktop, programs/applications, sub-functions in programs/applications, and the like. The main interface, desktop, applications and the like can provide a GUI for the user to interact therewith. System-oriented logical functions may include file fragment arrangement, system error diagnosis, and the like.

Foreground running and background running: Foreground running and background running are two relative concepts, both used to describe the operating mode of an application/program or process in an operating system (generally speaking, the operating system refers to software in a computer that allows the application to communicate with underlying hardware of the computer). The following takes a conventional computer as an example to illustrate foreground running and background running. The characteristics of foreground running and background running in AR technology are similar to those in the conventional computer. In a conventional computer, when an application runs in the foreground, the GUI of the application is usually displayed on the display screen. The user can view the GUI or window of the application and directly interact or communicate with the application based on the GUI. At this time, the application usually occupies at least one input device (such as a mouse or a keyboard). An application running in the foreground generally blocks the user interface, and the user needs to wait for the application running in the foreground to complete execution or interact according to the requirements of the application running in the foreground. This operating mode is applicable to tasks requiring real-time user feedback or user input. In a conventional computer, when an application runs in the background, the GUI is not output on the display screen, i.e., it is invisible to the user, and the user cannot directly interact or communicate with the application. When an application runs in the background, the user may continue to perform other tasks on the computer, and the application runs silently in an invisible state, such as processing files and executing system services. An application running in the background usually does not occupy input devices and requires no direct user participation in task execution, allowing the user to perform other tasks while the application is running and improving the multi-task processing capability of the system.

A display module refers to a display component, a display apparatus or a display device capable of displaying based on optical technology. Therefore, the display module is a physical hardware module. In some optional embodiments, the display module may be connected to a lens and powered on for displaying. The lens may be, for example, sunglasses commonly used in daily life, vision correction glasses, goggles, a mask with lenses, or the like, and may also be a lens of smart glasses with audio, sensing, other functions or a combination thereof. The display module may be connected to the lens by means of magnetic attraction, clamping or other adsorption manners, so that the display module can move freely on the connected lens or move within a preset area. For example, the display module can move linearly or curvilinearly or rotate about an axis on the placed lens.

In the related art, a user has the need for quick interaction with virtual information. Embodiments of the present disclosure aim to provide a control method for a display module, an electronic device, a near-eye display apparatus, a medium, a chip, and a computer program product, so as to independently or semi-independently address, to a certain extent, the challenge that a user cannot quickly interact with virtual information in near-eye display technology. The term “independently solving” refers to providing a hardware structural solution that can operate independently without software cooperation, so as to achieve the effect that the user can quickly interact with virtual information in near-eye display technology. The term “semi-independently solving” refers to providing a hardware structural solution. When cooperating with near-eye display software, for example, software for the user to interact with virtual information, the hardware structural solution can achieve the effect that the user can quickly interact with virtual information in near-eye display technology.

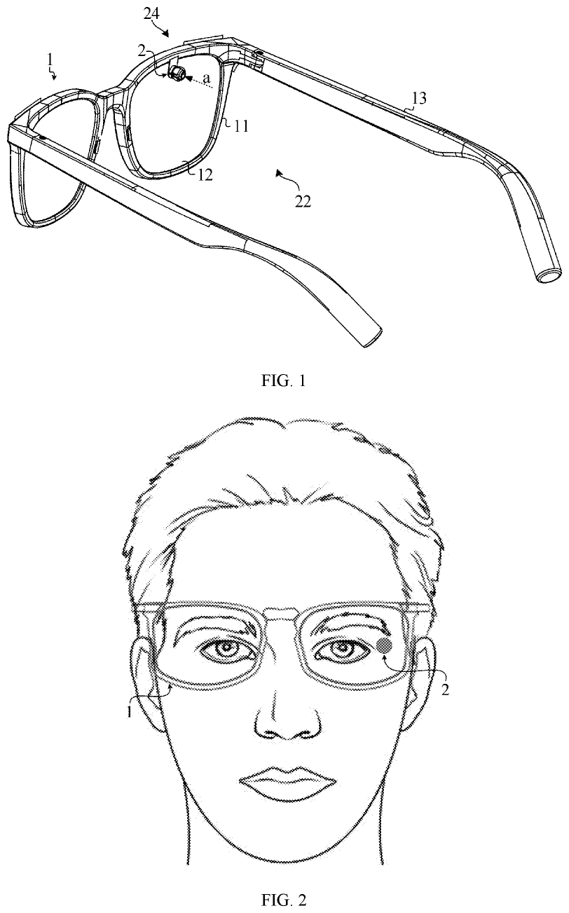

For example, as shown in FIG. 1, FIG. 1 is a schematic diagram showing a connection between a display module and a lens according to an embodiment of the present disclosure. Referring to FIG. 1, a lens of glasses is taken as an exemplary embodiment, but the present disclosure is not limited to glasses, and may also be applied to lenses disposed on head-mounted devices such as a helmet, goggles, vision correction devices, and sports headgear. The glasses 1 may be ordinary glasses, AR glasses, smart glasses, or the like. The glasses 1 include a frame body 11, a lens 12 embedded in the frame body 11, and a temple 13 movably connected to the frame body 11. The lens 12 includes an environment side 24 and an eye side 22. A user's eyes can view the physical environment on the environment side through the lens 12 from the eye side. Optionally, the display module 2 is provided with a first magnetic member at an end of the lens 12 facing the environment side 24, and is provided with a second magnetic member at an end of the lens 12 facing the eye side 22. It can be understood that two magnetic members that attract each other are disposed on two sides of the lens 12 to achieve pre-fixation of the display module on the lens. The first magnetic member and the second magnetic member may be magnets that attract each other; alternatively, one of them may be a magnet and the other may be a metal that can be attracted by a magnet, etc., such that the display module 2 is integrally attached to the lens 12. At this time, the display module 2 can freely slide or rotate about an axis on the lens 12 without being detached from the lens 12. Certainly, other solutions such as adsorption and movement are also feasible herein.

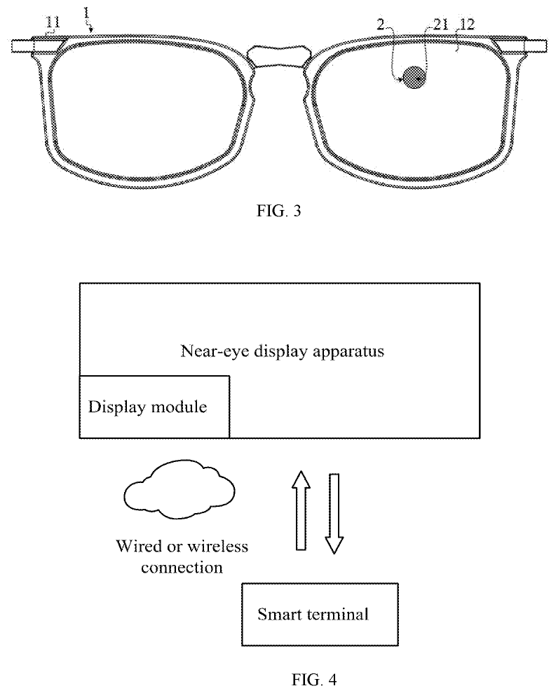

Exemplarily, as shown in FIG. 2 and FIG. 3, each of FIG. 2 and FIG. 3 is a schematic diagram showing an application scenario of a display module according to an embodiment of the present disclosure. FIG. 3 may be a front view obtained by observing the glasses 1 from a direction where the temples 13 of the glasses 1 are located, (i.e., the eye side). Referring to FIG. 1, FIG. 2 and FIG. 3, the direction indicated by the straight arrow a in FIG. 1 is a direction in which a user's eye views a virtual image displayed by the display module 2 on the lens 12. When viewing an end face of the display module 2 along the direction indicated by the arrow a, the user can see a virtual image or a graphical interface formed on the lens 12 based on AR technology. That is, an end face of the display module 2 viewed along the direction of the arrow a in FIG. 1 defines a display area 21 of the display module 2. When the display module 2 is in operation, the display area 21 may be in a “lit” state, capable of presenting image content such as text, interactive interfaces, videos, images, and other related display content. A region of the lens 12 not occupied by the display module still retains the inherent properties of the lens 12, for example, allowing a user to view the environment side from the eye side, such as eye protection and vision correction properties inherent to the lens.

In some optional embodiments, the center position of the lens 12 is defined as a calibration position, which serves as a reference position for the display module 2. When the display module 2 is stationary at the calibration position, the display module 2 images a main interface or an interface with a preset logical function on the lens 12. The reason for defining the center position of the lens 12 as the calibration position is that the display module 2 can move in more circumferential directions and at different distances from the center position, facilitating user operation of the display module 2 and user customization of a preset display area.

After wearing the glasses 1, the user may press (or pinch) a touch portion of the display module 2 by hand to drag the display module 2 to move on the lens 12 or to rotate the display module 2 about an axis. In some embodiments, the display module 2 may be located on the environment side, and light from the display area 21 may pass through the lens to reach the user's eye on the eye side and form an image, and the touch portion is also located on the environment side to facilitate user interaction. In other embodiments, the display module 2 may be located on the eye side such that light from the display area 21 directly enters the user's eyes for displaying. In this case, the touch portion may be located on the eye side, so that the user can interact more discreetly to allow the user to perform concealed interaction.

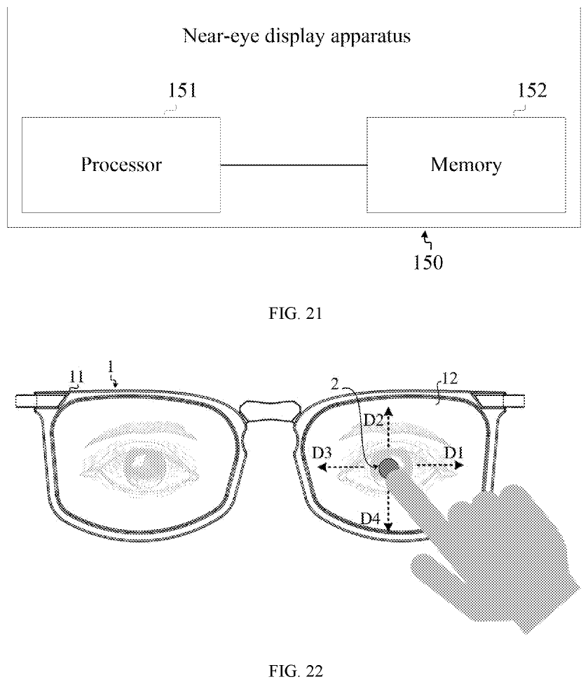

As shown in FIG. 22, FIG. 22 is a schematic diagram showing an application scenario of a display module according to an embodiment of the present disclosure. Referring to FIG. 22, a touch portion of the display module 2 is located on the environment side 24, and the user may press (or pinch) the touch portion of the display module 2 to drag the display module 2 to move on the lens 12 or rotate the display module 2 about an axis.

In some optional embodiments, a virtual image or a graphical interface displayed on the lens 12 by the display area 21 of the display module 2 may be generated by the display module 2 itself, or transmitted from the glasses 1 communicatively connected to the display module 2. In other embodiments, the virtual image or graphical interface may be generated by other electronic devices that are relatively independent of both the glasses 1 and the display module 2, such as mobile phones, tablet computers, and other smart terminals or computers. When the glasses 1 are ordinary glasses, the virtual image or graphical interface displayed by the display module 2 on the lens 12 is obtained from other electronic devices independent of both the glasses 1 and the display module 2, such as mobile phones, tablet computers, and other smart terminals or computers.

For example, as shown in FIG. 4, FIG. 4 is a schematic diagram showing a connection relationship between a display module and a smart terminal according to an embodiment of the present disclosure. As shown in FIG. 4, the display module 2 is (physically) connected to a near-eye display apparatus 10. The near-eye display apparatus 10 may be the aforementioned glasses 1. The smart terminal 4 may be a PC, a laptop, a smartphone, a tablet computer, a smart speaker, a server, or the like. A wired or wireless communication connection is established between the display module 2 and the smart terminal 4. For example, the display module 2 and the smart terminal 4 communicate based on a Wi-Fi protocol or a Bluetooth protocol; or, the display module 2 and the smart terminal 4 communicate via a USB cable based on a USB transmission protocol, and the display module 2 may also obtain power from the smart terminal 4 via the USB cable. Of course, the present disclosure is not limited to the foregoing examples, and the display module 2 and the smart terminal 4 may also establish a wired or wireless communication connection based on other communication protocols, such as an NFC protocol or a P2P (peer-to-peer) network. The display module 2 and the near-eye display apparatus 10 together constitute a “display device” of the smart terminal 4. The GUI output by the smart terminal 4 is displayed on the near-eye display apparatus 10 via the display module 2.

In some optional embodiments, a touch sensor, a pressure sensor, a capacitive sensor, or the like may be disposed on a touch portion of the display module 2 to detect whether the touch portion of the display module 2 is touched. In some optional embodiments, a miniature camera is further disposed on the touch portion of the display module 2 to obtain image/video data from the environment. In some optional embodiments, a miniature microphone is further disposed on the touch portion of the display module 2 to obtain ambient sound from the environment. In some optional embodiments, a miniature camera is also disposed on one side of the display area 21 of the display module 2 to capture eye images of a user wearing the glasses 1 to track the user's eyeballs.

A trigger condition refers to a preset condition for triggering operation or execution of a logical function. In some optional embodiments of the present disclosure, certain motion states of the display module are preset as trigger conditions for certain logical functions. For example, a state in which the display module is stationary at a preset position on the connected lens is preset as a trigger condition for triggering a main interface output function. When it is subsequently detected that the display module is stationary at the preset position, the display module images a main interface on the connected lens, and the user may view the main interface displayed on the lens by observing a display area of the display module. Optionally, the main interface may include an icon (thumbnail) of at least one application (or file). The preset position may be the center position of the lens, or easily remembered and identifiable positions such as four corners of a bezel.

A preset display area refers to a display area that is predefined for the display module on the connected lens. In some optional embodiments, the preset display area may be a regular area on the lens connected to the display module, such as a rectangular area, a circular area, or an elliptical area. In some optional embodiments, the preset display area may be an irregular area on the lens connected to the display module. In some optional embodiments, the preset display area may also be the entire area of the lens connected to the display module.

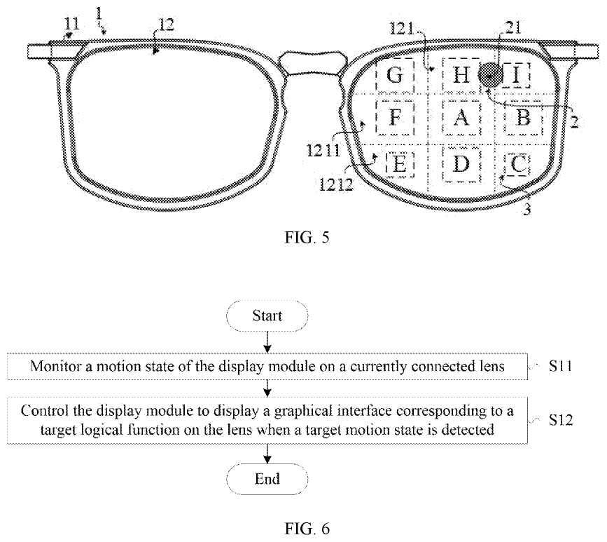

For example, as shown in FIG. 5, FIG. 5 is a schematic diagram showing amain display interface of a display module according to an embodiment of the present disclosure. Referring to FIG. 5, after the user wears the glasses 1 and views toward the lens 12 from a side of the temple 13 (refer to FIG. 1 and FIG. 2), i.e., from the eye side of the glasses, the user may view the main interface displayed by the display module 2 on the lens 12 by observing a display area of the display module. That is, in the embodiment of FIG. 5, when the display module 2 is stationary at the illustrated position on the lens 12 (the position is not limited to the position shown in FIG. 5, and the user can freely set any stationary position of the display module 2 on the lens 12 to trigger a logical function of outputting a main interface), the logical function of outputting the main interface is triggered. In the embodiment of FIG. 5, the preset display area 121 is the entire area of the lens 12, and the preset display area 121 is divided into a plurality of sub-areas (e.g., 6 sub-areas shown in FIG. 5). In each sub-area, an icon (thumbnail) of an application or file mapped to that sub-area is displayed. For example, an icon of application F is displayed in sub-area 1211, and an icon of application E is displayed in sub-area 1212. In the embodiment of FIG. 5, icons of applications A-I are displayed in six sub-areas. In other optional embodiments, at least one of icons A-I may be a file icon (thumbnail) corresponding to a video, an image, an audio file, a text file, or the like. In some optional embodiments, when the display module 2 is first connected to the lens 12 and powered on, the display module 2 will by default display the main interface on the lens 12.

It should be further noted that, to facilitate illustration of the main interface divided into a plurality of sub-areas, grid lines (i.e., dashed grid lines on the lens 12) indicating each sub-area are shown in FIG. 5. Such grid lines shall not be construed as a mandatory feature of the main interface displayed by the display module 2 according to embodiments of the present disclosure, and the grid lines are not essential. That is, the displayed main interface may not have these grid lines. After the display module 2 is placed on the lens 12, no grid lines are visible on the lens body itself, and the lens 12 still retains its inherent optical properties. When the lens itself adopts a holographic lens such as an optical waveguide, the lens may cooperate with the display module to provide simple prompts, etc. In addition, a setting option may be provided for the user to select whether to display the grid lines while displaying the main interface. When the user enables grid line display for the main interface, the display module displays the grid lines together with the main interface. When the user disables grid line display for the main interface, the display module images the main interface without displaying the grid lines. The grid lines may also correspond to a graphical interface of a smart terminal (such as a mobile application (APP)), allowing the user to divide or customize the grid lines of the preset display area 121 through the graphical interface of the terminal. Furthermore, the line style of a grid line is not limited to the dashed line shown in FIG. 5, and may also be a solid line, a center line, or the like.

Embodiments of the present disclosure provide a control method for a display module. The display module is configured to be connected to a lens of glasses and perform display on the connected lens. The control method for the display module may be executed by at least one of the glasses 1, the display module 2, the near-eye display apparatus 10, or the smart terminal shown in FIG. 1 to FIG. 5, so as to control specific content of a graphical user interface (GUI) displayed by the display module 2 on the connected glasses 1 (or the near-eye display apparatus 10) connected thereto. As shown in FIG. 6, FIG. 6 is a schematic flowchart showing steps of a control method for a display module according to an embodiment of the present disclosure. The control method for the display module includes the following steps.

S11: Monitor a motion state of the display module on a currently connected lens.

The lens refers to the lens of glasses to which the display module is currently connected. Exemplarily, the lens may be any lens described in the foregoing embodiments, and details are not repeated herein.

In some optional embodiments, an inertial sensor or an acceleration sensor (or a gyroscope) is provided in the display module. Such sensors may obtain instantaneous velocity and acceleration of the display module, thereby determining the motion state of the display module based on the obtained instantaneous velocity and acceleration in combination with parameters such as time.

S12: Control the display module to display a graphical interface corresponding to a target logical function on the lens when a target motion state is detected. The target motion state is preset as a trigger condition for triggering the target logical function.

The target logical function may be at least one logical function selected from all (user-oriented and system-oriented) logical functions provided by a device or a system.

Exemplarily, the target logical function may be a function of outputting a main interface, a function of outputting a chat interface of a social application, a function of outputting a search interface of a browser, and the like.

In the embodiments of the present disclosure, motion states of the display module on the lens are roughly divided into the following two categories: first, the display module is in a relatively static state on the lens; and second, the display module is in a relatively moving state on the lens. The relatively moving state of the display module on the lens can be further divided into two types: the display module can move on the lens (movement refers to moving from one point on the lens to another), or rotate (about its own central axis). In the embodiment shown in FIG. 1, the axis coincides with arrow a. The target motion state may be a motion state which is determined in advance from various possible motion states of the display module and can trigger the target logical function. In other embodiments, the motion may further include multi-segment motion, namely a combination of multiple linear motions on the lens, or “pattern-like” motion, such as a trajectory motion in the shape of a polyline, an L-shape, a Z-shape, or the like.

In some optional embodiments, when it is determined that the motion state of the display module is a target motion state based on the obtained instantaneous velocity and acceleration in combination with parameters such as time, a target logical function whose trigger condition is the target motion state is triggered. After the target logical function is triggered, the target logical function starts to operate or execute (when the triggered target logical function is an application that is already running in the background, the target logical function is switched to the foreground), the target logical function is switched to foreground running. When the target logical function is executed or operating, the display module is correspondingly controlled to display a graphical interface corresponding to the target logical function on the lens.

Exemplarily, taking the embodiment shown in FIG. 1 to FIG. 3 as an example, the target motion state may be linear motion of the display module 2 on the lens 12, the display module 2 being stationary at a preset position on the lens 12 (the preset position being a fixed position selected in advance), or the display module 2 moving along a diagonal of the lens 12 (assuming the lens has four corners, a diagonal is a line connecting any two non-adjacent corners), and the like. Meanwhile, linear motion of the display module 2 on the lens 12 is preset as a trigger condition for triggering a chat interface function of a social application. The display module 2 being stationary at the preset position on the lens 12 is preset as a trigger condition for triggering a main interface function. The display module 2 moving along the diagonal of the lens 12 is preset as a trigger condition for triggering a search interface function of a browser.

Exemplarily, when linear motion of the display module 2 on the lens 12 is detected, the display module 2 is controlled to display the chat interface of a social application on the lens 12. When the display module 2 being stationary at the preset position on the lens 12 is detected, the display module 2 is controlled to display the main interface on the lens 12 (refer to FIG. 5 and the related embodiments for description). The preset position may be an easily identifiable position such as the center of the lens or a position defined by a user according to personal preference. When the display module 2 moving along the diagonal of the lens 12 is detected, the display module 2 is controlled to display a search interface of a browser on the lens 12.

In the embodiments of the present disclosure, a display module for augmented reality display and imaging on a lens of glasses is allowed to move on the connected lens, instead of the display module being fixed to the lens. Motion states executable by the display module are preset as trigger conditions for triggering some logical functions. When it is detected that the motion state of the display module on the connected lens satisfies a trigger condition of a certain logical function, the display module is controlled to display the graphical interface corresponding to the triggered logical function on the lens. Compared with the related art in which the display module is fixed to the lens, a user may control the display module to perform a motion capable of triggering a desired logical function on the connected lens, so as to trigger and start the desired logical function, and further control the display module to display the graphical interface corresponding to the triggered logical function on the lens, allowing the user to quickly interact with virtual information presented by the display module.

In some optional embodiments, the target motion state includes that movement of the display module on the lens satisfies a first preset condition. The target logical function includes a first logical function. That the movement of the display module on the lens satisfies the first preset condition is preset as a trigger condition for triggering the first logical function. Step S12 includes:
controlling the display module to display a first graphical interface corresponding to the first logical function on the lens when it is detected that the movement of the display module on the lens satisfies the first preset condition.

In some optional embodiments, detecting movement of the display module may include detecting a process in which the instantaneous velocity of the display module changes abruptly from zero to a non-zero value and then changes back to zero (which is defined as a first process). The first process mentioned below refers to the process in which the instantaneous velocity of the display module changes abruptly from zero to a non-zero value and then changes back to zero. When the detected abrupt change process of the instantaneous velocity satisfies the first preset condition, the display module is controlled to display the first graphical interface corresponding to the first logical function on the lens.

In some optional embodiments, the first logical function may refer to at least one logical function selected from all (user-oriented and system-oriented) logical functions provided by a device or a system.

Exemplarily, the first logical function may be a main interface output function, a phone dialing function, an intelligent assistant function, a music player function, a video player function, a camera function, an album function, a social application function, and the like.

In some optional embodiments, the first preset condition may be any one or a combination of the following conditions \textcircled{1} to \textcircled{6}:

Condition \textcircled{1}: a displacement distance ΔS of the movement is no less than a preset first threshold length S_1.

Displacement described in the embodiments of the present disclosure conforms to the definition in physics. That is, displacement refers to a directed line segment from an initial position to a final position of an object over a period of time. The length of the directed line segment is the displacement distance, and the direction of the directed line segment is the displacement direction.

In some optional embodiments, when it is detected that ΔS of the display module in the first process satisfies ΔS>S_1, the display module is controlled to display the first graphical interface corresponding to the first logical function on the lens.

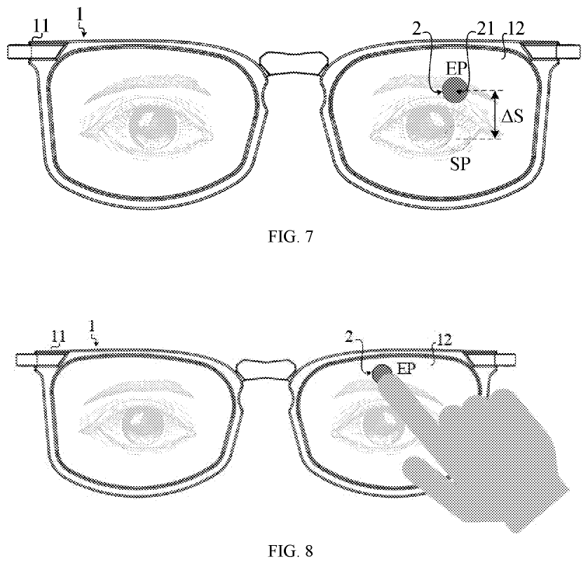

Exemplarily, the first logical function is a phone dialing function. As shown in FIG. 7, FIG. 7 is a schematic diagram showing an application scenario of a display module according to an embodiment of the present disclosure. Referring to FIG. 7, when the first process of the display module 2 on the lens 12 is detected and ΔS of the display module 2 in the first process satisfies ΔS>S_1, the phone dialing function is triggered, and the display module 2 is controlled to display a dialing interface corresponding to the phone dialing function on the lens 12.

Condition \textcircled{2}: A displacement distance ΔS of the movement is no less than a preset first threshold length S_1, and a displacement direction a→ of the movement is a preset first direction (a_1)→.

In some optional embodiments, when it is detected that ΔS of the display module in the first process satisfies ΔS>S_1 and the displacement direction a→ of the display module in the first process is the same as the preset first direction (a_1)→, the display module is controlled to display the first graphical interface corresponding to the first logical function on the lens.

Exemplarily, the first logical function is an intelligent assistant function. Referring to FIG. 7, when the first process of the display module 2 on the lens 12 is detected, ΔS of the display module 2 in the first process satisfies ΔS>S_1, and the displacement direction a→ of the display module 2 is the same as the preset first direction (a_1)→, the intelligent assistant function is triggered, and the display module 2 is controlled to display an instruction acquisition interface (voice or text) corresponding to the intelligent assistant function on the lens 12.

Condition \textcircled{3}: A displacement distance ΔS of the movement is no less than a preset first threshold length S_1, a starting point (SP) of the movement is a preset first position (P1), and the first position (P1) is a fixed position selected on the lens.

In some optional embodiments, when it is detected that ΔS of the display module in the first process satisfies ΔS>S_1, and the display module is located at the position P1 at a time point t when the instantaneous velocity of the display module changes abruptly from zero to a non-zero value in the first process, that is, the starting point SP of movement of the display module in the first process is the position P1 selected on the lens, the display module is controlled to display the first graphical interface corresponding to the first logical function on the lens.

Exemplarily, the first logical function is a music player function. Referring to FIG. 7, when the first process of the display module 2 on the lens 12 is detected and the starting point SP of the movement of the display module 2 in the first process is the position P1 selected on the lens 12 (for example, P1 is a center point of the lens 12), the music player function is triggered, and the display module 2 is controlled to display a song playback interface corresponding to the music player function on the lens 12.

Condition \textcircled{4}: A displacement distance ΔS of the movement is no less than a preset first threshold length S_1, a displacement direction a→ of the movement is a preset first direction (a_1)→, and a starting point (SP) of the movement is the first position.

In some optional embodiments, when it is detected that ΔS of the display module in the first process satisfies ΔS>S_1, the displacement direction a→ of the display module 2 is the same as the preset first direction (a_1)→, and the display module is located at the position P1 at a time point t when the instantaneous velocity of the display module changes abruptly from zero to a non-zero value in the first process, that is, the starting point SP of the movement of the display module in the first process is the position P1 selected on the lens, the display module is controlled to display the first graphical interface corresponding to the first logical function on the lens.

Exemplarily, the first logical function is a video player function. Referring to FIG. 7, when the first process of the display module 2 on the lens 12 is detected, the displacement direction a→ of the display module 2 is the same as the preset first direction (a_1)→, and the starting point SP of the movement of the display module 2 in the first process is the position P1 selected on the lens 12 (for example, P1 is a center point of the lens 12), the video player function is triggered, and the display module 2 is controlled to display a video playback interface corresponding to the video player function on the lens 12.

Condition \textcircled{5}: An endpoint (EP) of the movement is a preset second position (P2), and the second position (P2) is a fixed position selected on the lens.

In some optional embodiments, when it is detected that the display module is located at the second position P2 at a time point t when the instantaneous velocity of the display module changes abruptly from zero to a non-zero value and then changes back to zero in the first process, that is, the endpoint EP of the movement of the display module in the first process is the position P2 selected on the lens, the display module is controlled to display the first graphical interface corresponding to the first logical function on the lens. That is, regardless of how the display module moves on the lens, the first logical function is triggered as long as the display module moves to the position P2 on the lens.

Exemplarily, the first logical function is a camera function. As shown in FIG. 8, FIG. 8 is a schematic diagram showing an application scenario of a display module according to an embodiment of the present disclosure. Referring to FIG. 8, when the first process of the display module 2 on the lens 12 is detected and the endpoint EP of the display module 2 in the first process is at an upper boundary of the lens 12 (or a preset display area), the camera function is triggered, and the display module 2 is controlled to display the function interface of the camera on the lens 12.

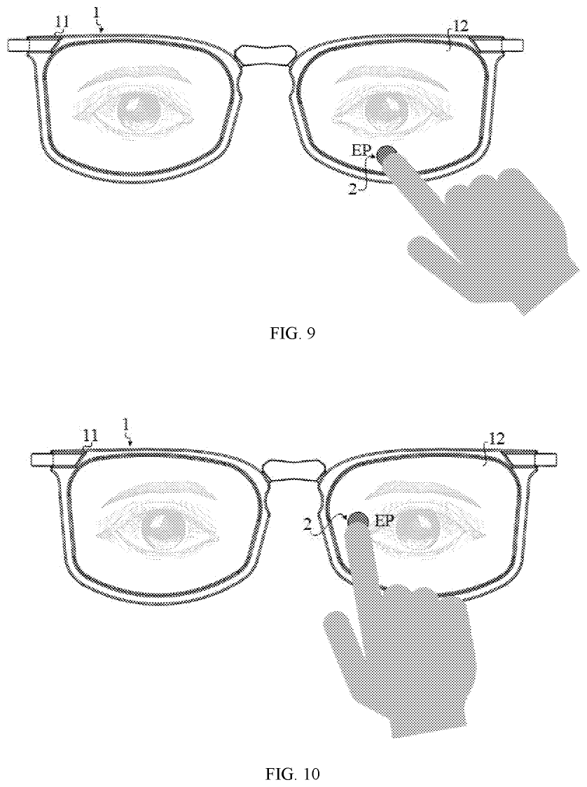

Exemplarily, the first logical function is an album function. As shown in FIG. 9, FIG. 9 is a schematic diagram showing an application scenario of a display module according to an embodiment of the present disclosure. Referring to FIG. 9, when the first process of the display module 2 on the lens 12 is detected and the endpoint EP of the display module 2 in the first process is at a lower boundary of the lens 12 (or a preset display area), the album function is triggered, and the display module 2 is controlled to display the function interface of the album on the lens 12.

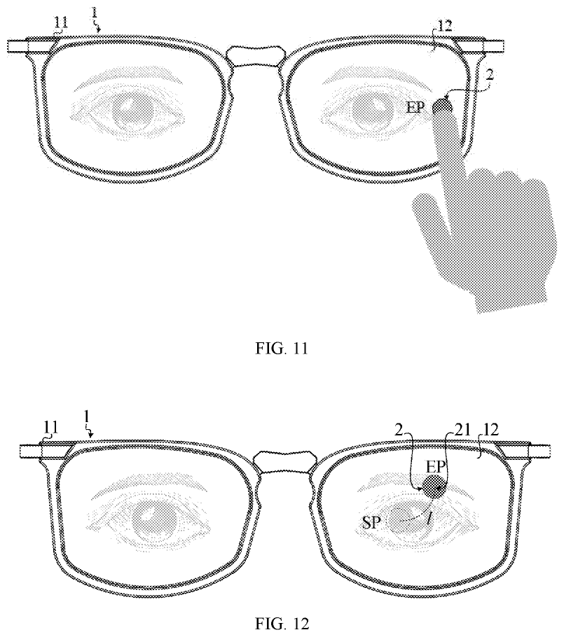

Exemplarily, the first logical function is a social application function. As shown in FIG. 10, FIG. 10 is a schematic diagram showing an application scenario of a display module according to an embodiment of the present disclosure. Referring to FIG. 10, when the first process of the display module 2 on the lens 12 is detected and the endpoint EP of the display module 2 in the first process is at a left boundary of the lens 12 (or a preset display area), the social application function is triggered, and the display module 2 is controlled to display the function interface of the social application on the lens 12.

Exemplarily, the first logical function is a navigation function. As shown in FIG. 11, FIG. 11 is a schematic diagram showing an application scenario of a display module according to an embodiment of the present disclosure. Referring to FIG. 11, when the first process of the display module 2 on the lens 12 is detected and the endpoint EP of the display module 2 in the first process is at a right boundary of the lens 12 (or a preset display area), the navigation function is triggered, and the display module 2 is controlled to display the function interface of the navigation on the lens 12.

Exemplarily, the first logical function is a main interface output function. When the first process of the display module 2 on the lens 12 is detected and the endpoint EP of the display module 2 in the first process is at a center point of the lens 12 (or a preset display area), the main interface output function is triggered, and the display module 2 is controlled to display a main interface on the lens 12.

Condition \textcircled{6}: A shape similarity (Sim) between a movement trajectory 1 and a preset trajectory 11 is no less than a preset first threshold a.

In some optional embodiments, when it is detected that the shape similarity Sim between the movement trajectory 1 and the preset trajectory 1_1 in the first process is no less than the preset first threshold a, the display module is controlled to display the first graphical interface corresponding to the first logical function on the lens.

Exemplarily, as shown in FIG. 12, FIG. 12 is a schematic diagram showing an application scenario of a display module according to an embodiment of the present disclosure. Referring to FIG. 12, when a first process of the display module 2 on the lens 12 is detected, and the shape similarity Sim between the detected movement trajectory 1 and the preset trajectory 11 in the first process is no less than a preset first threshold a, the first logical function is triggered, and the display module 2 is controlled to display a function interface of the first logical function on the lens 12.

The shape similarity Sim between the trajectory 1 and the preset trajectory 1_1 may be calculated by means of methods such as Euclidean distance, dynamic time warping, cosine similarity, Pearson correlation coefficient, Manhattan distance, dynamic kernel correlation, and mean absolute error.

In some optional embodiments, different first preset conditions may correspond to the same first logical function respectively, or may correspond to different first logical functions respectively.

Exemplarily, still taking the scenarios shown in FIG. 1 to FIG. 3 as an example, each of the foregoing conditions \textcircled{1} to \textcircled{6} that are satisfied by the movement of the display module 2 on the lens 12 may be preset as a trigger condition corresponding to a respective different logical function (as illustrated in the foregoing examples). Exemplarily, at least two of the conditions \textcircled{1} to \textcircled{6} that are satisfied by the movement of the display module 2 on the lens 12 may be preset as trigger conditions corresponding to the same logical function. For example, the condition \textcircled{1} that is satisfied by the movement of the display module 2 on the lens 12 may be preset as a trigger condition corresponding to a phone dialing function, and the condition \textcircled{6} that is satisfied by the movement of the display module 2 on the lens 12 may be preset as a trigger condition corresponding to a camera function. Alternatively, the condition \textcircled{1} that is satisfied by the movement of the display module 2 on the lens 12 may be preset as a trigger condition corresponding to the phone dialing function, and the condition \textcircled{6} that is satisfied may also be preset as a trigger condition corresponding to the phone dialing function.

It should be further noted that the first preset conditions in the embodiments of the present disclosure are not limited to the six listed conditions. Those skilled in the art may flexibly set the first preset conditions according to actual requirements. For example, the first preset condition may further include that the display module moves along a preset trajectory on the lens. Specifically, the first preset condition may be that the display module moves along the diagonal of the lens as described above.

In some optional embodiments, the target motion state includes that the display module is stationary at a third position on the lens. The third position is a fixed position selected on the lens. The target logical function includes a second logical function. That the display module is stationary at the third position on the lens is preset as a trigger condition for triggering the second logical function. Step S12 includes:

controlling the display module to display a second graphical interface corresponding to the second logical function on the lens when it is detected that the display module is stationary at the third position on the lens.

In some optional embodiments, the second logical function may refer to at least one logical function selected from all (user-oriented and system-oriented) logical functions provided by a device or a system. The second logical function may be the same as or different from the first logical function.

Exemplarily, the second logical function may be a main interface output function, a phone dialing function, an intelligent assistant function, a music player function, a video player function, a camera function, an album function, a social application function, and the like.

The third position may be the same as or different from the second position.

Exemplarily, the third position may be a center point of the lens, an upper boundary point of the lens (or a preset display area), a lower boundary point of the lens (or a preset display area), and the like.

Exemplarily, still taking the foregoing FIG. 1 to FIG. 12 as examples, when it is detected that the display module 2 is stationary at the center point of the lens 12, the display module 2 is controlled to display a main interface on the lens 12. When it is detected that the display module 2 is stationary at an upper boundary point of the lens 12, the display module 2 is controlled to display a function interface of a navigation application on the lens 12.

In some optional embodiments, the target motion state includes that the display module rotate about an axis. The target logical function includes a third logical function. The third logical function is a logical function currently running in the foreground. Step S12 includes:
controlling the display module to update a target area in a third graphical interface currently displayed on the lens when it is detected that the display module rotates about the axis. The third graphical interface is a graphical interface corresponding to the third logical function. The target area is a graphical area corresponding to a sub-function of the third logical function. That the display module rotates about an axis is preset as a trigger condition for triggering the sub-function of the third logical function.

In some optional embodiments, the third logical function may refer to at least one foreground-running logical function selected from all (user-oriented and system-oriented) logical functions provided by a device or a system.

Exemplarily, the third logical function may be a main interface output function, a phone dialing function, an intelligent assistant function, a music player function, a video player function, a camera function, an album function, a social application function, and the like.

In some optional embodiments, the sub-functions of the third logical function may be a page-scrolling function, a scrolling (forward/backward) operation function, and the like in the logical function currently running in the foreground.

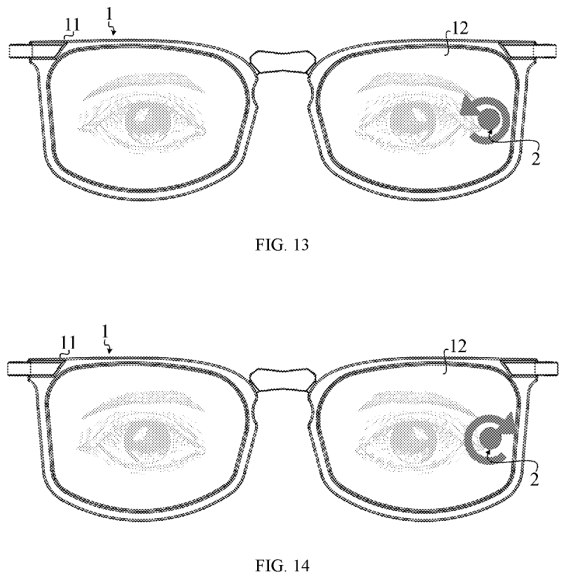

Exemplarily, as shown in FIG. 13 and FIG. 14, FIG. 13 and FIG. 14 are each a schematic diagram showing an application scenario of a display module according to an embodiment of the present disclosure. For example, when the third logical function is a main interface output function, counterclockwise axial rotation of the display module 2 as shown in FIG. 13 may be preset as a trigger condition for scrolling the main interface up (or down), and clockwise axial rotation of the display module 2 as shown in FIG. 14 may be preset as a trigger condition for scrolling the main interface down (or up). When counterclockwise or clockwise axial rotation of the display module 2 is detected, the display module 2 is controlled to update the main interface currently displayed on the lens 12, that is, to display a previous page or a next page of the main interface on the lens 12.

For another example, when the third logical function is a music player function, counterclockwise axial rotation of the display module 2 as shown in FIG. 13 may be preset as a trigger condition for switching to a previous (or next) song, and clockwise axial rotation of the display module 2 as shown in FIG. 14 may be preset as a trigger condition for switching to a next (or previous) song. When counterclockwise or clockwise axial rotation of the display module 2 is detected, a song switching operation is performed on the currently playing song, and the display module 2 is controlled to update the music player interface currently displayed on the lens 12, that is, to update the song information in the music player interface on the lens 12 to information of a previous (or next) song.

In some optional embodiments, the step of controlling the display module to update the target area in the third graphical interface currently displayed on the lens when it is detected that the display module rotates about the axis includes:

controlling the display module to update the target area in the third graphical interface currently displayed on the lens when it is detected that a rotation angle of the display module rotating about an axis is no less than a preset first threshold angle β.

The first threshold angle β may be flexibly set by those skilled in the art or a user according to actual requirements. For example, the first threshold angle β may be 15°, 20°, 25°, 30°, or the like.

Exemplarily, referring to FIG. 14, when it is detected that a clockwise rotation angle of the display module 2 about an axis is no less than the first threshold angle β, the display module 2 is controlled to update the target area in the third graphical interface currently displayed on the lens 12. This avoids triggering the sub-function of the third logical function and causing the display module 2 to start updating the third interface displayed on the lens 12 when the display module 2 is slightly driven to rotate about an axis. Thus, false triggering of the sub-function of the third logical function can be reduced to a certain extent.

In other optional embodiments, the third logical function may also be a logical function running in the background. For example, an imaging module of the display module is in a standby state, while a music playback function is running in the background. At this time, axial rotation of the display module may still be preset as a trigger condition for a song switching operation, so that the user can quickly switch songs, which facilitates quick interaction between the user and the device. In this case, it is unnecessary to control the display module to update the graphical interface (because the logical function runs in the background without outputting any graphical interface).

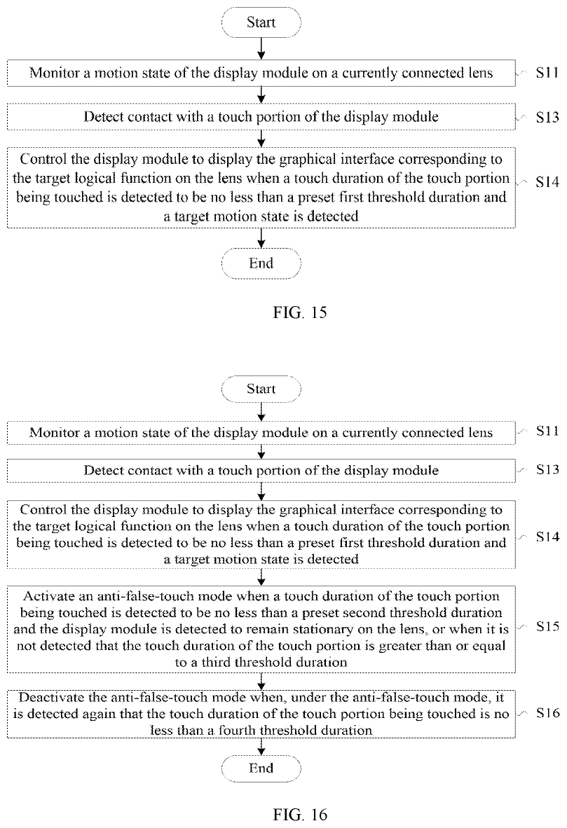

Embodiments of the present disclosure provide a control method for a display module. The display module is configured to be connected to a lens of glasses and perform display on the connected lens. The control method for the display module may be executed by at least one of the glasses 1, the display module 2, the near-eye display apparatus 10, or the smart terminal shown in FIG. 1 to FIG. 5, so as to control specific content of a graphical user interface (GUI) displayed by the display module 2 on the glasses 1 (or the near-eye display apparatus 10) connected thereto. As shown in FIG. 15, FIG. 15 is a schematic flowchart showing steps of a control method for a display module according to an embodiment of the present disclosure. The control method for the display module includes the following steps.

S11: Monitor a motion state of the display module on a currently connected lens.

Please refer to the foregoing description of Step S11, which will not be repeated herein.

S13: Detect contact with a touch portion of the display module.

Please refer to the foregoing description related to the display module 2 in the embodiments of FIG. 1 to FIG. 3 for Step S13, which will not be repeated herein.

It should be noted that there is no sequential relationship between S11 and S13, that is, S11 and S13 may be executed in parallel.

S14: Control the display module to display the graphical interface corresponding to the target logical function on the lens when a touch duration ΔT of the touch portion being touched is detected to be no less than a preset first threshold duration T_1 and a target motion state is detected.

Comparing Step S14 with Step S12, Step S14 adds conditions for triggering the target logical function and controlling the display module to display the graphical interface corresponding to the target logical function on the lens. Triggering requires not only detecting that the motion state of the display module is the target motion state, but also detecting that the touch duration ΔT of the touch portion of the display module being touched is no less than the preset first threshold duration T_1. That is, only when both the movement of the display module on the lens and effective touching of the display module are detected, the target logical function is triggered and the display module is controlled to display the corresponding graphical interface on the lens. This can avoid possible false triggering in certain scenarios. For example, as shown in FIG. 2, a user wears glasses 1 while in motion. The display module 2 may jitter as the user moves, and such jitter may conform to the target motion state. However, if touching of the touch portion of the display module by the user is not detected, or a touch is detected but the touch duration ΔT is less than the preset first threshold duration T_1, the target logical function will not be triggered, and the display module will not be controlled to display the graphical interface corresponding to the target logical function on the lens, thereby effectively preventing false triggering.

Embodiments of the present disclosure provide a control method for a display module. The display module is configured to be connected to a lens of glasses and perform display on the connected lens. The control method for the display module may be executed by at least one of the glasses 1, the display module 2, the near-eye display apparatus 10, or the smart terminal shown in FIG. 1 to FIG. 5, so as to control specific content of a graphical user interface (GUI) displayed by the display module 2 on the glasses 1 (or the near-eye display apparatus 10) connected thereto. As shown in FIG. 16, FIG. 16 is a schematic flowchart showing steps of a control method for a display module according to an embodiment of the present disclosure. The control method for the display module includes the following steps.

S11: Monitor a motion state of the display module on a currently connected lens.

S13: Detect contact with a touch portion of the display module.

S14: Control the display module to display a graphical interface corresponding to a target logical function on the lens when a touch duration ΔT of the touch portion being touched is detected to be no less than a preset first threshold duration T_1 and a target motion state is detected.

Please refer to the foregoing description for steps S11 to S14, which will not be repeated herein.

S15: Activate an anti-false-touch mode when a touch duration ΔT of the touch portion being touched is detected to be no less than a preset second threshold duration T_2 and the display module is detected to remain stationary on the lens, or when it is not detected that the touch duration of the touch portion is greater than or equal to a third threshold duration T_3.

The anti-false-touch mode refers to a mode in which the display module is controlled to maintain, on the lens, displaying of the graphical interface corresponding to a logical function currently running in the foreground.

The anti-false-touch mode is triggered when the touch duration ΔT of the touch portion being touched is detected to be no less than the preset second threshold duration T_2 and the display module is detected to remain stationary on the lens. That is, some embodiments of the present disclosure provide a function option for a user to actively activate the anti-false-touch mode. The user only needs to touch the touch portion of the display module continuously for at least the duration T_2 without moving the display module during this period to enter the anti-false-touch mode. This allows the user to switch the graphical interface displayed on the lens by the display module to a desired interface before wearing the glasses for sports (see FIG. 2). For example, before the user rides, the graphical interface displayed on the lens by the display module can be switched to the navigation interface, and the anti-false-touch mode can be activated, so that the user can use the navigation function during riding.

The anti-false-touch mode is activated when it is not detected that the touch duration of the touch portion is greater than or equal to the third threshold duration T_3. That is, some embodiments of the present disclosure further provide a function option for passively activating the anti-false-touch mode. When a user does not interact with the display module for a long time (i.e., the duration T_3), that is, does not touch the display module, it may be deemed that the user temporarily has no need to interact with the device. The anti-false-touch mode can be passively activated to suspend monitoring of the motion state of the display module, and the monitoring of the motion state is resumed after the anti-false-touch mode is deactivated, so as to save device power.

In some optional embodiments, the first threshold duration is less than the second threshold duration. Assuming the first threshold duration is 1 second and the second threshold duration is 0.5 seconds, namely the first threshold duration is greater than the second threshold duration, the following situation may occur: the user has not decided how to move the display module within the first 0.6 seconds of touching the display module, while the anti-false-touch mode is already activated. Even if the user moves the display module in the subsequent 0.4 seconds and the movement of the display module is a target motion state, the target logical function corresponding to the target motion state will not be triggered because the device enters the anti-false-touch mode when the display module is touched for 0.5 seconds (i.e., the triggering condition corresponds to the target logical function of the target motion state). Correspondingly, the display module will not display the graphical interface corresponding to the target logical function on the lens. In addition, the user has difficulty accurately perceiving the touch duration, which causes inconvenience in use. However, when the first threshold duration is less than the second threshold duration, the aforementioned “awkward” phenomenon can be avoided, thus facilitating user interaction with the display module.

In some optional embodiments, a prompt indicating that the anti-false-touch mode has been activated is output while the anti-false-touch mode is activated. The prompt may be text, an image, a video animation, or other prompt content displayed on the lens by the display module, so that the user can be informed that the anti-false-touch mode of the device has been activated.

S16: Deactivate the anti-false-touch mode when, under the anti-false-touch mode, it is detected again that the touch duration of the touch portion being touched is no less than a fourth threshold duration T_4.

After the device enters the anti-false-touch mode, the anti-false-touch mode is deactivated when the touch portion of the display module is detected to be touched again and the touch duration reaches the fourth threshold duration T_4, so as to allow the user to interact with the display module again.

In some optional embodiments, the fourth threshold duration is less than or equal to the first threshold duration.

When the first threshold duration is less than the fourth threshold duration, after the anti-false-touch mode is entered, the user must first touch the display module for the fourth threshold duration to deactivate the anti-false-touch mode before interacting with the display module, resulting in inconvenience in use. When the fourth threshold duration is less than or equal to the first threshold duration, the user can quickly deactivate the anti-false-touch mode to interact with the display module again.

In some optional embodiments, a prompt indicating that the anti-false-touch mode has been deactivated is output while the anti-false-touch mode is deactivated. The prompt may be text, an image, a video animation, or other prompt content displayed on the lens by the display module, so that the user can be informed that the anti-false-touch mode of the device has been deactivated.

In some optional embodiments, when the anti-false-touch mode is deactivated, and it is detected that the display module is stationary on the lens and the touch portion is touched, the display module is controlled to display movement prompt content around the display module on the lens.

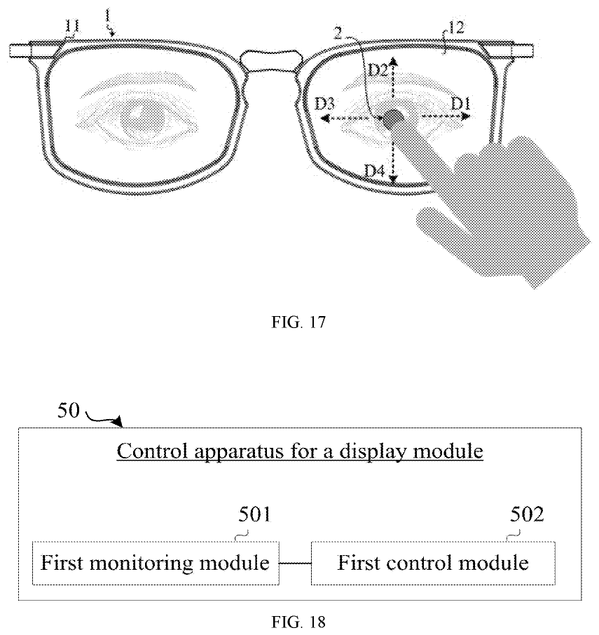

Exemplarily, as shown in FIG. 17, FIG. 17 is a schematic diagram showing an application scenario of a display module according to an embodiment of the present disclosure. Referring to FIG. 17, when it is detected that the display module 2 is stationary on the lens 12 and the touch portion of the display module 2 is touched, the display module 2 is controlled to display movement prompt content around the display module 2 on the lens 12. The prompt content prompts the user to move the display module 2 in multiple directions.

In some optional embodiments, based on the foregoing embodiments, the control method for a display module provided by the embodiments of the present disclosure further provides additional interaction modes for a user to interact with glasses (or a near-eye display apparatus) or a device connected to the display module. Such modes mainly relate to various interaction manners available for the user when the display module is stationary on the lens rather than moving relative to the lens. The specific steps include the following:
obtaining multimedia data and eye tracking data;
when it is detected that the display module is stationary on the lens and the touch portion is touched according to a target touch mode, or when it is detected that the display module is stationary on the lens and a target instruction is identified from the multimedia data, or when it is detected that the display module is stationary on the lens and a target eye movement mode is identified from the eye tracking data, controlling the display module to display a graphical interface corresponding to a target logical function on the lens, or controlling the display module to update a target area in a third graphical interface currently displayed on the lens. The third graphical interface is a graphical interface corresponding to a third logical function, the third logical function is a logical function currently running in the foreground, the target area is a graphical area corresponding to a sub-function of the third logical function, and the target touch mode, the target instruction and the target eye movement mode are preset as trigger conditions for triggering the target logical function or preset as trigger conditions for triggering the sub-function of the third logical function.

The multimedia data may be image/video data obtained by a miniature camera built into the display module or voice data obtained by a miniature microphone built into the display module. The eye tracking data is eye image data of a user obtained by a miniature camera built into the display module.

The target touch mode may be a single tap, a double tap, a triple tap, or the like. The target instruction may be a preset target gesture, a target voice command, or the like. The target eye movement mode may be eyeball movement according to a preset rule. Similarly, the target touch mode, the target instruction and the target eye movement mode are similar to the aforementioned target motion state, and may also be preset as trigger conditions for triggering the target logical function or trigger conditions for triggering the sub-function of the third logical function. When it is detected that the display module is stationary on the lens and the touch portion is touched according to the target touch mode, or when it is detected that the display module is stationary on the lens and the target instruction is identified from the multimedia data, or when it is detected that the display module is stationary on the lens and the target eye movement mode is identified from the eye tracking data, a target logical function (or a sub-function of the third logical function) for which the target touch mode, the target instruction and/or the target eye movement mode serve as (preset) trigger conditions is triggered, thereby controlling the display module to display the graphical interface corresponding to the triggered target logical function on the lens (or controlling the display module to update the target area in the third graphical interface currently displayed on the lens). The principle thereof is similar to that of the aforementioned target motion state triggering the target logical function (or a sub-function of the third logical function), thereby controlling the display module to display the graphical interface corresponding to the triggered target logical function on the lens (or controlling the display module to update the target area in the third graphical interface currently displayed on the lens), which will not be repeated herein. Those skilled in the art may understand the principle with reference to the foregoing description.

In some optional embodiments, a preset display area is disposed on the lens connected to the display module. The display module only performs display within the preset display area, rather than on the entire lens. Therefore, the display module is controlled to display a graphical interface corresponding to the target logical function on the lens when a target motion state is detected within the preset display area on the lens. When it is detected that the display module moves out of the preset display area, a low-power mode is activated. This saves power consumption of the device and extends the battery life and service life of the device.

It should be noted that although the foregoing embodiments are described by taking a monocular scenario (i.e., the display module provided in the embodiments of the present disclosure is connected to only one lens of the glasses) as an example, it is obvious that all embodiments provided herein are also applicable to a binocular scenario (i.e., the display module provided in the embodiments of the present disclosure is connected to both lenses of glasses).

The control method for the display module provided by the embodiments of the present disclosure can be executed by a control apparatus for the display module. In the embodiments of the present disclosure, the control apparatus for the display module is described by taking the control apparatus for the display module executing the control method for the display module as an example.

FIG. 18 is a schematic structural diagram showing a control apparatus for a display module according to an embodiment of the present disclosure. Referring to FIG. 18, a control apparatus 50 of the display module is provided. The display module is configured to be connected to a lens of glasses and perform display on the connected lens. The control apparatus 50 includes:
a first monitoring module 501, configured to monitor a motion state of the display module on a currently connected lens; and
a first control module 502, configured to control the display module to display a graphical interface corresponding to a target logical function on the lens when a target motion state is detected. The target motion state is preset as a trigger condition for triggering the target logical function.

In some optional embodiments, the target motion state includes the movement of the display module on the lens satisfying a first preset condition. The target logical function includes a first logical function. The movement of the display module on the lens satisfying the first preset condition is preset as a trigger condition for triggering the first logical function. The first control module 502 includes:
a first control submodule, configured to control the display module to display a first graphical interface corresponding to the first logical function on the lens when it is detected that the movement of the display module on the lens satisfies the first preset condition.

In some optional embodiments, the first preset condition is any one or a combination of the following:
a displacement distance of the movement is no less than a preset first threshold length;
a displacement distance of the movement is no less than a preset first threshold length, and a displacement direction of the movement is a preset first direction;
a displacement distance of the movement is no less than a preset first threshold length, and a starting point of the movement is a preset first position, the first position being a fixed position selected on the lens;
a displacement distance of the movement is no less than a preset first threshold length, the displacement direction of the movement is a preset first direction, and a starting point of the movement is the first position;
an endpoint of the movement is a preset second position, the second position being a fixed position selected on the lens;
a shape similarity between a movement trajectory and a preset trajectory is no less than a preset first threshold.

In some optional embodiments, the target motion state includes the display module being stationary at a third position on the lens, the third position being a fixed position selected on the lens. The target logical function includes a second logical function. The display module being stationary at the third position on the lens is preset as a trigger condition for triggering the second logical function. The first control module 502 includes:
a second control submodule, configured to control the display module to display a second graphical interface corresponding to the second logical function on the lens when it is detected that the display module is stationary at the third position on the lens.

In some optional embodiments, the target motion state includes the display module rotating about an axis; the target logical function includes a third logical function, and the third logical function is a logical function currently running in the foreground. The first control module 502 includes:
a third control submodule, configured to control the display module to update a target area in a third graphical interface currently displayed on the lens when it is detected that the display module rotates about the axis. The third graphical interface is a graphical interface corresponding to the third logical function, the target area is a graphical area corresponding to a sub-function of the third logical function, and the display module rotating about an axis is preset as a trigger condition for triggering the sub-function of the third logical function.

In some optional embodiments, the third control submodule includes:

a first control unit, configured to control the display module to update the target area in the third graphical interface currently displayed on the lens when it is detected that a rotation angle of the display module rotating about an axis is no less than a preset first threshold angle.

In some optional embodiments, the control apparatus 50 further includes:
a first detection module, configured to detect contact with a touch portion of the display module;
the first control module 502 includes:
a fourth control submodule, configured to control the display module to display a graphical interface corresponding to the target logical function on the lens when a touch duration of the touch portion being touched is detected to be no less than a preset first threshold duration and a target motion state is detected.

In some optional embodiments, the control apparatus 50 further includes:
a first activation module, configured to activate an anti-false-touch mode when a touch duration of the touch portion being touched is detected to be no less than a preset second threshold duration and the display module is detected to remain stationary on the lens, or when it is not detected that the touch duration of the touch portion is greater than or equal to a third threshold duration. The anti-false-touch mode refers to a mode in which the display module is controlled to maintain, on the lens, displaying of a graphical interface corresponding to a logical function currently running in the foreground.

In some optional embodiments, the first threshold duration is less than the second threshold duration.

In some optional embodiments, the control apparatus 50 further includes:
a first deactivation module, configured to deactivate the anti-false-touch mode when it is detected again that a touch duration of the touch portion being touched is no less than a fourth threshold duration in the anti-false-touch mode.

In some optional embodiments, the fourth threshold duration is less than or equal to the first threshold duration.

In some optional embodiments, the control apparatus 50 further includes:
a first prompt module, configured to output a prompt indicating that the anti-false-touch mode has been activated while activating the anti-false-touch mode;
a second prompt module, configured to output a prompt indicating that the anti-false-touch mode has been deactivated while deactivating the anti-false-touch mode.

In some optional embodiments, the control apparatus 50 further includes:
a second control module, configured to, control the display module to display movement prompt content around the display module on the lens when it is detected that the display module is stationary on the lens and the touch portion is touched.

In some optional embodiments, the control apparatus 50 further includes:
a third control module, configured to, when it is detected that the display module is stationary on the lens and the touch portion is touched according to a target touch mode, control the display module to display a graphical interface corresponding to a target logical function on the lens, or control the display module to update a target area in a third graphical interface currently displayed on the lens. The third graphical interface is a graphical interface corresponding to a third logical function, the third logical function is a logical function currently running in the foreground, the target area is a graphical area corresponding to a sub-function of the third logical function, and the target touch mode is preset as a trigger condition for triggering the target logical function or a trigger condition for triggering the sub-function of the third logical function.

In some optional embodiments, the control apparatus 50 further includes:
a first acquisition module, configured to obtain multimedia data;
a third control module, configured to, when it is detected that the display module is stationary on the lens and a target instruction is identified from the multimedia data, control the display module to display a graphical interface corresponding to a target logical function on the lens, or control the display module to update a target area in a third graphical interface currently displayed on the lens. The third graphical interface is a graphical interface corresponding to a third logical function, the third logical function is a logical function currently running in the foreground, the target area is a graphical area corresponding to a sub-function of the third logical function, and the target instruction is preset as a trigger condition for triggering the target logical function or a trigger condition for triggering the sub-function of the third logical function.

In some optional embodiments, the control apparatus 50 further includes:
a second acquisition module, configured to obtain eye tracking data;
a fourth control module, configured to, when it is detected that the display module is stationary on the lens and a target eye movement mode is identified from the eye tracking data, control the display module to display a graphical interface corresponding to a target logical function on the lens, or control the display module to update a target area in a third graphical interface currently displayed on the lens. The third graphical interface is a graphical interface corresponding to a third logical function, the third logical function is a logical function currently running in the foreground, the target area is a graphical area corresponding to a sub-function of the third logical function, and the target eye movement mode is preset as a trigger condition for triggering the target logical function or a trigger condition for triggering the sub-function of the third logical function.

In some optional embodiments, the control apparatus 50 includes:
a second monitoring module, configured to control the display module to display a graphical interface corresponding to the target logical function on the lens when a target motion state is detected within a preset display area on the lens;
a second activation module, configured to activate a low-power mode when it is detected that the display module moves out of the preset display area.

The control apparatus 50 for the display module according to some embodiments of the present disclosure may be an electronic device or a component of an electronic device, such as an integrated circuit or a chip. The electronic device may be a terminal or other non-terminal device. Exemplarily, the electronic device may be a mobile phone, a tablet computer, a laptop, a handheld computer, a vehicle electronic device, a Mobile Internet Device (MID), an Augmented Reality (AR)/Virtual Reality (VR) device, a robot, a wearable device, an Ultra-Mobile Personal Computer (UMPC), a netbook, a Personal Digital Assistant (PDA), or the like, and may also be a server, Network Attached Storage (NAS), a Personal Computer (PC), a Television (TV), a teller machine, a self-service terminal, or the like. The embodiments of the present disclosure are not limited thereto.

The control apparatus 50 for the display module according to some embodiments of the present disclosure may be a device provided with an operating system. The operating system may be an Android operating system, an iOS operating system, or other feasible operating systems, which is not specifically limited in the embodiments of the present disclosure.

The control apparatus 50 for the display module according to the embodiments of the present disclosure is capable of implementing all processes of the embodiments shown in FIG. 1 to FIG. 17, and details are not repeated herein to avoid redundancy.

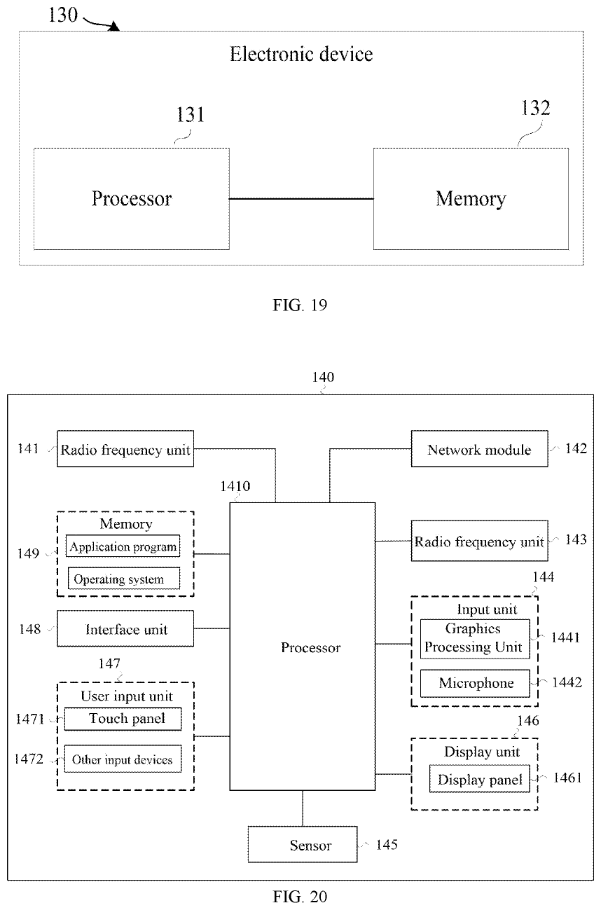

In some optional embodiments, as shown in FIG. 19, some embodiments of the present disclosure further provide an electronic device 130, including a processor 131 and a memory 132. The memory 132 stores a program or an instruction executable on the processor 131. When the program or the instruction is executed by the processor 131, each step of the foregoing embodiments of the control method for the display module is implemented, and the same technical effects can be achieved, which will not be repeated herein to avoid redundancy.

It should be noted that the electronic devices in the embodiments of the present disclosure include the foregoing mobile electronic devices and non-mobile electronic devices.

FIG. 20 is a schematic diagram showing a hardware structure of an electronic device according to an embodiment of the present disclosure.

The electronic device 140 includes, but is not limited to, a radio frequency unit 141, a network module 142, an audio output unit 143, an input unit 144, a sensor 145, a display unit 146, a user input unit 147, an interface unit 148, a memory 149, a processor 1410, or the like. Those skilled in the art will understand that the electronic device 140 may further include a power supply (such as a battery) for supplying power to each component. The power supply may be logically connected to the processor 1410 via a power management system, thereby enabling functions of managing charging, discharging, and power consumption via the power management system. The structure of the electronic device shown in FIG. 20 does not constitute a limitation on the electronic device; the electronic device may include more or fewer components than illustrated, or combine certain components, or adopt different component arrangements, which will not be elaborated herein.

The processor 1410 is configured to:
monitor a motion state of the display module on a currently connected lens;
control the display module to display a graphical interface corresponding to a target logical function on the lens when a target motion state is detected. The target motion state is preset as a trigger condition for triggering the target logical function.

It should be understood that in some embodiments of the present disclosure, the input unit 144 may include a Graphics Processing Unit (GPU) 1441 and a microphone 1442. The graphics processing unit 1441 is configured to process image data of static pictures or videos obtained by an image capturing device (such as a camera) in a video capture mode or an image capture mode. The display unit 146 may include a display panel 1461. The display panel 1461 may be configured in the form of a liquid crystal display, an organic light-emitting diode, or the like. The user input unit 147 includes at least one of a touch panel 1471 and other input devices 1472. The touch panel 1471 is also referred to as a touchscreen. The touch panel 1471 may include two parts: a touch detection device and a touch controller. Other input devices 1472 may include, but are not limited to, a physical keyboard, function keys (such as volume control buttons, switch buttons, etc.), a trackball, a mouse, and a joystick, etc., which will not be elaborated herein.

The memory 149 may be configured to store software programs and various data. The memory 149 may mainly include a first storage area for storing a program or an instruction and a second storage area for storing data. The first storage area may store an operating system and application programs or instructions required for at least one function (such as an audio playback function, an image playback function, etc.). In addition, the memory 149 may include volatile memory or non-volatile memory, or the memory 149 may include both volatile and non-volatile memory. The non-volatile memory may include, but is not limited to, read-only memory (ROM), programmable read-only memory (PROM), erasable programmable read-only memory (EPROM), electrically erasable programmable read-only memory (EEPROM), or flash memory. The volatile memory may include, but is not limited to, random access memory (RAM), static random access memory (SRAM), dynamic random access memory (DRAM), synchronous dynamic random access memory (SDRAM), double data rate synchronous dynamic random access memory (DDR SDRAM), enhanced synchronous dynamic random access memory (ESDRAM), synch link dynamic random access memory (SLDRAM), and direct rambus random access memory (DRRAM). The memory 149 in the embodiments of the present disclosure includes, but is not limited to, the above and any other suitable types of memories.

The processor 1410 may include one or more processing units. Optionally, the processor 1410 integrates an application processor and a modem processor. The application processor mainly processes operations related to an operating system, a user interface, application programs, or the like. The modem processor mainly processes wireless communication signals, such as a baseband processor. It can be understood that the foregoing modem processor may also be not integrated into the processor 1410.

An execution subject of the control method for the display module provided by the embodiments of the present disclosure may be AR glasses. In the embodiments of the present disclosure, an electronic system is described by taking a near-eye display apparatus executing the control method for the display module as an example.

In some optional embodiments, as shown in FIG. 21, the embodiments of the present disclosure further provide AR glasses 150, including a processor 151 and a memory 152. The memory 152 stores a program or an instruction executable on the processor 151. When the program or instruction is executed by the processor 151, each step of the foregoing embodiments of the control method for the display module is implemented with the same technical effects achieved, and details are not repeated herein to avoid redundancy.

In the related art, certain glasses (such as goggles) are designed with lens dimensions much larger than the human eye's field of view, such that a user wearing the glasses cannot see or clearly view some areas on the lens. That is, some areas (i.e., blind areas) on the lens of the glasses are located outside the field of view of the wearing user. If a display module connected to the lens of the glasses performs display within a blind area on the lens, the wearing user will be unable to see or clearly view the image content. Embodiments of the present disclosure aim to provide a control method and apparatus for a display module, an electronic device, a near-eye display apparatus, a medium, a chip, and a computer program product, so as to independently or semi-independently address, to a certain extent, the challenge that display performed by a display module connected to a lens of glasses within a blind area of the lens causes the wearing user to fail to see or clearly view the image content. The term “independently address” refers to providing a hardware structural solution that can operate independently without software cooperation, so as to achieve the effect that the display module connected to the lens of the glasses in near-eye display technology does not perform display within the blind area of the lens. The term “semi-independently address” refers to providing a hardware structural solution that, when cooperating with near-eye display software (for example, software for user interaction with virtual information in AR technology), can achieve the effect that the display module connected to the lens of the glasses does not perform display within the blind area of the lens in near-eye display technology.

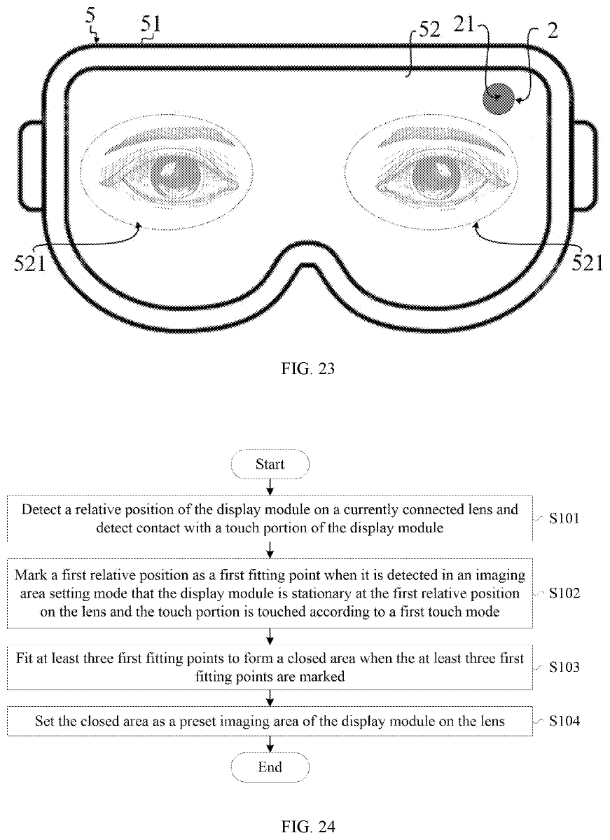

As shown in FIG. 23, FIG. 23 is a schematic diagram showing an application scenario of a display module according to an embodiment of the present disclosure. In this exemplary scenario, a front view of a pair of goggles is schematically shown. To enable the goggles to better protect the wearer's eyes as much as possible, manufacturers usually manufacture the lens with a relatively large size, so as to fully cover and protect the eye area without affecting the wearer's vision. Referring to FIG. 23, after a user wears the exemplary goggles 5, edge areas of the lens 52 closer to the frame 51 are difficult or even impossible for the user to clearly view; that is, some edge areas on the lens 52 constitute visual blind areas of the user.

Exemplarily, assuming that after user A wears the goggles 5, an area that user A can clearly view on the lens 52 is an area 521 enclosed by a dashed line (the area is referred to as a visible area of user A) as shown in the figure. (As is generally known, such a dashed line ring is generally not physically present on actual goggles, and the dashed line is used to schematically illustrate a virtual boundary between the blind area and the visible area.) The other areas on the lens 52 other than the area 521 are blind areas of user A. Only when the display module 2 is located within the area 521 and performs display inside the area 521 can user A clearly view the display module 2 (the display area 21 thereof), and the user can view the image formed by the display module 2 within the area 521 through the display area 21 of the display module 2. If the display module 2 is located within a blind area on the lens 52 (such as the position shown in FIG. 23), user A cannot even see the display module 2, let alone the display area 21 of the display module 2, and consequently cannot view the image formed by the display module 2 on the lens 52 by observing the display area 21 of the display module 2.

Therefore, in the related art, certain glasses (such as the goggles shown in FIG. 23) are designed with lens dimensions much larger than the human eye field of view for protection or appearance considerations, such that a user wearing the glasses cannot see or clearly view some areas on the lens. That is, some areas (i.e., blind areas) on the lens of the glasses are located outside the field of view of the wearing user. If a display module connected to the lens of the glasses performs display within a blind area on the lens, the wearing user will be unable to see or clearly view the image content.

Embodiments of the present disclosure provide a control method and apparatus, an electronic device, a near-eye display apparatus, a medium, a chip, and a computer program product for a display module, which can independently or semi-independently address, to a certain extent, the challenge that display performed by a display module connected to a lens of glasses within a lens blind area causes the wearing user to fail to see or clearly view the image content.

On this basis, some embodiments of the present disclosure are described in detail below.

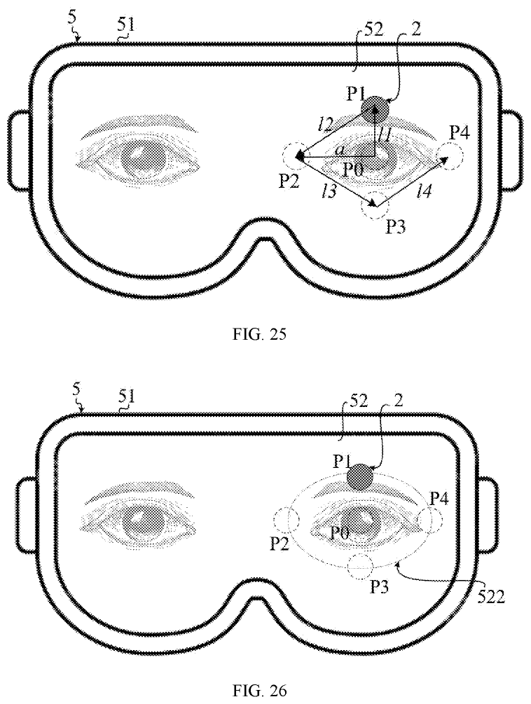

Embodiments of the present disclosure provide a control method for a display module. The display module is configured to be provided on an optical lens and output image content. Exemplarily, as shown in FIG. 1 to FIG. 5 and FIG. 22, the display module may be the display module 2 shown in FIG. 1 to FIG. 5 and FIG. 22, and the display module 2 can output image content on the lens 12 or the lens 52. The control method for the display module may be executed by at least one of the glasses 1 shown in FIG. 1 to FIG. 5, the display module 2 shown in FIG. 1 to FIG. 5, the near-eye display apparatus 10 or the smart terminal 4 shown in FIG. 4. The control method is capable of controlling specific content of a graphical user interface (GUI) displayed, by the display module 2, on the connected glasses 1 (or near-eye display apparatus 10 or goggles 5). FIG. 24 is a schematic flowchart showing a control method for a display module according to an embodiment of the present disclosure. To facilitate understanding of the control method, the flowchart shown in FIG. 24 is described below taking the goggles 5 in FIG. 23 as an example. Referring to FIG. 24, the control method for the display module includes the following steps.

S101: Detect a relative position of the display module on a currently connected lens and detect contact with a touch portion of the display module.

The lens refers to the lens of the glasses to which the display module is currently connected. Exemplarily, the lens may be any lens described in the foregoing embodiments, and details are not repeated herein.

In the embodiments of the present disclosure, the display module for augmented reality display and imaging on a lens of glasses is allowed to move on the connected lens, instead of being fixed to the lens. In some optional embodiments, an inertial sensor or an acceleration sensor (or a gyroscope) is provided in the display module. Such sensors can obtain instantaneous velocity and acceleration of the display module, so as to determine a motion trajectory of the display module based on the obtained instantaneous velocity and acceleration in combination with parameters such as time.

Optionally, a fixed reference point on the lens connected to the display module is pre-selected as an origin. The display module starts to move from the origin, and the motion trajectory of the display module is continuously monitored. A position of any point on the motion trajectory relative to the origin can represent the relative position of the display module with respect to the connected lens.

Exemplarily, as shown in FIG. 25, FIG. 25 is a schematic diagram showing an application scenario of a display module according to an embodiment of the present disclosure. For example, point P0 on the lens 52 is pre-selected as an origin. The display module 2 moves from the origin to point P1 along path l1, then to point P2 along path l2, subsequently to point P3 along path l3, and finally to point P4 along path l4. The motion trajectory 1 of the display module 2 at any time t during the movement process can be determined based on monitored motion parameters (such as velocity and acceleration) of the display module 2. A positional relationship between an endpoint of the motion trajectory at any time t and the origin P0 can represent the relative position of the display module 2 on the lens 52. For example, the display module 2 moves to point P1 at time t1. The positional relationship of point P1 relative to origin P0 can be determined based on the determined path l1, that is, the relative position of the display module 2 on the lens 52, which is exemplarily expressed as P1=(P0, (l1)→), indicating that point P1 is located at an endpoint of vector (l1)→, and vector (l1)→ starts from P0.

Similarly, when the motion trajectory of the display module 2 moving from P1 to P2 is 12, the positional relationship of P2 relative to P1 can be expressed as P2=(P1, (l2)→), indicating that point P2 is located at an endpoint of vector (l2)→, and vector (l2)→starts from P1. Based on a mathematical vector relationship, (l1)→+(l2)→=a→, so that P2=(P0, a→)=(P0, (l1)→+(l2)→). Correspondingly, P3=(P0, (l1)→+(l2)→+(l3)→), and P4=(P0, (l1)→+(l2)→+(l3)→+(l2)→). As is generally known, the foregoing vectors correspond to the displacements of the display module 2 during the movement process.

It should be supplemented that the paths and motion trajectories of the display module 2 in the foregoing embodiments are illustrated by straight line trajectories (paths). As is generally known, the display module 2 can move arbitrarily and is not limited to the straight line trajectories in the embodiments, and may also be a curved trajectory.

For the detection of contact with the touch portion of the display module, reference may be made to the foregoing related description, which will not be repeated herein.

S102: Mark a first relative position as a first fitting point when it is detected in a display area setting mode that the display module is stationary at the first relative position on the lens and the touch portion is touched according to a first touch mode. The first relative position is an arbitrary position of the display module on the lens, and in the display area setting mode, the first touch mode is a touch mode for indicating that a user can clearly view a display area of the display module.

The display area setting mode is a logical function that allows a user to set a preset display area on the lens connected to the display module. In some optional embodiments, the display module automatically enters the display area setting mode when the display module is first connected to the lens and is powered on. In some optional embodiments, an application (APP) for controlling the display module is provided on a smart terminal connected to the display module, and the user can activate the display area setting mode through a corresponding function option in the application. After entering this mode, the display module enters a preset display area setting process.

Exemplarily, the near-eye display apparatus 10 shown in FIG. 23 is the goggles 5 shown in FIG. 25. The display module 2 automatically enters the display area setting mode when the display module is first connected to the lens and is powered on. The user can also activate the display area setting mode of the display module 2 through the display area setting function option in an application (APP) for controlling the display module control on the smart terminal 4.

When the instantaneous velocity of the display module is detected to be zero, it may be determined that the display module is stationary on the lens.

Exemplarily, in the embodiment shown in FIG. 25, the display module 2 may be initially detected to be stationary at point P0, and then detected to be stationary again at point P1. Thereafter, stationary states of the display module are sequentially detected at point P2, point P3 and point P4. That is, each of P1, P2, P3 and P4 serves as a first relative position.

The first touch mode may be a preset touch mode, such as a single tap, a double tap, a triple tap, or the like on the touch portion of the display module. When it is detected that the display module is stationary at a certain position on the lens and the touch portion is touched according to the first touch mode, the position where the display module is located is marked as the first fitting point. The fitting points are configured to fit a boundary of the preset display area.

Exemplarily, in the embodiment of FIG. 25, when it is detected that the display module 2 moves from point P0 to each of points P1, P2, P3 and P4 and is stationary at each of points P1, P2, P3 and P4, and the touch portion is touched according to the first touch mode (e.g., a single tap), each of points P1, P2, P3 and P4 is marked as the first fitting point.

S103: Fit at least three first fitting points to form a closed area when the at least three first fitting points are marked.

S104: Set the closed area as a preset display area of the display module on the lens.

According to general mathematical principles, at least three points in space are required to form a closed area. Therefore, after at least three first fitting points are marked, all marked first fitting points may be fitted to form a closed area. The closed area fitted from all the first fitting points is set as the preset display area for displaying on the currently connected lens by the display module.

Fitting refers to connecting a plurality of points to form a closed area, such that a connecting line between any two points does not intersect a connecting line between any other two points. In some optional embodiments, at least three first fitting points may be fitted to form a closed area with a preset shape. For example, the preset shape may be an ellipse (a circle being a special case of an ellipse), a rectangle, a triangle, or the like. In some optional embodiments, during area fitting, a curve or a straight line may be adopted to connect two first fitting points having the shortest linear distance. When a curve is adopted, a smooth curve is preferably used for connection.

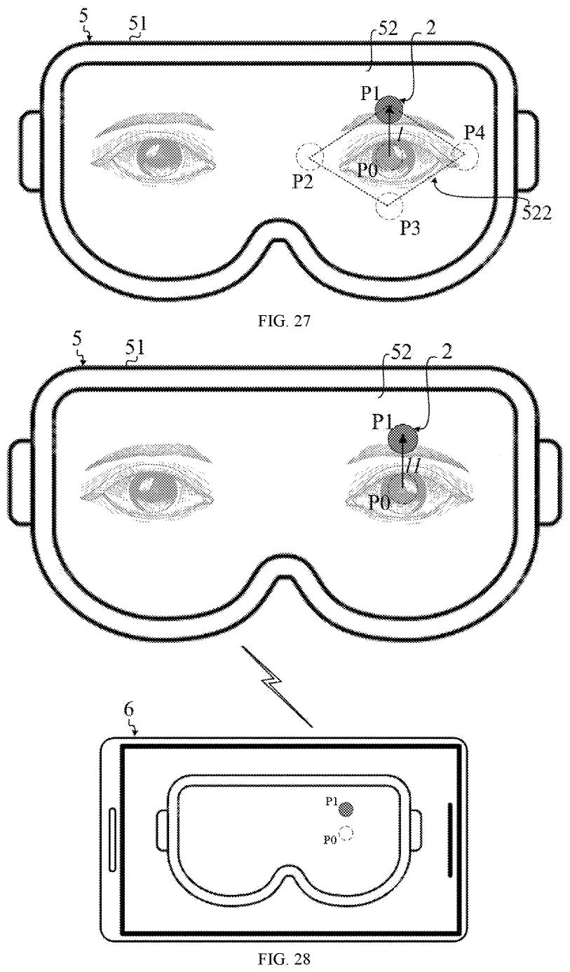

Exemplarily, as shown in FIG. 26 and FIG. 27, both figures are schematic diagrams showing an application scenario of a display module according to an embodiment of the present disclosure. Referring to FIG. 26, four first fitting points P1=(P0, (l1)→), P2=(P0, (l1)→+(l2)→), P3=(P0, (l1)→+(l2)→+(l3)→), and P4=(P0, (l1)→+(l2)→+(l3)→+(l2)→) are fitted to form an elliptical area, and the elliptical area is set as the preset display area 522 of the display module 2 on the lens 52. Referring to FIG. 27, the four first fitting points P1, P2, P3 and P4 are fitted to form a quadrilateral area, and the quadrilateral area is set as the preset display area 522 of the display module 2 on the lens 52.

In some optional embodiments, to facilitate user setup of the preset display area, the foregoing steps S101 to S104 may be assisted and implemented by a smart terminal communicatively connected to the display module (see FIG. 4). The following is an exemplary description.

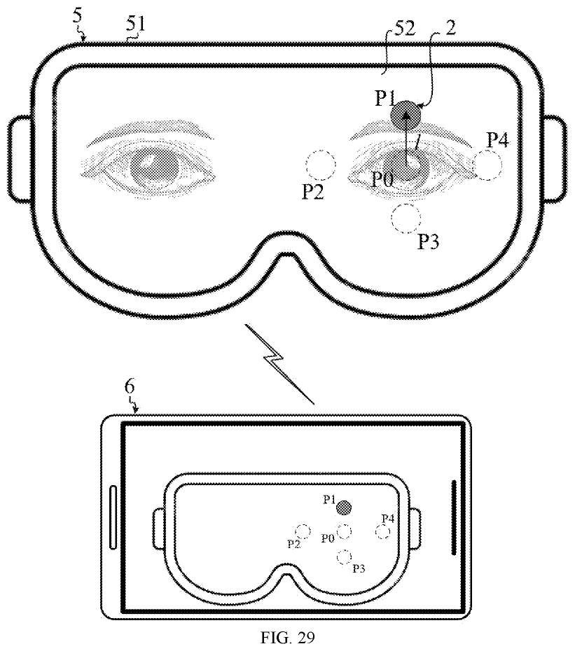

As shown in FIG. 28 to FIG. 29, each figure is a schematic diagram showing an application scenario of a display module according to an embodiment of the present disclosure. Referring to FIG. 28 to FIG. 29, the display module 2 maintains communication connection with a smart terminal 6, and the smart terminal 6 pre-acquires a virtual contour model of the goggles 5. The virtual contour model may be obtained by scanning the goggles 5 with a 3D scanner or obtained from a manufacturer of the goggles 5. After the display module 2 is connected (placed) on the lens 52, when the display module 2 activates the display area setting mode, the virtual contour model of the goggles 5 is correspondingly output on a screen of the smart terminal 6, and a relative position of the display module 2 on the goggles 5 is traced on the virtual contour model of the goggles 5. The display module 2 may be moved to different positions on the connected lens 52 for positioning, and each positioning point (i.e., fitting point) is confirmed based on whether the user wearing the goggles 5 can clearly view the display module. That is, the user places the display module 2 at different positions on the lens 52 for point alignment positioning. All positioning points are displayed on the smart terminal 6, and then all positioning points are fitted to form the preset display area.

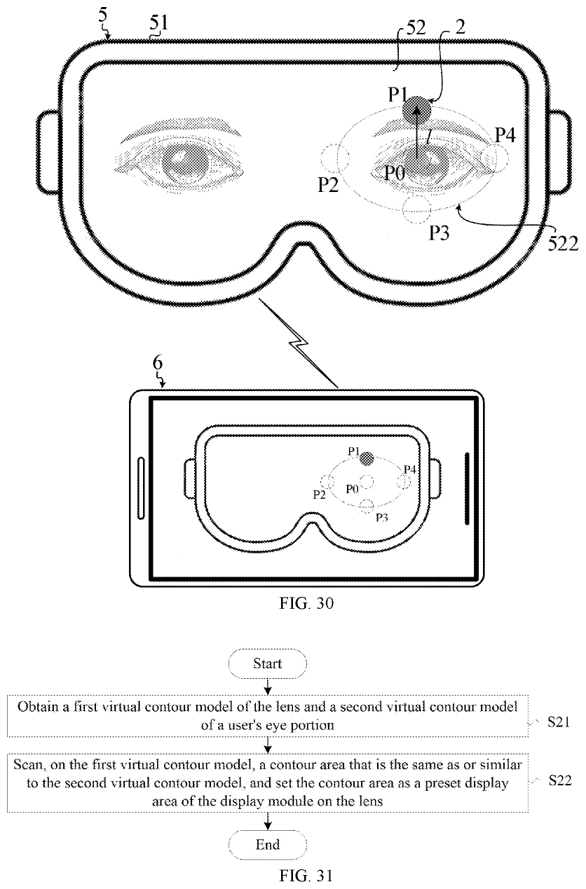

Referring to FIG. 28, when the display module 2 initially enters the display area setting mode, an initial position P0 of the display module 2 is displayed on the virtual contour model of the goggles 5 on the screen of the smart terminal 6. When the display module 2 moves from P0 to P1, the position P1 is displayed on the virtual contour model of the goggles 5 on the screen of the smart terminal 6. If the user confirms that the display module 2 can be clearly viewed at point P1, the position of P1 relative to the origin P0 is recorded. Referring to FIG. 29, after completing point marking positioning, all obtained positioning points (such as P1, P2, P3 and P4 in the embodiment of FIG. 29) are displayed on the virtual contour model of the goggles 5 on the screen of the smart terminal 6. Referring to FIG. 30, the fitted elliptical closed area is displayed on the virtual contour model of the goggles 5 on the screen of the smart terminal 6, and the closed area is set as the preset display area 522 for displaying on the lens 52 by the display module 2.

In some optional embodiments, when selecting the first relative position, priority is given to selecting an extreme position point on the lens adjacent to the frame, such as a position point adjacent to an edge area of the lens. When the user confirms that the display module cannot be clearly viewed at such position points, the user is prompted to gradually move the display module toward a center position point of the lens, so that the finally fitted preset display area is as large as possible to increase the area of the preset display area. As is generally known, the greater the number of calibrated first fitting points, the closer the fitted preset display area is to the user's visible area. Therefore, the number of first fitting points for fitting the preset display area may be flexibly set.

In the embodiments of the present disclosure, in the display area setting mode, by detecting the relative position of the display module on the currently connected lens and detecting the contact of the touch portion of the display module, at least three first fitting points confirmed to be clearly viewable by the user are determined on the lens connected to the display module. The at least three determined fitting points are then fitted to form a closed area. Since all boundary points of the closed area (as is generally known, the boundary points include the first fitting points) can be clearly viewed by the user, the entire closed area can also be clearly viewed by the user. The closed area is set as the preset display area of the display module on the lens. Thereafter, the display module performs display only within the preset display area on the lens rather than within a blind area of the lens. This effectively addresses the challenge that display performed by a display module connected to a lens of glasses within the lens blind area causes virtual information in the blind area to be invisible or unclear to the user wearing glasses.

Embodiments of the present disclosure provide a control method for a display module. The display module is configured to be provided on an optical lens and output image content. Exemplarily, as shown in FIG. 1 to FIG. 5 and FIG. 22 to FIG. 23, the display module may be the display module 2 shown in FIG. 1 to FIG. 5, and the display module 2 can output image content on the lens 12 or the lens 52. The control method for the display module may be executed by at least one of the glasses 1 in FIG. 1 to FIG. 5, the display module 2 in FIG. 1 to FIG. 5, the near-eye display apparatus 10 or the smart terminal 4 shown in FIG. 4. The control method is capable of controlling specific content of a graphical user interface (GUI) displayed, by the display module 2, on the connected glasses 1 (or near-eye display apparatus 10 or goggles 5). FIG. 25 is a schematic flowchart showing a control method for a display module according to an embodiment of the present disclosure. To facilitate understanding of the control method provided by some embodiments of the present disclosure, the flowchart shown in FIG. 25 is described below by taking the goggles 5 shown in FIG. 23 and the scenario shown in FIG. 32 as examples. Referring to FIG. 25, the control method for the display module includes the following steps.

S21: Obtain a first virtual contour model of the lens and a second virtual contour model of a user's eye portion;

S22: Scan, on the first virtual contour model, a contour area that is the same as or similar to the second virtual contour model, and set the contour area as a preset display area of the display module on the lens.

Referring to FIG. 32, the relevant description for the smart terminal 6 obtaining the first virtual contour model 5′ of the lens may refer to the foregoing content, which will not be repeated herein. Similarly, a 3D scanner may be configured to obtain the second virtual contour model of the eye portion of user A wearing the goggles 5, and the smart terminal 6 obtains the second virtual contour model from the 3D scanner. The smart terminal 6 displays the second virtual contour model and the first virtual contour model 5′ in an overlapped manner, scans out a contour area 522′ that is the same as or similar to the second virtual contour model on the first virtual contour model 5′, and sets the contour area 522′ as the preset display area 522 of the display module 2 on the lens 52.

Compared with the aforementioned setting method for a preset display area, this method is faster in process flow, but the difficulty lies in the fact that for each pair of glasses, each user wearing the glasses needs to simultaneously obtain the virtual contour of the glasses' lens and the virtual contour of the user's eye portion. Therefore, in practical application, the user may flexibly select the setting method for a preset display area according to actual needs.

After the preset display area is set, when the display module is located within the preset display area on the connected lens, the display module can perform display within the preset display area on the connected lens. When the display module is located outside the preset display area on the connected lens, the display module does not perform display on the connected lens. Thus, in some optional embodiments, a low-power mode is activated when it is detected that the display module is located outside the preset display area.

Exemplarily, in FIG. 27, after the preset display area is set, when the display module 2 moves out of the area 522 on the lens 52, the display module 2 activates the low-power mode. This saves power consumption of the device and extends battery life and service life. In the low-power mode, the display module 2 may be in a fully inactive state, a standby state, or a state where partial modules operate. When the display module 2 moves back into area 522, the display module 2 exits the low-power mode and resumes normal operation. In some optional embodiments, the user may further set specific states corresponding to the low-power mode in different time periods for a non-preset display area (i.e., the area outside area 522 on the lens 52 in the embodiment of FIG. 27). For example, the low-power mode from 11 p.m. to 7 a.m. the next day may be set to a fully inactive state, the low-power mode from 7 a.m. to 9 a.m., 12 p.m. to 2 p.m., and 5 p.m. to 8 p.m. may be set to a standby state, and the remaining time periods may be set to a state where partial modules operate (for example, the hardware for monitoring the motion state of the display module is in operation).

In some optional embodiments, based on the foregoing embodiments, the control method for a display module provided by the embodiments of the present disclosure further includes:
dividing the preset display area into at least two sub-display areas when receiving a partitioning instruction;
controlling the display module to display a first graphical interface within a first sub-display area when receiving a mapping instruction for displaying the first graphical interface within the first sub-display area. The first sub-display area is any one of the at least two sub-display areas.

The user may divide the preset display area into multiple sub-display areas, present different images in different sub-display areas, and set the image content presented in each sub-display area. When receiving a partitioning instruction input by the user, the display module divides the preset display area into the number of sub-display areas (exemplarily, the preset display area 522 is divided into six sub-display areas as shown in FIG. 33) in response to the area quantity specified in the partitioning instruction. When receiving a mapping instruction for a certain sub-display area, based on mapped data in the mapping instruction, the display module images a graphical interface corresponding to the mapped data within the sub-display area.

Exemplarily, FIG. 33 is a schematic diagram showing an application scenario of a display module according to an embodiment of the present disclosure. Referring to FIG. 33, the user sets a preset display area 522 for the display module 2 on the lens 52. The preset display area 522 is divided into six sub-display areas, and a graphical interface corresponding to mapped data in each sub-display area is displayed in each sub-display area. Icons A-I shown in FIG. 33 may be icons (thumbnails) of application programs or files, or other content such as a playing video.

In the embodiments of the present disclosure, to endow such conventional glasses with an augmented reality display function and achieve efficient interaction thereon, the user may customize and layout the specific preset display area as needed. For example, the lens of the glasses is generally circular, square, or of other shapes, and has a lens area larger than the field of view of the human eye. In such cases, the user may select a position with a good field of view as the preset display area. The preset display area may be divided into multiple sub-display areas. Each sub-display area may be configured to output a corresponding graphical interface, and multiple sub-areas can achieve multi-channel output of multiple graphical interfaces.

As is generally known, for a specific pair of glasses, the blind area and visible area differ from one wearing user to another. For a specific user, the blind area and visible area vary with the type of glasses worn by the user. That is to say, the setting method for the preset display area provided in the foregoing embodiments needs to be customized for different users and different pairs of glasses. In other words, preset display area A set by User A when wearing Glasses A may be unsuitable for User B wearing the same Glasses A. User B may be unable to clearly view some areas within preset display area A, and may need to reset preset display area B when wearing Glasses A. Thus, in some optional embodiments, for the lens currently connected to the display module, identity information of the user who sets the preset display area may be associated with the preset display area set by the user, so that when different users subsequently wear the glasses, the display module performs display based on the preset display area associated with the corresponding user. Therefore, in some optional embodiments, based on the foregoing embodiments, the control method for a display module further includes:
obtaining identity information of the user;
establishing and storing a mapping rule between the identity information and the preset display area.

The user herein refers to the user who sets the preset display area on the lens currently connected to the display module. The user may be the user who touches the touch portion of the display module according to the first touch mode in the foregoing step S102, or the user corresponding to the second virtual contour model in the foregoing step S21.

The user identity information may include a user account/password, voiceprint, fingerprint, iris, and the like.

After the user completes preset display area setting while wearing a pair of glasses, a mapping rule may be established and stored between the user's identity information and the preset display area set by the user. When the user uses the same glasses next time, the preset display area set by the user for the glasses is directly obtained based on the mapping rule.

Exemplarily, for the display module 2, when preset display area A1 is set by User A on the goggles 5, a mapping is established between identity information ID-A of User A and preset display area A1. When preset display area A2 is set by User A on the glasses 1, another mapping is established between identity information ID-A of User A and preset display area A2. For the display module 2, when preset display area B1 is set by User B on the goggles 5, a mapping is established between identity information ID-B of User B and preset display area B1. All such mapping rules are stored.

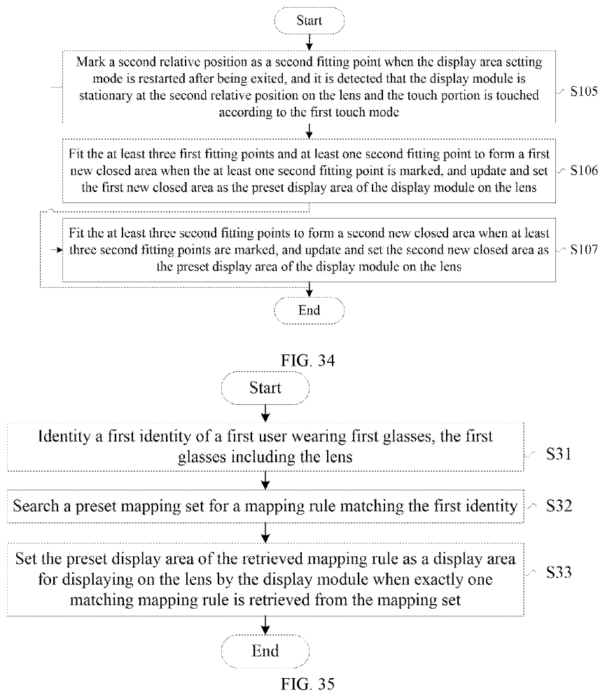

FIG. 34 is a schematic flowchart showing a control method for a display module according to an embodiment of the present disclosure. Referring to FIG. 34, based on the foregoing embodiments, the control method further includes the following steps.

S105: Mark a second relative position as a second fitting point when the display area setting mode is restarted after being exited, and it is detected that the display module is stationary at the second relative position on the lens and the touch portion is touched according to the first touch mode. The second relative position is an arbitrary position on the lens different from the first relative position.

S106: Fit the at least three first fitting points and at least one second fitting point to form a first new closed area when the at least one second fitting point is marked, and update and set the first new closed area as the preset display area of the display module on the lens; or

S107: fit the at least three second fitting points to form a second new closed area when at least three second fitting points are marked, and update and set the second new closed area as the preset display area of the display module on the lens.

After setting a preset display area, the user may feel the set area is unsatisfactory and intend to perform partial update or complete resetting of the original preset display area. Thus, After setting the preset display area, the user may re-enter the display area setting mode to update or reset the preset display area. That is, when re-entering the display area setting mode, the user may perform point alignment positioning again on the lens to obtain new positioning points different from the first fitting points, namely the second fitting points. The second fitting points may be added to the first fitting points to refit the preset display area (i.e., step S106) so as to update the preset display area. Alternatively, at least three second fitting points may be obtained to refit a new preset display area based on the at least three second fitting points (i.e., step S107) so as to reset the preset display area.

FIG. 35 is a schematic flowchart showing a control method for a display module according to an embodiment of the present disclosure. Referring to FIG. 35, based on the foregoing embodiments, the control method further includes the following steps.

S31: Identity a first identity of a first user wearing first glasses, the first glasses including the lens.

S32: Search a preset mapping set for a mapping rule matching the first identity.

S33: Set the preset display area of the retrieved mapping rule as a display area for displaying on the lens by the display module when exactly one matching mapping rule is retrieved from the mapping set; wherein each mapping rule in the mapping set defines a preset mapping relationship between one user identity and one preset display area, and all mapping rules in the mapping set are mutually distinct.

The first user may be any user.

In some optional embodiments, the user's login account/password and fingerprint information can be obtained via a smart terminal communicatively connected to the display module to identify the first user's identity. Optionally, the first user's identity information can be identified by collecting the first user's iris information via a camera on the display module.

The display module can be connected to any pair of glasses, and thus the mapping set is associated with each pair of glasses. For example, a mapping set A may be configured for Glasses A, which records at least one mapping rule corresponding to preset display areas set by various users when wearing Glasses A. A mapping set B may be configured for Glasses B, which records at least one mapping rule corresponding to preset display areas set by various users when wearing Glasses B.

After identifying the first identity of the first user, a search is performed in the mapping set corresponding to the first glasses for a mapping rule matching the first identity. When exactly one matching mapping rule is retrieved from the mapping set of the first glasses, the preset display area specified in the retrieved mapping rule is set as the display area for displaying on the lens by the display module.

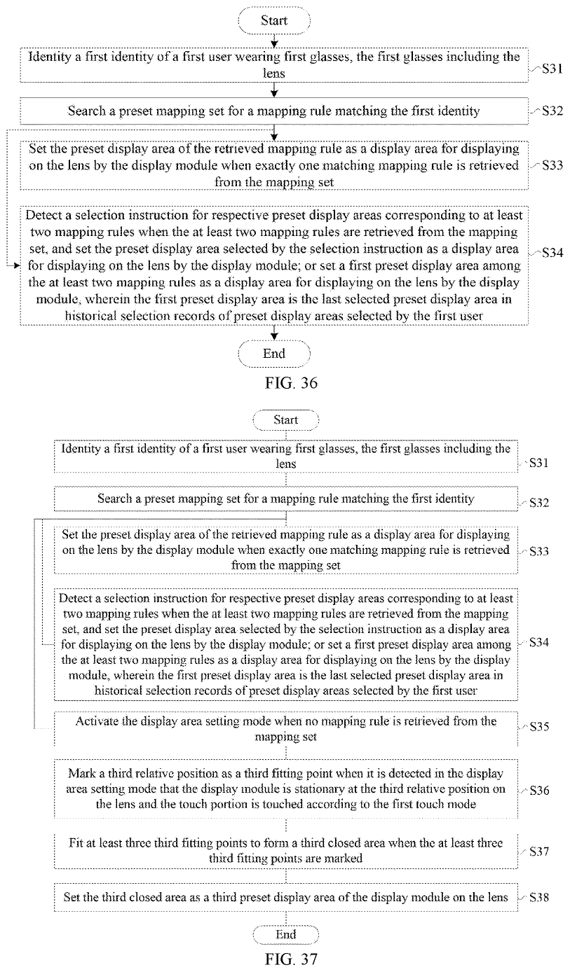

FIG. 36 is a schematic flowchart showing a control method for a display module according to an embodiment of the present disclosure. Referring to FIG. 36, based on the embodiment shown in FIG. 35, the control method for a display module further includes the following steps.

S34: Detect a selection instruction for respective preset display areas corresponding to at least two mapping rules when the at least two mapping rules are retrieved from the mapping set, and set the preset display area selected by the selection instruction as a display area for displaying on the lens by the display module; or set a first preset display area among the at least two mapping rules as a display area for displaying on the lens by the display module, wherein the first preset display area is the last selected preset display area in historical selection records of preset display areas selected by the first user.

When at least two mapping rules are retrieved from the mapping set of the first glasses, it indicates that the first user has set a plurality of preset display areas for the first glasses. These preset display areas may be displayed on a smart terminal communicatively connected to the display module for selection by the first user, and the preset display area selected according to the user's input selection instruction is set as the display area for displaying on the lens by the display module. Alternatively, the last selected preset display area in the historical selection records of preset display areas selected by the first user may be set as the display area for displaying on the lens by the display module.

FIG. 37 is a schematic flowchart showing a control method for a display module according to an embodiment of the present disclosure. Referring to FIG. 37, based on the embodiment shown in FIG. 36, the control method for a display module further includes the following steps.

S35: Activate the display area setting mode when no mapping rule is retrieved from the mapping set.

S36: Mark a third relative position as a third fitting point when it is detected in the display area setting mode that the display module is stationary at the third relative position on the lens and the touch portion is touched according to the first touch mode. The third relative position is an arbitrary position of the display module on the lens.

S37: Fit at least three third fitting points to form a third closed area when the at least three third fitting points are marked.

S38: Set the third closed area as a third preset display area of the display module on the lens.

When no mapping rule is retrieved from the mapping set, it indicates that the first user has not yet set any preset display area for the first glasses. Thus, the display area setting mode is activated to allow the first user to set a preset display area for the display module on the first glasses. For the specific process of the first user finding third fitting points on the lens and fitting the third fitting points to form the third preset display area, reference may be made to the foregoing description of preset display area setup, which will not be repeated herein.

In some optional embodiments, based on the embodiment shown in FIG. 20, the control method for a display module further includes: establishing a third mapping rule between the first identity and the third preset display area, and incorporating the third mapping rule into the mapping set.

A third mapping rule is established between the first identity of the first user and the third preset display area, and is incorporated into the mapping set corresponding to the first glasses, so that the preset display area corresponding to the first user using the first glasses can be quickly determined when the first user uses the first glasses next time.

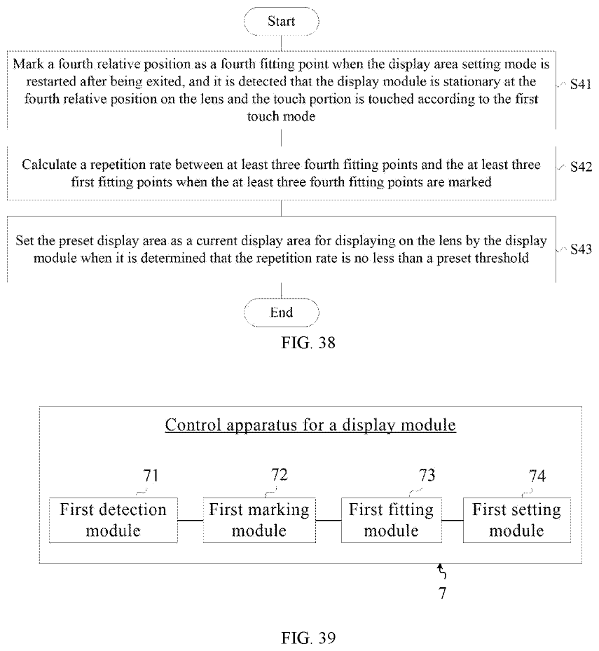

FIG. 38 is a schematic flowchart showing a control method for a display module according to an embodiment of the present disclosure. Referring to FIG. 38, based on the foregoing embodiments, the control method for a display module further includes the following steps.

S41: Mark a fourth relative position as a fourth fitting point when the display area setting mode is restarted after being exited, and it is detected that the display module is stationary at the fourth relative position on the lens and the touch portion is touched according to the first touch mode. The fourth relative position is an arbitrary position of the display module on the lens.

S42: Calculate a repetition rate between at least three fourth fitting points and the at least three first fitting points when the at least three fourth fitting points are marked.

S43: Set the preset display area as a current display area for displaying on the lens by the display module when it is determined that the repetition rate is no less than a preset threshold.

In some optional embodiments, a user may forget that a preset display area has already been set for the currently worn glasses. When the display module detects re-entry into the preset display area setting mode and the repetition rate of relative positions of the detected fourth fitting points and the first fitting points on the lens reaches a preset threshold (e.g., 90%), preset display area setup is aborted, and the preset display area fitted according to the first fitting points is directly configured as the current display area for displaying on the lens by the display module.

In some optional embodiments, based on the embodiment shown in FIG. 37, the control method for a display module further includes: fitting the at least three fourth fitting points to form a fourth closed area and setting the fourth closed area as a current display area for displaying on the lens by the display module when it is determined that the repetition rate is less than the preset threshold.

It should be noted that although the foregoing embodiments are described by taking a monocular scenario (i.e., the display module provided in the embodiments of the present disclosure is connected to only one lens of the glasses) as an example, it is obvious that all embodiments provided herein are also applicable to a binocular scenario (i.e., the display module provided in the embodiments of the present disclosure is connected to both lenses of the glasses).

An execution subject of the control method for the display module provided by the embodiments of the present disclosure may be a control apparatus for the display module. In the embodiments of the present disclosure, the control apparatus for the display module is described by taking the control apparatus executing the control method for the display module as an example.

FIG. 39 is a schematic structural diagram showing a control apparatus for a display module according to an embodiment of the present disclosure. Referring to FIG. 39, a control apparatus 7 for the display module is provided. The display module is configured to be provided on an optical lens and output image content. The control apparatus 7 includes:
a first detection module 71, configured to detect a relative position of the display module on a currently connected lens and detect contact with a touch portion of the display module; and
a first marking module 72, configured to mark a first relative position as a first fitting point when it is detected in a display area setting mode that the display module is stationary at the first relative position on the lens and the touch portion is touched according to a first touch mode; wherein the first relative position is an arbitrary position of the display module on the lens, and in the display area setting mode, the first touch mode is a touch mode for indicating that a user can clearly view a display area of the display module;
a first fitting module 73, configured to fit at least three first fitting points to form a closed area when the at least three first fitting points are marked; and
a first setting module 74, configured to set the closed area as a preset display area of the display module on the lens.

In some optional embodiments, the control apparatus 7 further includes:
a module configured to activate a low-power mode when it is detected that the display module is located outside the preset display area.

In some optional embodiments, the control apparatus 7 further includes:
a first dividing module, configured to divide the preset display area into at least two sub-display areas when receiving a partitioning instruction; and
a first imaging module, configured to control the display module to display a first graphical interface within a first sub-display area when receiving a mapping instruction for displaying the first graphical interface within the first sub-display area; wherein the first sub-display area is any one of the at least two sub-display areas.

In some optional embodiments, the control apparatus 7 further includes:
a second marking module, configured to mark a second relative position as a second fitting point when the display area setting mode is restarted after being exited, and it is detected that the display module is stationary at the second relative position on the lens and the touch portion is touched according to the first touch mode; wherein the second relative position is an arbitrary position on the lens different from the first relative position; and
a second fitting module, configured to fit the at least three first fitting points and at least one second fitting point to form a first new closed area when the at least one second fitting point is marked, and update and set the first new closed area as the preset display area of the display module on the lens; or fit the at least three second fitting points to form a second new closed area when at least three second fitting points are marked, and update and set the second new closed area as the preset display area of the display module on the lens.

In some optional embodiments, the control apparatus 7 further includes:
a first identification module, configured to identify a first identity of a first user wearing first glasses, the first glasses including the lens;
a first searching module, configured to search a preset mapping set for a mapping rule matching the first identity; and
a second setting module, configured to set a preset display area of the retrieved mapping rule as a display area for displaying on the lens by the display module when exactly one matching mapping rule is retrieved from the mapping set; wherein each mapping rule in the mapping set defines a preset mapping relationship between one user identity and one preset display area, and all mapping rules in the mapping set are mutually distinct.

In some optional embodiments, the control apparatus 7 further includes:
a third setting module, configured to detect a selection instruction for respective preset display areas corresponding to at least two mapping rules when the at least two mapping rules are retrieved from the mapping set, and set the preset display area selected by the selection instruction as a display area for displaying on the lens by the display module; or set a first preset display area among the at least two mapping rules as a display area for displaying on the lens by the display module, wherein the first preset display area is the last selected preset display area in historical selection records of preset display areas selected by the first user.

In some optional embodiments, the control apparatus 7 further includes:
a first activation module, configured to activate the display area setting mode when no mapping rule is retrieved from the mapping set;
a third marking module, configured to mark a third relative position as a third fitting point when it is detected in the display area setting mode that the display module is stationary at the third relative position on the lens and the touch portion is touched according to the first touch mode; wherein the third relative position is an arbitrary position of the display module on the lens;
a third fitting module, configured to fit at least three third fitting points to form a third closed area when the at least three third fitting points are marked; and
a fourth setting module, configured to set the third closed area as a third preset display area of the display module on the lens.

In some optional embodiments, the control apparatus 7 further includes:
a first establishing module, configured to establish a third mapping rule between the first identity and the third preset display area, and incorporate the third mapping rule into the mapping set.

In some optional embodiments, the control apparatus 7 further includes:
a fourth marking module, configured to mark a fourth relative position as a fourth fitting point when the display area setting mode is restarted after being exited, and it is detected that the display module is stationary at the fourth relative position on the lens and the touch portion is touched according to the first touch mode; wherein the fourth relative position is an arbitrary position of the display module on the lens;
a fourth fitting module, configured to calculate a repetition rate between at least three fourth fitting points and the at least three first fitting points when the at least three fourth fitting points are marked; and
a fifth setting module, configured to set the preset display area as a current display area for displaying on the lens by the display module when it is determined that the repetition rate is no less than a preset threshold.

In some optional embodiments, the control apparatus 7 further includes:
a sixth setting module, configured to fit the at least three fourth fitting points to form a fourth closed area and set the fourth closed area as a current display area for displaying on the lens by the display module when it is determined that the repetition rate is less than the preset threshold.

In some optional embodiments, the control apparatus 7 further includes:
a first acquiring module, configured to obtain a first virtual contour model of the lens and a second virtual contour model of a user's eye portion; and
a seventh setting module, configured to scan, on the first virtual contour model, a contour area that is the same as or similar to the second virtual contour model, and set the contour area as a preset display area of the display module on the lens.

In some optional embodiments, the control apparatus 7 further includes:
a second acquiring module, configured to obtain identity information of the user; and
a second establishing module, configured to establish and store a mapping rule between the identity information and the preset display area.

The control apparatus 7 for the display module in some embodiments of the present disclosure may be an electronic device or a component of an electronic device, such as an integrated circuit or a chip. The electronic device may be a terminal or other non-terminal device. Exemplarily, the electronic device may be a mobile phone, a tablet computer, a laptop, a handheld computer, a vehicle electronic device, a Mobile Internet Device (MID), an Augmented Reality (AR)/Virtual Reality (VR) device, a robot, a wearable device, an Ultra-Mobile Personal Computer (UMPC), a netbook, a Personal Digital Assistant (PDA), or the like, and may also be a server, Network Attached Storage (NAS), a Personal Computer (PC), a Television (TV), a teller machine, a self-service terminal, or the like. The embodiments of the present disclosure are not limited thereto.

The control apparatus 7 for the display module according to some embodiments of the present disclosure may be a device provided with an operating system. The operating system may be an Android operating system, an iOS operating system, or other feasible operating systems, which is not specifically limited in the embodiments of the present disclosure.

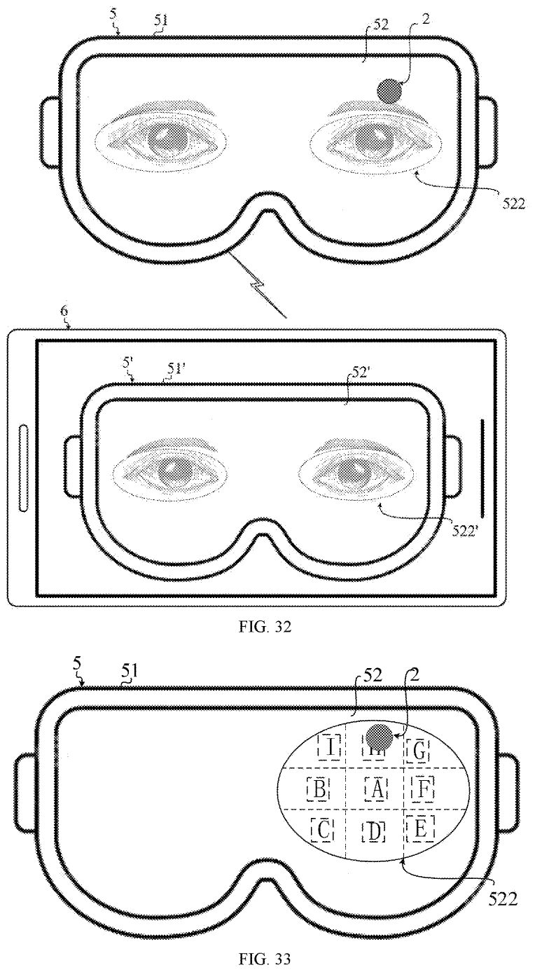

The control apparatus 7 for the display module provided by some embodiments of the present disclosure is capable of implementing all processes of the embodiments shown in FIG. 1 to FIG. 5 and FIG. 22 to FIG. 38, and details are not repeated herein to avoid redundancy.

Embodiments of the present disclosure further provide an electronic device 130. As shown in FIG. 19, the electronic device 130 may include a processor 131 and a memory 132. The memory 132 stores a program or an instruction executable on the processor 131. When the program or the instruction is executed by the processor 131, each step of the foregoing control method embodiments for the display module is implemented, and the same technical effects can be achieved, which will not be repeated herein to avoid redundancy.

Embodiments of the present disclosure further provide an electronic device with a hardware structure as schematically shown in FIG. 20. Descriptions of components with the same functions are omitted herein. The processor 1410 is configured to: detect a relative position of the display module on a currently connected lens and detect contact with a touch portion of the display module; mark a first relative position as a first fitting point when it is detected under a display area setting mode that the display module is stationary at the first relative position on the lens and the touch portion is touched according to a first touch mode, wherein the first relative position is an arbitrary position of the display module on the lens, and the first touch mode in the display area setting mode is a touch mode for confirming that a user can clearly view a display area of the display module; fit the at least three first fitting points to form a closed area when at least three first fitting points are marked; and set the closed area as a preset display area of the display module on the lens.

In some optional embodiments, the embodiments of the present disclosure further provide a near-eye display apparatus 150. The near-eye display apparatus 150 may be configured as shown in FIG. 21, and may include a processor 151 and a memory 152. The memory 152 stores a program or an instruction executable on the processor 152. When the program or instruction is executed by the processor 152, each step of the foregoing control method embodiments of the display module is implemented with the same technical effects achieved, which will not be repeated herein to avoid redundancy.

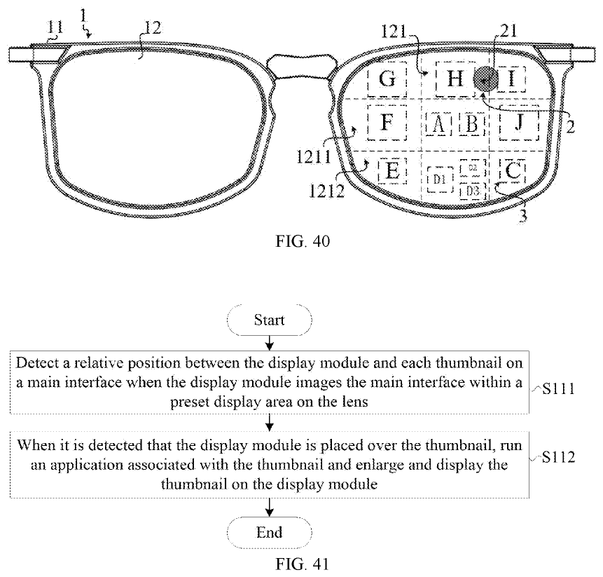

Please further refer to FIG. 40. Two thumbnails [A] and [B] are simultaneously displayed in a central area of the preset display area, and three thumbnails [D1], [D2] and [D3]are simultaneously displayed in an area adjacent to the edge of the frame body 11. Corresponding interaction means need to be provided to allow a user to select a desired thumbnail from these (icon) thumbnails, so as to achieve interaction between the user and the display module. Meanwhile, it is necessary to ensure that the user can quickly and accurately select the intended thumbnail without selection errors or confusion.

In the related art, a display module may simultaneously display (icon) thumbnails of a plurality of applications or files in a certain area on a near-eye display apparatus. How to enable a user to accurately interact with these thumbnails without confusion or errors is a challenge that urgently needs to be addressed. Embodiments of the present disclosure aim to provide a control method and apparatus, an electronic device, a near-eye display apparatus, a medium, a chip, and a computer program product for a display module, so as to independently or semi-independently address, to a certain extent, the challenge that when a display module connected to a near-eye display apparatus simultaneously displays thumbnails of multiple applications or files in a certain area of the near-eye display apparatus, user interaction with these thumbnails easily leads to confusion or errors. The term “independently address” refers to providing a hardware structural solution that can operate independently without software cooperation, so as to achieve the effect that when the display module connected to the near-eye display apparatus simultaneously displays thumbnails of multiple applications or files in a certain area of the near-eye display apparatus, the user can accurately interact with these thumbnails easily causing confusion or errors. The term “semi-independently address” refers to providing a hardware structural solution that, when cooperating with near-eye display software, such as software for the user to interact with virtual information in AR technology, can achieve the effect that when the display module connected to the near-eye display apparatus simultaneously displays thumbnails of multiple applications or files in a certain area of the near-eye display apparatus, the user can accurately interact with these thumbnails without easily causing confusion or errors.

The embodiments of the present disclosure provide a control method and apparatus, an electronic device, a near-eye display apparatus, a medium, a chip, and a computer program product for a display module, which can independently or semi-independently address, to a certain extent, the challenge that user interaction easily leads to confusion or errors when a display module connected to a near-eye display apparatus simultaneously displays thumbnails of multiple applications or files in a certain area of the near-eye display apparatus.

On this basis, the embodiments of the present disclosure are described in detail below.

Embodiments of the present disclosure provide a control method for a display module. The display module is configured to be provided on an optical lens and output image content. Exemplarily, as shown in FIG. 1 to FIG. 48, the display module may be the display module 2 illustrated in these figures, and the display module 2 can output image content on the lens 12. The control method for the display module may be executed by at least one of the glasses 1, the display module 2, the near-eye display apparatus 10, or the smart terminal 4 shown in FIG. 1 to FIG. 48, and is capable of controlling specific content of a graphical user interface (GUI) displayed by the display module 2 on the connected glasses 1 (or near-eye display apparatus 10). FIG. 41 is a schematic flowchart showing a control method for a display module according to an embodiment of the present disclosure. The control method for the display module includes the following steps.

S111: Detect a relative position between the display module and each thumbnail on a main interface when the display module images the main interface within a preset display area on the lens.

S112: When it is detected that the display module is placed over the thumbnail, run an application associated with the thumbnail and enlarge and display the thumbnail on the display module.

The lens refers to the lens on the glasses to which the display module is currently connected. Exemplarily, the lens may be the lens described in the foregoing embodiments, and details are not repeated herein.

In the embodiments of the present disclosure, the display module configured for augmented reality display and imaging on a lens of glasses is allowed to move on the connected lens, instead of being fixed to the lens. In some optional embodiments, an inertial sensor or an acceleration sensor (or a gyroscope) is provided in the display module. Such sensors can obtain instantaneous velocity and acceleration of the display module, so as to determine a motion trajectory of the display module based on the obtained instantaneous velocity and acceleration in combination with parameters such as time

An operating system generally provides a desktop or main interface function for users, and a user may customize icons (thumbnails) for certain files, applications or programs on the desktop or the main interface. For example, in the example shown in FIG. 40, the display module 2 images a main interface provided for the user on the lens 12, and the user may customize icons (thumbnails) corresponding to certain files, applications or programs on the main interface.

Optionally, a fixed reference point on the lens connected to the display module is pre-selected as an origin. The display module starts to move from the origin, and the motion trajectory of the display module is continuously monitored. A position of any point on the motion trajectory relative to the origin can represent the relative position of the display module with respect to the connected lens. The relative position of each thumbnail on the main interface with respect to the lens is already determined when the display module outputs an image, that is, the relative position of each thumbnail on the lens is known.

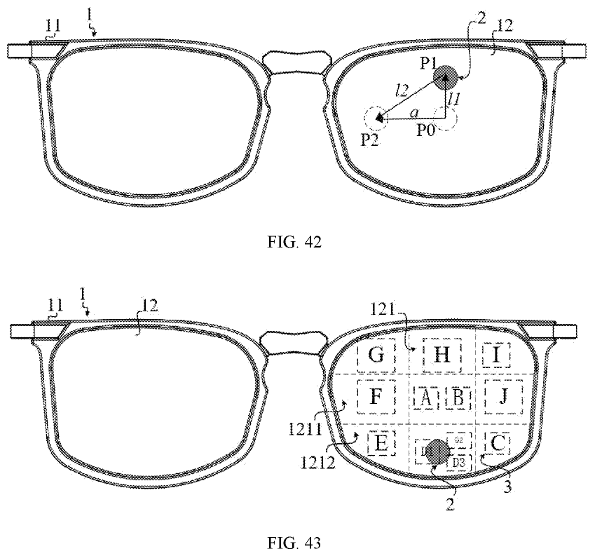

Exemplarily, FIG. 42 is a schematic diagram showing an application scenario showing a display module according to an embodiment of the present disclosure. For example, point P0 on the lens 12 is pre-selected as an origin. The display module 2 moves from the origin to point P1 along path l1, and then moves to point P2 along path l2. The motion trajectory 1 of the display module 2 at any time t during the movement process can be determined based on monitored motion parameters (such as velocity and acceleration) of the display module 2. A positional relationship between an endpoint of the motion trajectory at any time t and the origin P0 can represent the relative position of the display module 2 on the lens 12. For example, the display module 2 moves to point P1 at time t1. The positional relationship of point P1 relative to the origin P0 can be determined based on the determined path l1, that is, the relative position of the display module 2 on the lens 12, which is exemplarily expressed as P1=(P0, (l1)→), indicating that point P1 is located at the endpoint of vector (l1)→, and vector (l1)→starts from P0.

Similarly, when the motion trajectory of the display module 2 moving from P1 to P2 is 12, the positional relationship of P2 relative to P1 can be expressed as P2=(P1, (l2)→), indicating that point P2 is located at the endpoint of vector (l2)→, and vector (l2)→starts from P1. Based on a mathematical vector relationship, (l1)→+(l2)→=a→, so that P2=(P0, a→)=(P0, (l1)→+(l2)→). As is generally known, the foregoing vectors correspond to the displacements of the display module 2 during the movement process.

It should be supplemented that the paths and motion trajectories of the display module 2 in the foregoing embodiments are illustrated by straight line trajectories (paths). As is generally known, the display module 2 can move arbitrarily and is not limited to straight line trajectories, and may also be a curved trajectory.

When the display module 2 images the main interface on the lens 12, the relative position of each thumbnail on the main interface with respect to the lens 12 is known. Based on the known relative positions of the thumbnails on the lens 12 and the monitored relative position of the display module 2 on the lens 12, a relative positional relationship between the display module 2 and each thumbnail on the main interface can be determined.

When it is detected that the display module is placed over one thumbnail, the thumbnail is enlarged and displayed on the display module.

Exemplarily, in FIG. 40, when a user moves the display module 2 to a position over the thumbnail [A], the thumbnail [A] is enlarged and displayed within the display area 21 of the display module 2.

In some embodiments of the present disclosure, when the display module images the main interface on the connected lens, the relative position between the display module and each thumbnail on the main interface is detected. When it is detected that the display module is placed over one thumbnail, the thumbnail is enlarged, so that the user can confirm whether to select the thumbnail. This enables accurate user interaction with the thumbnails to avoid confusion or errors to a certain extent.

In some optional embodiments, the control method for a display module provided by the embodiments of the present disclosure further includes: when it is detected that the display module is placed over at least one thumbnail, enlarging and displaying the thumbnail closest to the display module among the at least one thumbnail on the display module.

Exemplarily, in FIG. 43, the display module 2 is moved to be placed over thumbnails [D1], [D2] and [D3]. When determining the distance between the display module 2 and each thumbnail, the distance between the center point of each thumbnail and the center point of the display area of the display module 2 is taken as the basis. As is generally known, the thumbnail [D1] is closer to the display module 2, and thus the thumbnail [D1] is enlarged and displayed in the display area 21 of the display module 2.

In some optional embodiments, the control method for a display module provided by the embodiments of the present disclosure further includes:
detecting contact with a touch portion of the display module when any thumbnail is enlarged;
controlling the display module to display a graphical interface of an application associated with the enlarged thumbnail within a preset display area on the lens when it is detected that the touch portion is touched according to a first touch mode; wherein the first touch mode is preset as a trigger condition for launching the application associated with the enlarged thumbnail.

The first touch mode may be a single tap, a double tap, a triple tap, or the like.

When a certain thumbnail is enlarged and displayed on the display module and the user touches the touch portion of the display module according to the first touch mode, it is determined that the user intends to launch (or enter) the application associated with the enlarged thumbnail. Thus, when a thumbnail is enlarged and displayed and a touch on the touch portion of the display module is detected according to a first touch mode, the application associated with the thumbnail runs in the foreground, and the display module is controlled to display the graphical interface of the application associated with the enlarged thumbnail in the preset display area on the lens. When the application associated with the thumbnail is already running in the background, the application is switched to foreground running. This assists the user in selecting a thumbnail on the main interface, accessing the corresponding associated application and using related functions.

Exemplarily, in the foregoing example where the thumbnail [A] is enlarged and displayed, when a touch on the touch portion of the display module 2 is detected according to the first touch mode while the thumbnail [A] is enlarged, the application associated with the thumbnail [A] runs in the foreground, and the display module 2 is controlled to display the graphical interface of the application associated with the enlarged thumbnail [A] in the preset display area 121 on the lens 12. Exemplarily, in the foregoing example where the thumbnail [D1] is enlarged and displayed, the application associated with the thumbnail [D1] runs in the foreground, and the display module 2 is controlled to display the graphical interface of the application associated with the enlarged thumbnail [D1] in the preset display area 121 on the lens 12.

In the embodiments of the present disclosure, when the display module displays a main interface on the connected lens, the relative position between the display module and each thumbnail on the main interface is detected. When it is detected that the display module is placed over one thumbnail, the thumbnail is enlarged to allow the user to confirm whether to select the thumbnail. When the user further touches the touch portion of the display module according to the first touch mode, it is determined that the user intends to launch (or enter) the application associated with the enlarged thumbnail, enter the application, and image its graphical interface. The present solution assists the user in selecting thumbnails on the main interface to access associated applications and use corresponding functions, thereby enabling the user to accurately interact with the thumbnails to avoid confusion and operation errors to a certain extent.

In some optional embodiments, the control method for the display module provided by the embodiments of the present disclosure further includes:
when the display module images a main interface within a preset display area on the lens, monitoring a motion state of the display module, detecting contact with a touch portion of the display module, and obtaining multimedia data; and
controlling the display module to switch a current page of the main interface displayed within the preset display area on the lens to a previous page or a next page of the main interface when it is monitored that the display module rotates about an axis, or it is detected that the touch portion is touched according to a second touch mode, or a page-scrolling instruction is recognized from the multimedia data; wherein the display module rotating about an axis, the second touch mode, and the page-scrolling instruction are preset as trigger conditions for triggering a page-scrolling function.

When the display module images the main interface within the preset display area on the lens, the motion state of the display module is monitored, contact with the touch portion of the display module is detected, and multimedia data is obtained. Reference may be made to the foregoing description for monitoring the motion state of the display module and detecting contact with the touch portion, which will not be repeated herein. The display module may obtain multimedia data via its own camera, microphone and other components, or obtain multimedia data from a network, or from a smart terminal or a near-eye display apparatus communicatively connected thereto.

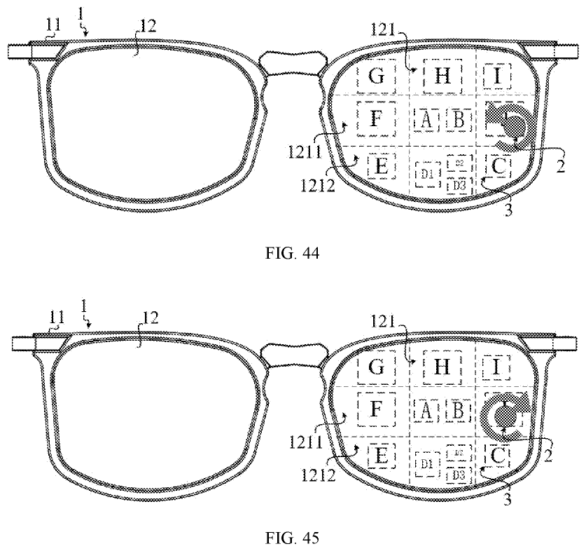

Exemplarily, FIG. 44 and FIG. 45 are schematic diagrams showing an application scenario of a display module according to an embodiment of the present disclosure. Counterclockwise axial rotation of the display module 2 as shown in FIG. 47 may be preset as a trigger condition for scrolling the main interface up (or down), and clockwise axial rotation of the display module 2 as shown in FIG. 45 may be preset as a trigger condition for scrolling the main interface down (or up). When counterclockwise (or clockwise) axial rotation of the display module 2 is monitored, the display module 2 is controlled to update the main interface currently displayed on the lens 12, that is, the display module 2 is controlled to display a previous page (or next page) of the main interface on the lens 12.

Exemplarily, the second touch mode may include two distinct touch modes, such as a single tap and a double tap, or a double tap and a triple tap. One of the two touch modes is set as a trigger condition for scrolling to the previous page, and the other is set as a trigger condition for scrolling to the next page. For example, when a single tap is detected, the main interface scrolls up, so that the display module 2 is controlled to display the previous page of the main interface on the lens 12. When a triple tap is detected, the main interface scrolls down, so that the display module 2 is controlled to display the next page of the main interface on the lens 12.

It should be supplemented that the first touch mode and the second touch mode shall be two completely different touch modes, so as to ensure orderly execution of application launching and main interface page-scrolling functions without operational conflicts.

Exemplarily, the multimedia data may be voice data or gesture data. When a page-scrolling voice instruction or a target gesture is recognized from the multimedia data, the main interface performs page scrolling, that is, the display module 2 is controlled to display the previous page (or the next page) of the main interface on the lens 12.

In some optional embodiments, detection of axial rotation of the display module while placed over a thumbnail is preset as a trigger condition for a main interface scaling function. Clockwise (or counterclockwise) axial rotation of the display module is preset as a trigger condition for enlarging the thumbnail beneath the display module; and counterclockwise (or clockwise) axial rotation of the display module is preset as a trigger condition for scaling the main interface.

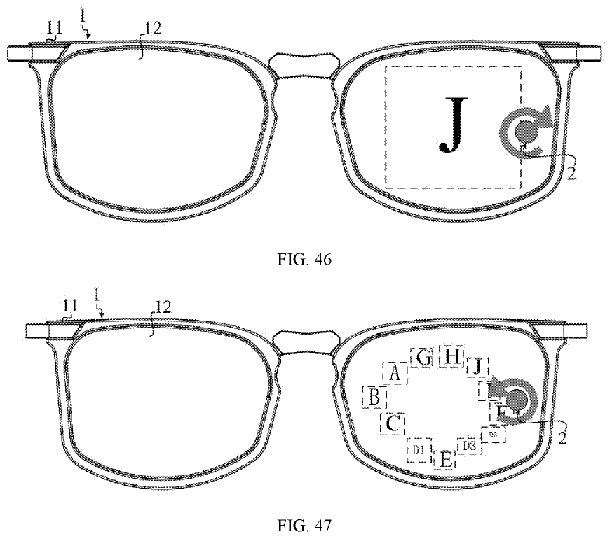

Exemplarily, in the scenario shown in FIG. 45, clockwise axial rotation of the display module 2 enlarges the thumbnail [J] as shown in FIG. 46; and counterclockwise axial rotation of the display module 2 in the scenario shown in FIG. 45 scales the current page of the main interface as shown in FIG. 46.

In some optional embodiments, the control method for the display module provided by the embodiments of the present disclosure further includes:
when the display module images a graphical interface of an application within a preset display area on the lens, monitoring a motion state of the display module, detecting contact with a touch portion of the display module, and obtaining multimedia data;
controlling the display module to update a first target area of the graphical interface of the application displayed within the preset display area on the lens when it is monitored that the motion state corresponds to the display module rotating about an axis, or it is detected that the touch portion is touched according to a target touch mode, or a target instruction is recognized from the multimedia data. The first target area is a graphical area corresponding to a sub-function of the application. The display module rotating about an axis, the target touch mode, and the target instruction are preset as trigger conditions for triggering the sub-function of the application.

Exemplarily, when the currently displayed graphical interface corresponds to a music player function, counterclockwise axial rotation of the display module 2 may be preset as a trigger condition for switching to the previous (or next) song, and clockwise axial rotation of the display module 2 may be preset as a trigger condition for switching to the next (or previous) song. When counterclockwise (or clockwise) axial rotation of the display module 2 is monitored, a song switching operation is performed on the currently playing song, and the display module 2 is controlled to update the music player interface currently displayed on the lens 12, that is, the display module 2 is controlled to update song information in the music player interface displayed on the lens 12 to information of the previous (or next) song.

The multimedia data may be image or video data acquired by a built-in miniature camera of the display module, or voice data acquired by a built-in miniature microphone of the display module. eye tracking data refers to eye image data of a user acquired by a built-in miniature camera of the display module.

The target touch mode may be a single tap, a double tap, a triple tap, or the like. The target instruction may be a preset target gesture, a target voice command, or the like. The target eye movement mode may be eyeball movement following a preset rule. Similarly, the target touch mode, the target instruction and the aforementioned display module rotating about an axis may also be preset as trigger conditions for sub-functions of an application. When it is detected that the touch portion of the display module is touched according to the target touch mode, or a target instruction is identified from multimedia data, a sub-function of the application for which the target touch mode, the target instruction and/or the display module rotating about an axis serve as the (preset) trigger condition is triggered, so as to control the display module to update an area within the graphical interface currently displayed on the lens. The principle thereof is similar to that of triggering a sub-function of an application through axial rotation of the display module, thereby controlling the display module to update an area within the graphical interface currently displayed on the lens, which will not be repeated herein. Those skilled in the art may understand the principle with reference to the foregoing description.

In some optional embodiments, the control method for the display module further includes:
controlling the display module to update the graphical interface displayed within the preset display area on the lens when it is monitored that a rotation angle of the display module rotating about an axis is no less than a preset first threshold angle β.

The first threshold angle β may be flexibly set by those skilled in the art or a user according to actual requirements. For example, the first threshold angle β may be 15°, 20°, 25°, 30°, or the like.

This avoids updating the graphical interface displayed on the lens when the display module 2 is slightly driven to rotate about an axis. Thus, false triggering of the sub-function of the third logical function can be reduced to a certain extent.

It should be noted that although the foregoing embodiments are described by taking a monocular scenario (i.e., the display module provided in the embodiments of the present disclosure is connected to only one lens of the glasses) as an example, it is obvious that all embodiments provided herein are also applicable to a binocular scenario (i.e., the display module provided in the embodiments of the present disclosure is connected to both lenses of the glasses).

An execution subject of the control method for the display module provided in the embodiments of the present disclosure may be a control apparatus for the display module. In the embodiments of the present disclosure, the control apparatus for the display module is described by taking the control apparatus executing the control method for the display module as an example.

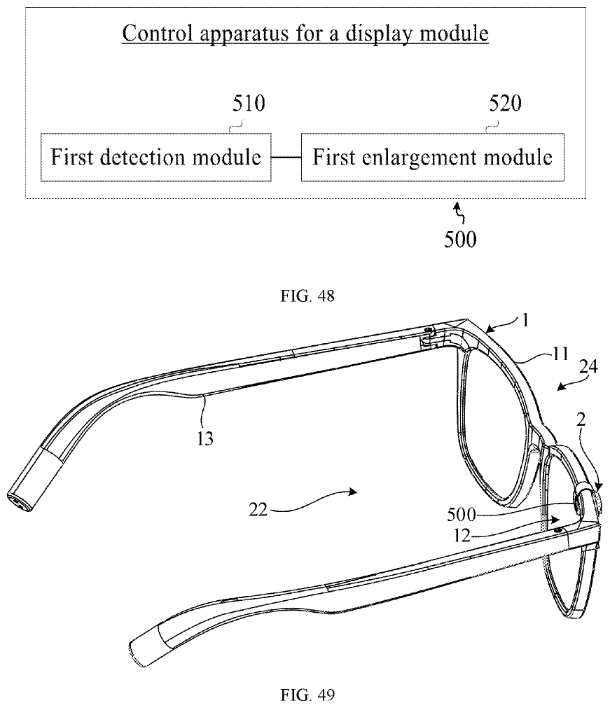

FIG. 48 is a schematic structural diagram showing a control apparatus for a display module according to an embodiment of the present disclosure. Referring to FIG. 48, a control apparatus 500 for the display module is provided. The display module is configured to be provided on an optical lens and output image content. The control apparatus 500 includes:
a first detection module 510, configured to detect a relative position between the display module and each thumbnail on a main interface when the display module images the main interface within a preset display area on the lens;
a first enlargement module 520, configured to enlarge and display the thumbnail on the display module when it is detected that the display module is placed over one thumbnail.

In some optional embodiments, the apparatus 500 further includes:
a second enlargement module, configured to, when it is detected that the display module is positioned over at least one thumbnail, enlarge and display the thumbnail closest to the display module among the at least one thumbnail on the display module.

In some optional embodiments, the apparatus 500 further includes:
a second detection module, configured to detect contact with a touch portion of the display module when any thumbnail is enlarged; and
a first control module, configured to control the display module to display a graphical interface of an application associated with the enlarged thumbnail within a preset display area on the lens when it is detected that the touch portion is touched according to a first touch mode; wherein the first touch mode is preset as a trigger condition for launching the application associated with the enlarged thumbnail.

In some optional embodiments, the apparatus 500 further includes:
a first monitoring module, configured to monitor a motion state of the display module when the display module images a main interface within a preset display area on the lens; and
a second control module, configured to control the display module to switch a current page of the main interface displayed within the preset display area on the lens to a previous page or a next page of the main interface when it is monitored that the display module rotates about an axis; wherein the display module rotating about an axis is preset as a trigger condition for triggering a page-scrolling function.

In some optional embodiments, the apparatus 500 further includes:
a third detection module, configured to detect contact with a touch portion of the display module when the display module images a main interface within a preset display area on the lens; and
a third control module, configured to control the display module to switch a current page of the main interface displayed within the preset display area on the lens to a previous page or a next page of the main interface when it is detected that the touch portion is touched according to a second touch mode; wherein the second touch mode is preset as a trigger condition for triggering a page-scrolling function.

In some optional embodiments, the apparatus 500 further includes:
a first acquisition module, configured to obtain multimedia data when the display module images a main interface within a preset display area on the lens; and
a fourth control module, configured to control the display module to switch a current page of the main interface displayed within the preset display area on the lens to a previous page or a next page of the main interface when a page-scrolling instruction is recognized from the multimedia data; wherein the page-scrolling instruction is preset as a trigger condition for triggering a page-scrolling function.

In some optional embodiments, the apparatus 500 further includes:
a second monitoring module, configured to monitor a motion state of the display module when the display module images a graphical interface of an application within a preset display area on the lens; and
a fifth control module, configured to control the display module to update a first target area of the graphical interface of the application displayed within the preset display area on the lens when it is monitored that the motion state corresponds to the display module rotating about an axis; wherein the first target area is a graphical area corresponding to a sub-function of the application, and the display module rotating about an axis is preset as a trigger condition for triggering the sub-function of the application.

In some optional embodiments, the apparatus 500 further includes:
a fourth detection module, configured to detect contact with a touch portion of the display module when the display module images a graphical interface of an application within a preset display area on the lens; and
a sixth control module, configured to control the display module to update a first target area of the graphical interface of the application displayed within the preset display area on the lens when it is detected that the touch portion is touched according to a target touch mode; wherein the first target area is a graphical area corresponding to a sub-function of the application, and the target touch mode is preset as a trigger condition for triggering the sub-function of the application.

In some optional embodiments, the apparatus 500 further includes:
a second acquisition module, configured to obtain multimedia data when the display module displays a graphical interface of an application within a preset display area on the lens; and
a seventh control module, configured to control the display module to update a first target area of the graphical interface of the application displayed within the preset display area on the lens when a target instruction is recognized from the multimedia data; wherein the first target area is a graphical area corresponding to a sub-function of the application, and the target instruction is preset as a trigger condition for triggering the sub-function of the application.

The control apparatus 5 of the display module in some embodiments of the present disclosure may be an electronic device or a component of an electronic device, such as an integrated circuit or a chip. The electronic device may be a terminal or other non-terminal device. Exemplarily, the electronic device may be a mobile phone, a tablet computer, a laptop, a handheld computer, a vehicle electronic device, a Mobile Internet Device (MID), an Augmented Reality (AR)/Virtual Reality (VR) device, a robot, a wearable device, an Ultra-Mobile Personal Computer (UMPC), a netbook, a Personal Digital Assistant (PDA), or the like, and may also be a server, Network Attached Storage (NAS), a Personal Computer (PC), a Television (TV), a teller machine, a self-service terminal, or the like, which is not specifically limited in the embodiments of the present disclosure.

The control apparatus 5 of the display module according to some embodiments of the present disclosure may be a device provided with an operating system. The operating system may be an Android operating system, an iOS operating system, or other feasible operating systems, which is not specifically limited in the embodiments of the present disclosure.

The control apparatus 500 for the display module provided by the embodiments of the present disclosure is capable of implementing all processes of the embodiments shown in FIG. 1 to FIG. 46, and details are not repeated herein to avoid redundancy.

In some optional embodiments, as shown in FIG. 19, the embodiments of the present disclosure further provide an electronic device 130, including a processor 131 and a memory 132. The memory 132 stores a program or an instruction executable by the processor 131. When the program or instruction is executed by the processor 131, each step of the foregoing control method embodiments for the display module is implemented, and the same technical effects can be achieved, which will not be repeated herein to avoid redundancy.

It should be noted that the electronic devices in the embodiments of the present disclosure include the foregoing mobile electronic devices and non-mobile electronic devices.

FIG. 20 is a schematic diagram showing a hardware structure of an electronic device according to an embodiment of the present disclosure.

The electronic device 140 includes, but is not limited to, a radio frequency unit 141, a network module 142, an audio output unit 143, an input unit 144, a sensor 145, a display unit 146, a user input unit 147, an interface unit 148, a memory 149, a processor 1410, or the like. Those skilled in the art will understand that the electronic device 140 may further include a power supply (such as a battery) for supplying power to each component. The power supply may be logically connected to the processor 1410 via a power management system, thereby enabling functions of managing charging, discharging, and power consumption via the power management system. The structure of the electronic device shown in FIG. 20 does not constitute a limitation on the electronic device, and the electronic device may include more or fewer components than those illustrated, or combine certain components, or adopt different component arrangements, which will not be elaborated herein.

The processor 1410 is configured to:
detect a relative position between the display module and each thumbnail on a main interface when the display module displays the main interface within a preset display area on the lens; and
when it is detected that the display module is positioned over one thumbnail, run an application associated with the thumbnail, and control the display module to display a graphical interface of the application within the preset display area on the lens.

It should be understood that in some embodiments of the present disclosure, the input unit 144 may include a Graphics Processing Unit (GPU) 1441 and a microphone 1442. The Graphics Processing Unit 1441 is configured to process image data of static pictures or videos obtained by an image capturing apparatus (such as a camera) in a video capture mode or an image capture mode. The display unit 146 may include a display panel 1461. The display panel 1461 may be configured in the form of a liquid crystal display, an organic light-emitting diode, or the like. The user input unit 147 includes at least one of a touch panel 1471 and other input devices 1472. The touch panel 1471 is also referred to as a touch screen. The touch panel 1471 may include two parts: a touch detection device and a touch controller. The other input devices 1472 may include, but are not limited to, a physical keyboard, function keys (such as volume control buttons, switch buttons, etc.), a trackball, a mouse, and a joystick, etc., which will not be enumerated herein.

The memory 149 may be configured to store software programs and various data. The memory 149 may mainly include a first storage area for storing a program or an instruction and a second storage area for storing data. The first storage area may store an operating system, application programs or instructions required for at least one function (such as an audio playback function, an image playback function, etc.). In addition, the memory 149 may include volatile memory, non-volatile memory, or both volatile and non-volatile memory. The non-volatile memory may include, but is not limited to, read-only memory (ROM), programmable read-only memory (PROM), erasable programmable read-only memory (EPROM), electrically erasable programmable read-only memory (EEPROM), or flash memory. The volatile memory may include, but is not limited to, random access memory (RAM), static random access memory (SRAM), dynamic random access memory (DRAM), synchronous dynamic random access memory (SDRAM), double data rate synchronous dynamic random access memory (DDR SDRAM), enhanced synchronous dynamic random access memory (ESDRAM), synch link dynamic random access memory (SLDRAM), and direct rambus random access memory (DRRAM). The memory 149 in the embodiments of the present disclosure includes, but is not limited to, the above and any other suitable types of memories.

The processor 1410 may include one or more processing units. Optionally, the processor 1410 integrates an application processor and a modem processor. The application processor mainly processes operations related to an operating system, a user interface, application programs, or the like. The modem processor mainly processes wireless communication signals such as a baseband signal. It can be understood that the foregoing modem processor may also be not integrated into the processor 1410.

An execution subject of the control method for the display module provided by the embodiments of the present disclosure may be a near-eye display apparatus. In the embodiments of the present disclosure, the near-eye display apparatus is described by taking the near-eye display apparatus executing the control method for the display module as an example.

In some optional embodiments, as shown in FIG. 21, the embodiments of the present disclosure further provide a near-eye display apparatus 150, which includes a processor 151 and a memory 152. The memory 152 stores a program or an instruction executable by the processor 151. When the program or the instruction is executed by the processor 151, each step of the foregoing control method for the display module is implemented with the same technical effects achieved, which will not be repeated herein to avoid redundancy.

Any of the foregoing product embodiments can implement each process of the foregoing control method embodiments of the display module through operation of its own processor, and can achieve the same technical effects, which will not be elaborated one by one herein to avoid redundancy.

Any of the foregoing product embodiments can implement each process of the foregoing control method embodiments of the display module through operation of its own processor, and can achieve the same technical effects, which will not be elaborated one by one herein to avoid redundancy.

Embodiments of the present disclosure further provide a readable storage medium. The readable storage medium stores a programs or an instruction which, when executed by a processor, causes the processor to perform each process of the foregoing control method embodiments for the display module and achieve the same technical effects, which will not be repeated herein to avoid redundancy. The processor is the processor in the electronic device or electronic system described in the foregoing embodiments. The readable storage medium includes a computer-readable storage medium, such as a read-only memory (ROM), a random access memory (RAM), a magnetic disk, an optical disc, or the like.

Embodiments of the present disclosure further provide a chip. The chip includes a processor and a communication interface. The communication interface is coupled to the processor. The processor is configured to run a program or an instruction to implement each process of the foregoing control method embodiments for the display module and achieve the same technical effects, which will not be repeated herein to avoid redundancy.

It should be understood that the chip mentioned in the embodiments of the present disclosure may also be referred to as a system-level chip (SLC), system chip, chip system, system-on-chip (SoC), or the like.

The embodiments of the present disclosure provide a computer program product. The program product is stored in a storage medium and executed by at least one processor to cause the processor to perform each process of the foregoing control method embodiments for the display module and achieve the same technical effects, which will not be repeated herein to avoid redundancy.

It should be understood that the disclosed system(s), apparatus and method(s) in the embodiments of the present disclosure may be implemented in other manners. For example, the described apparatus embodiments are merely illustrative. For example, the division of modules or units is only a logical function division, and there may be other division methods in actual implementation. For example, a plurality of units or components may be combined or integrated into another system, or some features may be omitted or not executed. In addition, the illustrated or discussed mutual coupling, direct coupling or communication connection may be indirect coupling or communication connection via certain interfaces, apparatus or unit, and may be in electrical, mechanical or other forms.

In addition, each functional unit in the respective embodiments of the present disclosure may be integrated into one processing unit, or each unit may exist physically separately, or two or more units may be integrated into one unit. The integrated units may be implemented in the form of hardware or software functional units.

When the integrated units are implemented in the form of software functional units and sold or used as independent products, they may be stored in a computer-readable storage medium. Based on such understanding, the technical solutions of some embodiments of the present disclosure, or the part contributing to the related art, or all or part of the technical solutions may be embodied in the form of a software product. The computer software product is stored in a storage medium and includes several instructions for causing a computer device (which may be a personal computer, a server, a network device, etc.) or a processor to execute all or part of the steps of the methods described in the respective embodiments of the present disclosure. The foregoing storage medium includes a USB flash drive, a mobile hard disk, a read-only memory (ROM), a random access memory (RAM), a magnetic disk, an optical disc, and other media that can store program code.

A near-eye display apparatus, also referred to as a head-mounted display or wearable display, is applied to optical lenses. In some technical scenarios, Augmented Reality (AR), Virtual Reality (VR), Mixed Reality (MR), and Extended Reality (XR) can all be referred to as near-eye display. The optical lenses in some embodiments of the present disclosure may be goggles, smart glasses, myopia glasses, hyperopia glasses, sports glasses, or other near-eye or head-mounted optical lenses, etc. The optical lenses of a user can face the human eye. The near-eye display apparatus is provided with an optical engine. The optical engine may include a microdisplay, such as Micro Light-Emitting Semiconductor, Micro Light-Emitting Diode (Micro-LED/uLED), Micro Organic Light-Emitting Diode (Micro-OLED), Liquid Crystal On Silicon (LCoS), Liquid Crystal Display (LCD), Digital Micromirror Device (DMD)/Digital Light Processing (DLP), Laser Beam Scanning (LBS), or any combination of these technologies. It can be understood that the optical engine may further include a micro-optical module disposed in front of the microdisplay, and light emitted by the display passes through the micro-optical module and then exits. The description of the microdisplay in other embodiments of the present disclosure may refer to the relevant description herein.

The near-eye display apparatus may further include a circuit board, a battery for supplying power to the optical engine and the circuit board, and at least one electrical element for enabling electrical connection between each component and the battery. Taking AR glasses as an example, in general, electrical components such as the circuit board and the battery are mounted on a temple of the AR glasses, and the optical engine is mounted on an optical lens. A channel for wiring is provided outside the optical engine to facilitate power supply to the optical engine. In some scenarios, the temple of the AR glasses need to rotate relative to the frame, which affects the connection between the optical engine and electrical elements such as the battery. This can easily lead to relative misalignment and short circuits in the wiring. With the relative movement of the temple, wiring portions of the optical engine and electrical components such as the battery are also prone to water ingress, affecting the use of the AR glasses. In general, a near-eye display apparatus is usually a head-mounted or other wearable display provided in front of human vision, with a relatively complex structure, which increases the difficulty of product fixation and affects the production efficiency of the product.

To address the above challenge, embodiments of the present disclosure proposes a near-eye display module for an optical lens. The near-eye display module can be directly mounted on a frame or an optical lens. The near-eye display module includes a first connecting portion for connecting the optical lens and a mounting base for mounting an optical engine. The first connecting portion is provided with a first electrical compartment for accommodating an electrical component. The mounting base is provided with a mounting groove for mounting the optical engine and is located on one side of the first connecting portion along a first direction, The first direction is arranged at an angle to an axial direction of the mounting groove. In some embodiments of the present disclosure, the first electrical compartment is provided in the first connecting portion, which facilitates the installation of electrical components such as a battery on the first connecting portion, and reduces the need for a separate wiring structure outside the optical lens to connect the battery and the optical engine, thereby reducing problems such as water ingress at electrical connecting portions caused by relative movement of the temple relative to the frame. Since the axial direction of the mounting groove is arranged at an angle to the first direction, the mounting base and the first electrical compartment are arranged along the first direction, which helps reduce the thickness of the near-eye display apparatus. After being mounted on the optical lens, the module can reduce visual compression on the human eye and improve wearing comfort of the product.

Please refer to FIG. 49. For ease of description, the following description takes the near-eye display module 2 in embodiments of the present disclosure applied to eyeglasses as an example. The eyeglasses may include a frame body 11, an optical lens 12 and a temple 13. The optical lenses 12 may be mounted on the frame body 11, and the temple is connected to the frame body 11. The near-eye display module 2 may be mounted on the frame body 11 and/or the optical lens 12, which can reduce the need for an excessively large power supply module such as a battery on the temple, or reduce the need for a wiring portion between the temple and the optical lens 12 for connecting a power supply module such as a battery to the near-eye display module 2. This can reduce problems such as water ingress, open circuits and short circuits at wiring portions caused by relative movement between the temple and the lens. A display assembly 1 can be combined with existing ordinary eyeglasses such as myopia glasses, hyperopia glasses, protective glasses and sports glasses to achieve an augmented display function, enabling ordinary eyeglasses to have the augmented reality function of smart glasses.

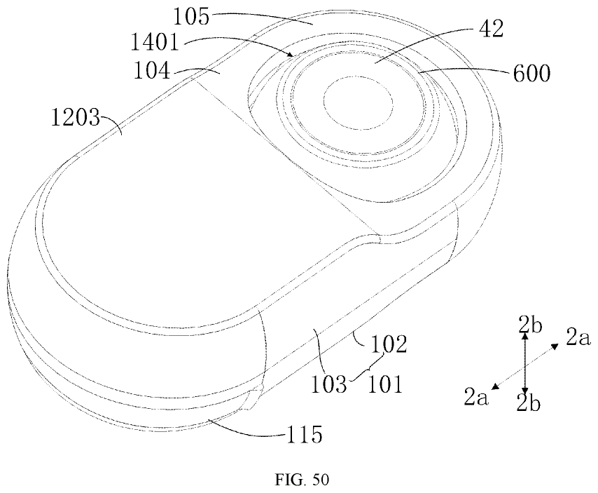

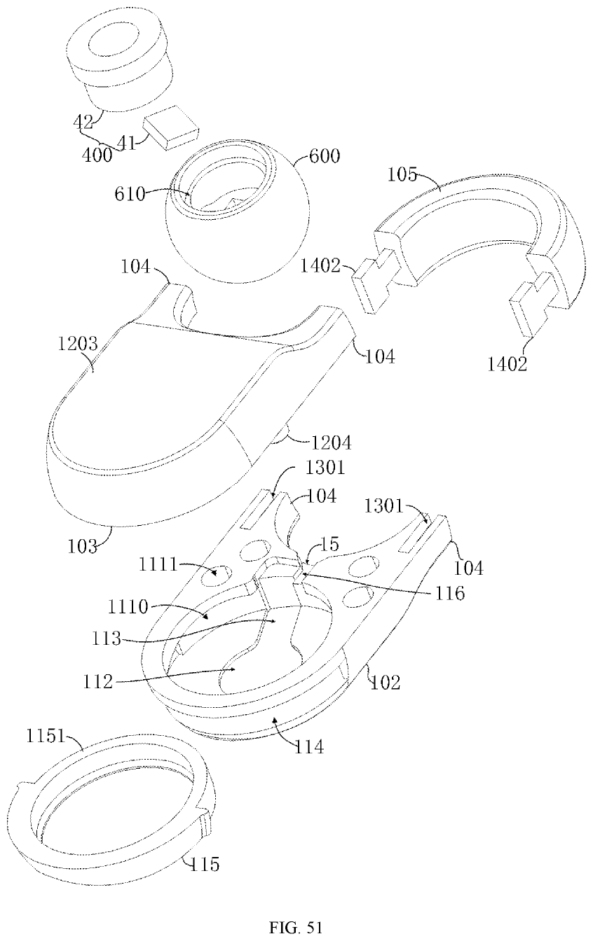

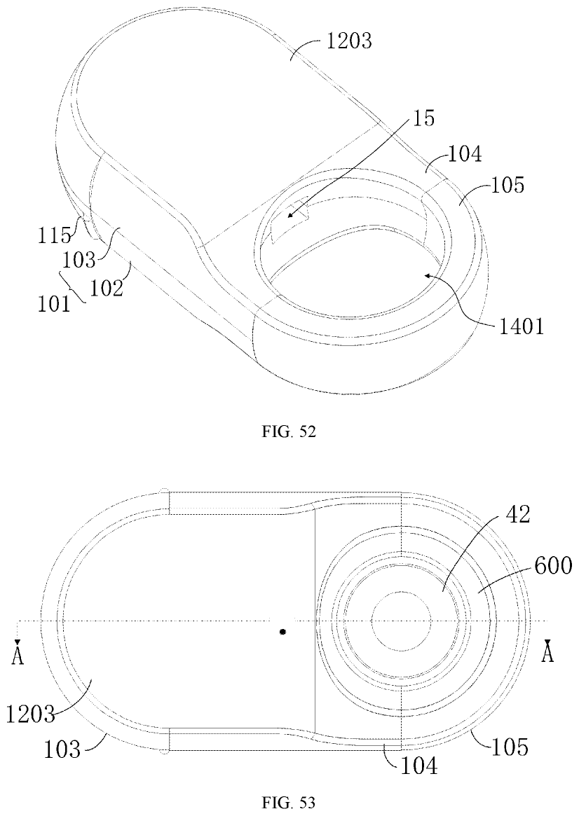

Please refer to FIG. 50, FIG. 51 and FIG. 52. The present disclosure discloses an embodiment of a near-eye display module 2, which will be described in detail respectively below.

The near-eye display module 2 includes a first connecting portion 101 and a mounting base 105. The first connecting portion 101 is configured to be connected to an optical lens 12 and/or a frame, and is provided with a first electrical compartment 1110 for accommodating electrical components. The mounting base 105 is connected to one side of the first connecting portion 101 along a first direction 2a. The mounting base 105 is provided with a mounting groove 1401 for mounting an optical engine 400. The first direction 2a is arranged at an angle to an axial direction of the mounting groove 1401.

Referring to FIG. 51 and FIG. 52, the first connecting portion 101 may serve as a structural body of the near-eye display module 2 and is configured to be connected to the optical lens 12. In this embodiment, the first connecting portion 101 is provided with a fixing surface 1203. The fixing surface 1203 may be made of plastic or other suitable materials. The fixing surface 1203 is configured to be connected to the optical lens 12 or the frame. In some embodiments, the first connecting portion 101 may be directly connected to the optical lens 12, or connected to the optical lens 12 via an intermediate connecting member such as a magnetic attraction member and a hanging buckle. The first connecting portion 101 may be fixedly connected to the optical lens 12. For example, the first connecting portion 101 may be bonded to the optical lens 12, so that the first connecting portion 101 maintains a relatively fixed position on the optical lens 12. In some embodiments, the first connecting portion 101 may be movably mounted on the optical lens 12. For example, the first connecting portion 101 can be slidably or rotatably connected to the optical lens 12. In some embodiments, the first connecting portion 101 may be detachably mounted on the optical lens 12. For example, the first connecting portion 101 may be snap-fitted or attached to the optical lens 12. The fixing surface 1203 may further be provided with a buffer layer to reduce wear on the optical lens 12.

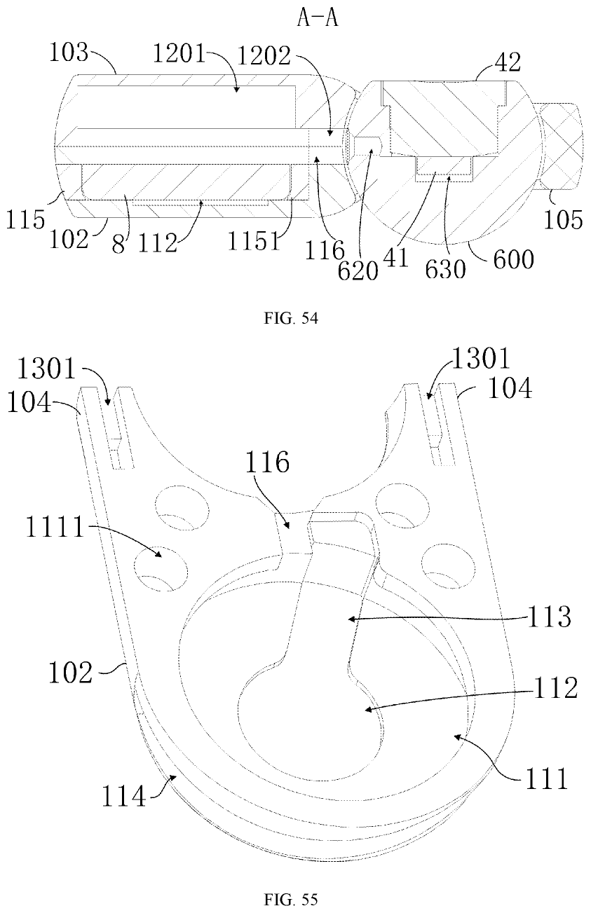

Referring to FIG. 51, FIG. 53 and FIG. 54, at least a partial region of the first connecting portion 101 is of a hollow structure. The first electrical compartment 1110 is a hollow cavity provided in the first connecting portion 101 for accommodating an electrical component. The electrical component in the embodiments of the present disclosure include, but is not limited to, a battery 8, a circuit board, and the like. For ease of description, the following description takes the arrangement of the battery 8 provided in the first electrical compartment 1110 as an example.

The mounting base 105 is configured to mount the optical engine 400 and is provided with a mounting groove 1401. The mounting groove 1401 may be a through groove penetrating the mounting base 105 or a recessed groove formed thereon.

The mounting groove 1401 has an axial direction, and the optical engine 400 has a light exit surface and an optical axis perpendicular to the light exit surface. In some embodiments, the light exit surface of the optical engine 400 is located on one side along an axial direction of the mounting groove 1401. The light exit surface of the optical engine 400 may be perpendicular to the axial direction of the mounting groove 1401, and the optical axis of the optical engine 400 may be parallel to the axial direction of the mounting groove 1401. Alternatively, the light exit surface of the optical engine 400 is not perpendicular to the axial direction of the mounting groove 1401, and the optical axis of the optical engine 400 is arranged at an angle to the first direction. The optical axis of the optical engine 400 is neither parallel nor coincident with the first direction. As shown in FIG. 50, direction 2b may be the axial direction of the mounting groove 1401, and the optical axis of the optical engine 400 may be arranged along the direction 2b. The mounting base 105 may be separate from the first connecting portion 101 and connected to the first connecting portion 101. Alternatively, The mounting base 105 and the first connecting portion 101 may be integrally formed.

The mounting base 105 is connected to one side of the first connecting portion 101 along the first direction 2a, so that the mounting base 105 and the first connecting portion 101 are arranged along the first direction 2a. The arrangement that the first direction 2a is arranged at an angle to the axial direction of the mounting groove 1401 means that the first direction 2a is neither parallel nor coincident with the axial direction of the mounting groove 1401. As shown in FIG. 50 and FIG. 54, the axial direction of the mounting groove 1401 may be perpendicular to the first direction 2a. In the embodiment, since the first connecting portion 101 is provided with a first electrical compartment 1110 and the mounting base 105 is provided with the mounting groove 1401, when the mounting base 105 and the first connecting portion 101 are arranged along the first direction 2a, the first electrical compartment 1110 and the mounting groove 1401 are substantially arranged along the first direction 2a, so that the first electrical compartment 1110 can be offset from the mounting groove 1401 along the first direction 2a. It can be understood that the axial direction of the mounting groove 1401 may also be not perpendicular to the first direction 2a. When the mounting groove 1401 and the first electrical compartment 1110 are arranged along the first direction 2a, the thickness of the near-eye display module 2 in the axial direction of the mounting groove 1401 can be reduced to a certain extent. After the optical engine 400 is mounted in the mounting groove 1401 and the battery 8 is mounted in the first electrical compartment 1110, since the battery 8 and the optical engine 400 are substantially distributed along the first direction 2a, one side of the mounting groove 1401 along the axial direction serves as a light exit side of the optical engine 400. When the near-eye display module 2 is mounted on the outer side of the optical lens 12, light passes through the optical lens 12 and enters the human eye, and the overall thickness of the near-eye display module 2 on the optical lens 12 is relatively small, enabling power supply to the optical engine 400 without increasing the overall thickness of an AR device. When the near-eye display module 2 is mounted on the inner side of the optical lens 12, light directly enters the human eye without passing through the lens. The overall thickness of the near-eye display module 2 is not increased, which reduces the intrusion feeling of the near-eye display module 2 to the user's eyeballs, thereby lowering oppressive feeling and improving product comfort. In the embodiment, the first electrical compartment 1110 and the mounting slot 1401 are arranged along the first direction 2a, so that an electrical structure such as the battery 8 in the first electrical compartment 1110 and the optical engine 400 in the mounting groove 1401 can maintain relative balance on the near-eye display module 2, balancing the weight distribution of the near-eye display module 2 and helping improve the stability of the near-eye display module 2 on the optical lens 12.

In some embodiments, the battery 8 or a related circuit board can be directly mounted in the first electrical compartment 3, which can reduce the need to additionally dispose electrical connecting elements for connecting the optical engine 400 and the battery 8 at the connection between the temple 13 and the frame body 11 of the AR device. On the one hand, this reduces water ingress or wear of electrical connecting members/portions caused by relative movement between the temple and the frame body 11. On the other hand, it reduces the complexity at a connecting portion of the temple and the frame body 11 and simplifies the structure of the AR device. In some application scenarios, the near-eye display module 2 can operate independently without connecting to an electrical element of the temple (e.g., displaying image content), which greatly improves the portability and mobility of the display assembly 1, enables compatibility with other conventional head-mounted devices such as myopia and hyperopia glasses, protective glasses and helmets, and enriches and diversifies application scenarios.

In some embodiments, the first connecting portion 101 may be provided with a first wire passing hole 15 that directly communicates with the interior of the first electrical compartment 1110 and the mounting groove 1401, so that the battery 8 and the optical engine 400 are connected by an electrical element from inside the near-eye display module 2. By arranging the battery 8 in the first connecting portion 101, the wiring structure opened outside the first connecting portion 101 or the mounting base 105 can be reduced, packaging steps for the near-eye display module 2 can be simplified, and the product production efficiency can be improved when the near-eye display module 2 is packaged. In some embodiments, the first connecting portion 101 may be provided with the first wire passing hole 15 that communicates with the first electrical compartment 1110 and an outer wall of the first connecting portion 101, and the battery 8 and the optical engine 400 in the first electrical compartment 1110 can be connected by an electrical structure passing through the first wire hole 15.

The optical engine 400 in some embodiments of the present disclosure may include an optical module 42 and a microdisplay 41. The optical module 42 and the microdisplay 41 may be fixedly connected to each other, or may be connected and fixed to the mounting base 105 respectively.

Referring to FIG. 50, FIG. 51, and FIG. 55 to FIG. 58, in some embodiments, the first connecting portion 101 includes a first cover body 102 and a second cover body 103. The first cover body 102 is provided with the first electrical compartment 1110. The second cover body 103 covers the first cover body 102 and is configured to close the first electrical compartment 1110. At least one of the first cover body 102 and the second cover body 103 is connected to the mounting base 105.

The first electrical compartment 1110 may be a groove provided on the first cover body 102. The first electrical compartment 1110 may be provided with an opening, through which the battery 8 can be placed into the first electrical compartment 1110.

The second cover body 103 is connected to the first cover body 102 and can be configured to close the opening of the first electrical compartment 1110.

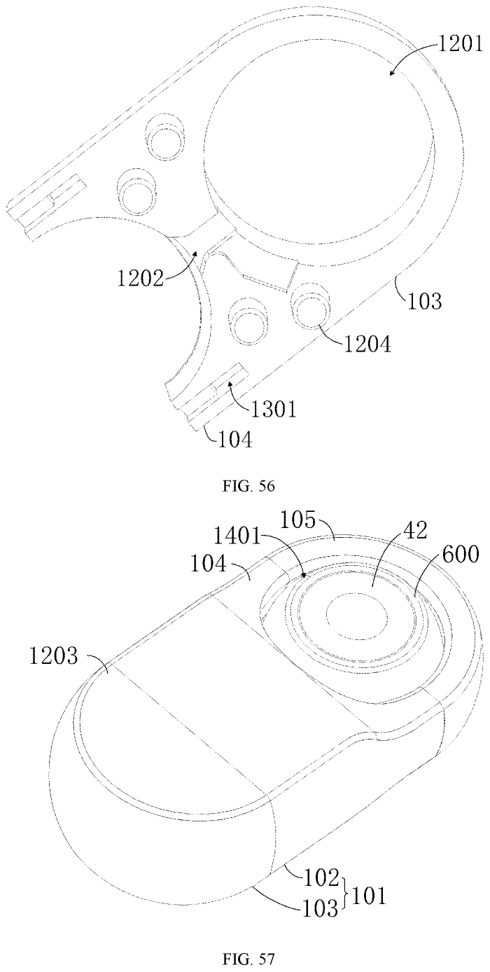

Referring to FIG. 50, FIG. 51, FIG. 55 and FIG. 56, in some embodiments, the opening of the first electrical compartment 1110 may be provided on one side of the first cover body 102 along a second direction 2b, and the second cover body 103 may cover the first cover body 102 along the second direction 2b. The second direction 2b may be parallel to the axial direction of the mounting groove 1401. In some embodiments, an end surface of the first cover body 102 facing away from the second cover body 103 may serve as the fixing surface 1203 of the first connecting portion 101; or, an end surface of the second cover body 103 facing away from the first cover body 102 may serve as the fixing surface 1203 of the first connecting portion 101.

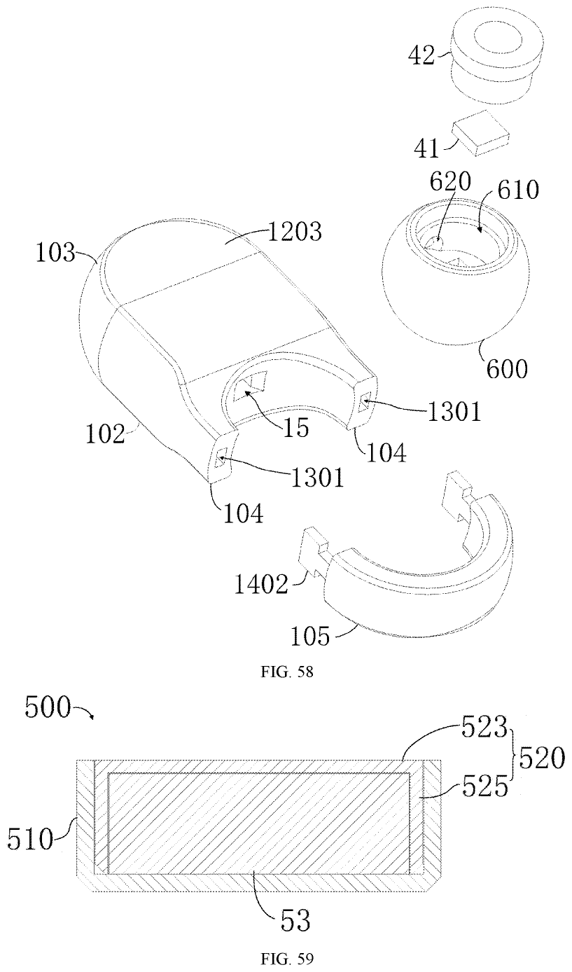

Referring to FIG. 57 and FIG. 58, in some embodiments, the opening of the first electrical compartment 1110 may be provided on one side of the first cover body 102 along the first direction 2a. The opening of the first electrical compartment 1110 may be arranged away from the mounting base. The second cover body 103 may cover the first connecting portion 101 along the first direction 2a.

In some embodiments, the first connecting portion 101 is formed by combining the first cover body 102 and the second cover body 103, which facilitates forming the first electrical compartment 1110 on the first cover body 102 and enables convenient molding and mold opening during processing of the first cover body 102. The first cover body 102 and the second cover body 103 may be fixedly connected to each other. For example, the first cover body 102 and the second cover body 103 may be bonded to each other. In some embodiments, the first cover body 102 and the second cover body 103 may be detachably connected. For example, the first cover body 102 and the second cover body 103 may be snap-fitted or threadedly connected to each other. In some embodiments, one of the first cover body 102 and the second cover body 103 is protrudingly provided with a positioning post 1204, and the other is provided with a positioning hole 117. The positioning post 1204 can be embedded into the positioning hole 117 to facilitate mutual positioning and assembly of the first cover body 102 and the second cover body 103.

In some embodiments, the arrangement that at least one of the first cover body 102 and the second cover body 103 is connected to the mounting base 105 means that the mounting base 105 is connected to either the first cover body 102 or the second cover body 103, or connected to both the first cover body 102 and the second cover body 103. Taking the snap-fit connection between the mounting base 105 and the first connecting portion 101 as an example, the mounting base 105 may be snap-fitted to one of the first cover body 102 and the second cover body 103, or simultaneously snap-fitted to both the first cover body 102 and the second cover body 103.

Referring to FIG. 52, FIG. 54 and FIG. 55, in some embodiments, the first cover body 102 is provided with a first wiring groove 113 that communicates with the mounting groove 1401 and the first electrical compartment 1110. The first wiring groove 113 is configured to allow a conductive module of the optical engine 400 to pass through and be connected to an electrical component.

For convenience of description, in some embodiments, the battery 8 is taken as an example of the electrical component. The conductive module can be connected to a corresponding electrode of the battery 8. The first wiring groove 113 communicates with the mounting groove 1401 and the first electrical compartment 1110, so that the conductive module of the optical engine 400 can enter the first electrical compartment 1110 via the first wiring groove 113. In some embodiments of the present disclosure, the conductive module of the optical engine 400 may be a wire, a metal sheet, a flexible circuit board, a copper-plated layer, or the like. The first cover body 102 is provided with a first wiring groove 113 for arranging the conductive module, which facilitates disposing the conductive module in the first connecting portion 101 and prevents the conductive module of the optical engine 400 from being exposed outside the first connecting portion 101, thereby reducing short-circuit problems caused by water ingress at a wiring portion. The wiring groove in some embodiments may be a through slot penetrating one end of the first cover body 102 adjacent to the mounting base 105. In some embodiments, the first wiring groove 113 may be configured to allow the conductive module of the optical engine 400 to pass through and be connected to the positive electrode of the battery 8. In some embodiments, the first wiring groove 113 may be configured to allow the conductive module of the optical engine 400 to pass through and be connected to the negative electrode of the battery 8. In some embodiments, the first wiring groove 113 may be configured to allow the conductive module of the optical engine 400 to pass through and be separately connected to both the positive and negative electrodes of the battery 8. In some embodiments, the second cover body 103 covers the first cover body 102 along the second direction 2b described above, the first wiring groove 113 is provided with an opening facing the second cover body 103, and the second cover body 103 can cover the opening of the first wiring groove 113, so that one end of the first wiring groove 113 communicates with the mounting groove 1401 and the other end communicates with the first electrical compartment 1110.

In some embodiments, the first cover body 102 is provided with a first wire passing hole 15. One end of the first wire passing hole 15 communicates with the first wiring groove 113, and the other end communicates with the mounting groove 1401. The first wire passing hole 15 is configured to accommodate the conductive module of the optical engine 400. The conductive module of the optical engine 400 passes through the first wire passing hole 15 and communicates with the electrical component via the first wiring groove 113.

Referring to FIG. 55, in some embodiments, the first cover body 102 is provided with a first recessed groove 112 for accommodating an electrode tab. The first recessed groove 112 communicates with the first wiring groove 113 and the first electrical compartment 1110. The electrode tab is configured to be connected to the conductive module and an electrical component. For example, the electrode tab may be connected to a corresponding electrode of the battery 8.

The first recessed groove 112 communicates with the first wiring groove 113 and the first electrical compartment 1110, meaning that the first recessed groove 112 at least includes an opening respectively communicating with the first wiring groove 113 and the first electrical compartment 1110, so that the electrode tab disposed in the first recessed groove 112 can electrically connect the electrical component and the conductive module in the first wiring groove 113. The electrode tab described herein may be a metal sheet or other structure with conductive performance. The first recessed groove 112 serves as an intermediate connecting member between the electrical component and the conductive module, facilitating electrical connection between the conductive module and the electrical component. Taking the battery 8 as an example of the electrical component, the electrode tab can be mounted in the first wiring groove 113 without occupying the internal space of the first electrical compartment 1110, which can reduce the interference between the electrode tab and the battery 8, improve the mounting convenience of the battery 8, and also help improve the stability of the battery 8.

Referring to FIG. 51, FIG. 52 and FIG. 55, in some embodiments, taking the battery 8 as an example, the first electrical compartment 1110 is provided with an opening facing the second cover body 103 and a bottom wall disposed opposite to the opening. The first recessed groove 112 is provided on the bottom wall of the first electrical compartment 1110. The opening of the first electrical compartment 1110 is configured to allow the battery 8 to be placed into the first electrical compartment 1110. The bottom wall of the first electrical compartment 1110 is disposed opposite to the opening of the first electrical compartment 1110. The position of the bottom wall of the first electrical compartment 1110 can be the deepest mounting position of the battery 8 in the first electrical compartment 1110. The first recessed groove 112 is provided on the bottom wall of the first electrical compartment 1110, so that the mounted electrode tab do not occupy the internal space of the first electrical compartment 1110. In some embodiments, the opening of the first electrical compartment 1110 is located on a side of the first cover body 102 far away from the mounting base 105 along the first direction 2a. The second cover body 103 covers the opening of the first electrical compartment 1110 along the first direction 2a. The bottom wall of the first electrical compartment 1110 is located on a side adjacent to the mounting base 105 along the first direction 2a. The first wiring groove 113 can be connected adjacently to the mounting groove 1401 and the first recessed groove 112. In some embodiments, the second cover body 103 covers the opening of the first electrical compartment 1110 along the second direction 2b. The bottom wall of the first electrical compartment 1110 is disposed at one end face of the first electrical compartment 1110 along the second direction 2b. The first wiring groove 113 is partially located on the bottom wall of the first electrical compartment 1110, and partially located on the side wall of the first electrical compartment 1110 while communicating with the mounting groove 1401.

In some embodiments, the first cover body 102 is further provided with a second wiring groove 116 that communicates with the mounting groove 1401 and the first electrical compartment 1110. The second wiring groove 116 is configured to allow the conductive module of the optical engine 400 to pass through and be connected to an electrical component. Taking the battery as an example of the electrical component in an embodiment, the second wiring groove 116 cooperates with the first wiring groove 113 to enable the conductive module of the optical engine 400 to be respectively connected to the positive electrode and the negative electrode of the battery 8. For example, the conductive module passes through the first wiring groove 113 and is connected to the positive electrode of the battery 8. The second wiring groove 116 is configured to allow the conductive module to pass through and connect to the negative electrode of the battery 8. The electrical component may also be a combination of the battery 8 and a circuit board. The second wiring groove 116 is configured to allow the conductive module of the optical engine 400 to pass through and be connected to the circuit board and the optical engine 400. The first wiring groove 113 and the second wiring groove 116 may be in communication with each other. The first wiring groove 113 and the second wiring groove 116 may be arranged independently. In some embodiments, the first wire passing hole 15 described in any foregoing embodiment is provided at an end of the first cover body 102 adjacent to the mounting groove 1401. The first wiring groove 113 and the second wiring groove 116 each communicate with the first wire passing hole 15.

Referring to FIG. 54 and FIG. 56, in some embodiments, a second recessed groove 1201 is provided on a side of the second cover body 103 facing the first cover body 102. The second recessed groove 1201 is configured to accommodate one of the battery 8, a circuit board, a magnet 53, a counterweight block, or a combination thereof. After the first cover body 102 and the second cover body 103 are closed, the first cover body 102 can close the second recessed groove 1201 of the second cover body 103, so that the battery 8, the circuit board, the magnet 53 or the counterweight block in the second recessed groove 1201 is prevented from being exposed outside the first connecting portion 101. The arrangement of the second recessed groove 1201 facilitates adding the battery 8 and other structures in the first connecting portion 101 to extend the battery life of the near-eye display module 2. The circuit board of the near-eye display module 2 can be mounted in the second recessed groove 1201, which balances the weight distribution of the near-eye display module 2 while accommodating the circuit board in the first connecting portion 101. This reduces the layout of the circuit board on the outside of the near-eye display module 2, simplifies the structure of the near-eye display module 2 and improves assembly performance. The second recessed groove 1201 can also be configured to mount the magnet 53 and/or the counterweight block. The magnet 53 enables the near-eye display module 2 to be magnetically attached to a preset position on the optical lens 12, so that the position of the near-eye display module 2 on the optical lens 12 can be adjusted as needed to adapt to users with different pupil distances. The second recessed groove 1201 may also be configured to mount other functional modules.

Referring to FIG. 54 and FIG. 56, in some embodiments, the second cover body 103 covers the first cover body 102 along the second direction 2b, and the second direction 2b is arranged at an angle to the first direction 2a. The second cover body 103 is provided with a third wiring groove 1202 that communicates with the mounting groove 1401 and the second recessed groove 1201. In some embodiments, the third wiring groove 1202 at least includes an opening that communicates with the mounting groove 1401 and the second recessed groove 1201, so as to facilitate electrical connection between an electrical element in the second recessed groove 1201 and the optical engine 400. The second cover body 103 covers the first cover body 102 along the second direction 2b, and the second direction 2b may be parallel to the axial direction of the mounting groove 1401. The depth of the second recessed groove 1201 can be determined based on the number, shape and volume of the battery 8, the circuit board, the magnet 53 and/or the counterweight block to be mounted. Optionally, the second recessed groove 1201 and the first recessed groove 112 are oppositely arranged to save the internal space of the first connecting portion 101. The second recessed groove 1201 provides sufficient internal space for the near-eye display module 2 to expand a functional component as needed. In some application scenarios, for example, the magnetic attraction force of a single magnet to a battery may be insufficient to support the near-eye display module 2 on the optical lens 12. To achieve stronger clamping attraction, a metal block or an additional magnet can be arranged in the second recessed groove 1201, so that magnetic clamping between the first connecting portion 101 and an external magnet are more stable.

Referring to FIG. 50, FIG. 51 and FIG. 55, in some embodiments, the first connecting portion 101 is provided with a through hole 114. One end of the through hole 114 communicates with the first electrical compartment 1110, and the other end penetrates through an outer wall of the first connecting portion 101. The through hole 114 is configured to allow electrical components to move in and out relative to the first connecting portion 101. The near-eye display module 2 further includes a sealing cover 115 for closing the through hole 114. The through hole 114 penetrates a side wall of the first connecting portion 101 and communicates with the first electrical compartment 1110, so that the electrical component in the first electrical compartment 1110 can move to the outside of the first connecting portion 101 via the through hole 114. Taking the battery 8 as an example, the battery 8 can be placed into the first electrical compartment 1110 through the through hole 114 to facilitate assembly. The sealing cover 115 is mounted on the first connecting portion 101 to close the through hole 114 when needed. The sealing cover 115 may be annular or provided with a mounting groove, and the battery 8 may be mounted in the sealing cover 115. Since the sealing cover 115 surrounds the battery 8 in its entire circumference, the insertion and removal of the battery 8 can be realized. The sealing cover 115 may further be provided with a finger grip exposed relative to the first cover body 102 to facilitate user operation. When mounting the battery 8 into the first electrical compartment 1110, the battery 8 may be inserted into the first electrical compartment 1110 through the through hole 114, and the through hole 114 is closed by the sealing cover 115. In some embodiments, the sealing cover may have a shape and size matching the through hole 114 so as to completely seal the through hole 114. In some embodiments, the sealing cover may cover the outer surface of the first connecting portion 101 to cover the through hole 114 from the outer surface of the first connecting portion 101. In some embodiments, the sealing cover may be partially embedded in the through hole 114 and partially attached to the outer surface of the first connecting portion 101, so as to facilitate fixation of the sealing cover. Optionally, the first connecting portion 101 includes the first cover body 102 and the second cover body 103 described in any of the foregoing embodiments. The through hole 114 may be provided on either the first cover body 102 or the second cover body 103. For ease of description, the following takes the through hole 114 provided on the first cover body 102 as an example. In some embodiments, the first cover body 102 is provided with the first recessed groove 112 described in any of the foregoing embodiments for mounting an electrode tab, and the first recessed groove 112 may be offset from the through hole 114.

Referring to FIG. 51 and FIG. 54, in some embodiments, the near-eye display module 2 further includes an annular fixing portion 1151 connected to the sealing cover 115. The annular fixing portion 1151 is configured to fit around an electrical component, and the through hole 114 is further configured to allow the annular fixing portion 1151 to move toward the outer side of the first connecting portion 101. The annular fixing portion 1151 fits around the electrical component. When the sealing cover 115 moves outward from the first connecting portion 101 via the through hole 114, the annular fixing portion 1151 can drive the electrical component to move synchronously, thereby facilitating the assembly and disassembly of the electrical component. The annular fixing portion 1151 may be integrally formed with the sealing cover 115, or be separate from the sealing cover 115 and connected to each other. The annular fixing portion 1151 may be a complete annular structure or a partially split annular structure.

Referring to FIG. 50 and FIG. 51, in some embodiments, the through hole 114 is disposed at an end of the first connecting portion 101 far away from the mounting base 105. The through hole 114 is configured to allow an electrical component to move along the first direction 2a. Since the mounting base 105 is disposed on one side of the first connecting portion 101 along the first direction 2a, moving the electrical component along the first direction 2a through the through hole 114 can reduce the interference of the mounting base 105 with the electrical component during the assembly and disassembly of the electrical component.

Referring to FIG. 57 and FIG. 58, in some embodiments, the first connecting portion 101 includes a first cover body 102 and a second cover body 103. The first cover body 102 is connected to the mounting base 105 and is provided with the first electrical compartment 1110. An opening that communicates with the first electrical compartment 1110 is provided on a side of the first cover body 102 facing away from the mounting base 105. The second cover body 103 covers the first cover body 102. The second cover body 103 covers the opening of the first electrical compartment 1110 along the first direction 2a. The second cover body 103 covers the side of the first cover body 102 far away from the mounting base 105 to enclose the first electrical compartment 1110. The opening is configured to allow an electrical component such as the battery 8 to be placed into the first electrical compartment 1110. By covering the first cover body 102 with the second cover body 103 along the first direction 2a, the interference of the mounting base 105 on the second cover body 103 can be reduced, thereby improving the assembly performance of the first cover body 102 and the second cover body 103. In some embodiments, the second cover body 103 may be provided with a second recessed groove 1201 at a position corresponding to the first electrical compartment 1110. When the first cover body 102 and the second cover body 103 are closed to form the first connecting portion 101, part of the electrical component may be accommodated in the second recessed groove 1201. Optionally, the second recessed groove 1201 may also be configured for mounting other functional modules such as a circuit board and a magnet. In some embodiments, the first cover body 102 is provided with the first wiring groove 113 described in any of the foregoing embodiments to facilitate electrical connection between the conductive module of the optical engine 400 and the electrical component. The first wiring groove 113 may be located on a side of the first cover body 102 far away from the second cover body 103. In some embodiments, the first cover body 102 may further be provided with the first recessed groove 112 described in any of the foregoing embodiments, and the first recessed groove 112 may be connected to the first wiring groove 113.

Referring to FIG. 52 and FIG. 58, in some embodiments, a protruding portion 104 is provided on a side of the first connecting portion 101 adjacent to the mounting base 105. There are two protrusions 104, which are spaced apart. The mounting base 105 is respectively connected to the two protruding portions 104. The two protruding portions 104 and the mounting base 105 together enclose to form the mounting groove 1401. The two spaced protruding portions 104 allow part of the optical engine 400 to be located between the two protruding portions 104. The mounting base 105 is connected to the two protruding portions 104 and cooperates with the two protruding portions 104 to form the mounting groove 1401. In some embodiments, a recess is provided on a side of the mounting base 105 facing the first connecting portion 101, and the recess of the mounting base 105 cooperates with a gap between the two protruding portions 104 to form the mounting groove 1401. The protruding portions 104 serve as connecting structures between the first connecting portion 101 and the mounting base 105, enhancing the stability of the connection between the first connecting part 101 and the mounting base 105. For wiring of the optical engine 400, optionally, the first connecting portion 101 is provided with the first wire passing hole 15 that communicates with the mounting groove 1401 and the first electrical compartment 1110. The first wire passing hole 15 is configured to accommodate the conductive module of the optical engine 400. An end of the first wire passing hole 15 far away from the first electrical compartment 1110 is located between the two protruding portions 104. Since the two protruding portions 104 are spaced apart, the first wire passing hole 15 is hidden between the two protruding portions 104, reducing the exposure of the conductive module of the optical engine 400 and thus reducing the problem of water ingress into the near-eye display module 2.

In some embodiments, one of the mounting base 105 and the protruding portion 104 is provided with a snap-fit member 1402, and the other is provided with a snap-fit groove 1301. The snap-fit member 1402 is snapped to the snap-fit groove 1301. The snap-fit member 1402 and the snap-fit groove 1301 are mutually adapted to mount the mounting base 105 on the protruding portion 104. For ease of description, the following embodiment takes the snap-fit groove 1301 disposed on the protruding portion 104 and the snap-fit member 1402 disposed on the mounting base 105 as an example. Optionally, the snap-fit groove 1301 may be a straight groove, a T-shaped groove, or other grooved structures. Optionally, the snap-fit member 1402 may be integrally formed with the mounting base 105, or be separate from the mounting base 105 and connected to each other.

Referring to FIG. 57 and FIG. 58, in some embodiments, the first connecting portion 101 includes the first cover body 102 and the second cover body 103 described in any of the foregoing embodiments. The second cover body 103 covers the first cover body 102 along the first direction 2a. The protruding portion 104 described above is provided on a side of the first cover body 102 far away from the second cover body 103.

Referring to FIG. 50 to FIG. 56, in some embodiments, the first connecting portion 101 includes the first cover body 102 and the second cover body 103 described in any of the foregoing embodiments. The second cover body 103 covers the first cover body 102 along the second direction 2b. The protruding portion 104 described above is provided at an end of the first cover body 102 or the second cover body 103 adjacent to the mounting base 105.

Referring to FIG. 50 to FIG. 56, in some embodiments, the first connecting portion 101 includes the first cover body 102 and the second cover body 103 described in any of the foregoing embodiments. The second cover body 103 covers the first cover body 102 along the second direction 2b. The protruding portions 104 described above are respectively provided at ends of the first cover body 102 and the second cover body 103 adjacent to the mounting base 105. The snap-fit member 1402 on the mounting base 105 is simultaneously snapped to the protruding portions 104 of the first cover body 102 and the second cover body 103. Optionally, the snap-fit member 1402 may be a T-shaped structure. Each of the protruding portions 104 of the first cover body 102 and the second cover body 103 is provided with a snap-fit groove 1301. When the second cover body 103 covers the first cover body 102, the snap-fit grooves 1301 of the first cover body 102 and the second cover body 103 enclose to form a T-shaped groove. The snap-fit member 1402 is snapped to the T-shaped groove to limit the movement of the mounting base 105 relative to the first connecting portion 101 along the first direction 2a.

Referring to FIG. 50 to FIG. 54, in some embodiments, the near-eye display module 2 further includes a fixing base 600 mounted in the mounting groove 1401. The fixing base 600 is provided with a fixing groove 610 for mounting the optical engine 400. The fixing base 600 is provided with a second wire passing hole 620 for accommodating a conductive module of the optical engine 400. One end of the second wire passing hole 620 communicates with the fixing groove 610, and the other end penetrates to the outer wall of the fixing base 600.

The fixing base 600 is configured to mount the optical engine 400 on the mounting base 105 and can also protect the optical engine 400. The fixing groove 610 may be a through groove or a recessed groove provided on the fixing base 600. The fixing base 600 may be fixedly connected to the mounting base 105; or the mounting base 600 may be movably mounted on the mounting base 105. The second wire passing hole 620 serves as a channel for accommodating the conductive module of the optical engine 400, facilitating the wiring of the optical engine 400.

In some embodiments, the first connecting portion 101 is provided with the first wire passing hole 15 described in any of the foregoing embodiments. The second wire passing hole 620 may be communicate with the first wire passing hole 15.

In some embodiments, an axial direction of the second wire passing hole 620 is arranged at an angle to an axial direction of the fixing groove 610. The second wire passing hole 620 is configured to allow an conductive module of the optical engine 400 to pass through, so that the electrical component of the optical engine 400 can be connected to an electrical component in the first electrical compartment 1110. The shape of the fixing groove 610 matches the outline of the optical engine 400. The fixing groove 610 is provided with an opening. The opening of the fixing groove 610 may be provided on the same side as a light exit side of the optical engine 400. An axial direction of the fixing groove 610 is arranged at an angle to the first direction 2a. Optionally, the axial direction of the fixing groove 610 may be perpendicular to a plane where the opening of the fixing groove 610 is located. The axial direction of the second wire passing hole 620 is arranged at an angle to the axial direction of the fixing groove 610, meaning that the two axial directions are neither parallel nor coincident. With such arrangement, the conductive module of the optical engine 400 can be led out from the side of the fixing base 600, thereby shortening the distance between the conductive module and the first electrical compartment 1110. Since the conductive module can be led out from the side of the fixing base 600, the fixing groove 610 can be configured as a recessed groove, facilitating sealing between the optical engine 400 and the inner wall of the fixing groove 610.

In some embodiments, the fixing base 600 is provided with a second electrical compartment 630, and the second wire passing hole 620 communicates with the fixing groove 610 via the second electrical compartment 630. The second electrical compartment 630 can be configured to accommodate structures such as the optical engine and a circuit board, so that the circuit module of the optical engine 400 can be built into the fixing base 600, thereby simplifying the structure of the near-eye display module 2, improving the compactness of the product, facilitating the packaging of the product, and allowing functional expansion of the near-eye display module 2 as needed. The second electrical compartment 630 communicates with the second wire passing hole 620, which facilitates leading out the conductive module, circuit board and other structures of the optical engine 400 through the second wire passing hole 620 for routing arrangement.

Referring to FIG. 52 and FIG. 54, in some embodiments, one of an outer wall surface of the fixing base 600 and an inner wall surface of the mounting groove 1401 is a convex arc surface, and the other is a concave arc surface adapted to the convex arc surface. The mounting groove 1401 is configured to allow the fixing base 600 to rotate within the fixing base 600 to adjust a light exit angle of the optical engine 400. The convex arc surface and the concave arc surface are mutually adapted, meaning that the convex arc surface can fit against the concave arc surface, so that the fixing base 600 can rotate relative to the mounting base 105 in the mounting groove 1401. When the fixing base 600 rotates relative to the mounting base 105, the optical engine 400 on the fixing base 600 can also rotate synchronously, thereby synchronously allowing the light exit angle of the optical engine 400 to change synchronously. By adjusting the position of the optical engine 400 relative to the human eye's field of view, the position of the optical engine 400 can be precisely adjust to adapt to different users with varying pupil distances or field-of-view ranges, and meet the viewing needs and preferences of different users. In addition, flexible position testing can be achieved in the early research and development stage to achieve the intended design effect.

In some embodiment, at least part of the outer surface of the fixing base 600 may be spherical, and the inner wall surface of the mounting groove 1401 is a concave arc surface, so that the fixing base 600 can rotate relative to the mounting base 105 in the mounting groove 1401. Optionally, the outer surface of the fixing base 600 may be a concave arc surface, and the inner wall surface of the mounting groove 1401 may be a convex arc surface, so that the fixing base 600 can rotate relative to the mounting base 105 in the mounting groove 1401.

Based on the foregoing near-eye display module 2, some embodiments of the present disclosure further provide a near-eye display apparatus for an optical lens 12. The near-eye display apparatus includes the near-eye display module 2 according to any of the foregoing embodiments. The first connecting portion 101 of the near-eye display module 2 is connected to the optical lens 12. The first connecting portion 101 may be fixedly connected or detachably connected to the optical lens 12.

It can be understood that the examples of the near-eye display apparatus in the present disclosure include the near-eye display apparatus according to any of the foregoing embodiments, as well as corresponding technical effects in any of the above embodiments, which will not be repeated herein.

Referring to FIG. 49 and FIG. 59, in some embodiments, the first connecting portion 101 of the near-eye display module 2 is connected to a first side of the optical lens 12. The near-eye display apparatus further includes a second connecting portion 500. The second connecting portion 500 is disposed opposite to the first connecting portion 101 and is configured to be connected to a second side of the optical lens 12. The first side and the second side of the optical lens 12 are opposite sides. The first connecting portion 101 and the second connecting portion 500 are configured to cooperate to clamp the lens and allow the mounting base 105 to move on the lens, so as to adjust the position of the optical engine 400 relative to the lens.

In some embodiments, the second connecting portion 500 may be a component fixedly connected to the first connecting portion. For example, the first connecting portion 101 may be fixed to the second connecting portion 500 by means of bonding, snap-fit, threaded connection or the like. The first connecting portion 101 may also be connected to the second connecting portion 500 via an intermediate connecting member. In some embodiments, the first connecting portion 101 and the second connecting portion 500 may be independent components, and the first connecting portion 101 and the second connecting portion 500 may cooperate with each other to serve as a a clamping or magnetic attraction element.

Referring to FIG. 59, in some embodiments, at least part of the second connecting portion 500 is made of magnetic material. The second connecting portion 500 may be made entirely of magnetic material or partially of magnetic material. As shown in FIG. 49 and FIG. 59, the second connecting portion 500 includes a sleeve 510 and a magnet 53 embedded in the sleeve 510. Since structures such as the battery 8 can be attracted by the magnet 53, when the first connecting portion 101 and the second connecting portion 500 are respectively disposed on two sides of the optical lens 12, the second connecting portion 500 can attract the first connecting portion 101 to a preset position on the optical lens 12. In some embodiments, the first connecting portion 101 includes the first cover body and the second cover body according to any of the foregoing embodiments. The second cover body is provided with a second recessed groove, and a magnet can be configured to be mounted in the second recessed groove to enhance the attraction performance between the first connecting portion and the second connecting portion.

In some embodiments, the second connecting portion 500 is provided with a protection member 520. The protection member 520 may be a protective film or a protective cover. The protection member 520 is configured to be interposed between the magnet 53 and the optical lens 12 to reduce wear on the optical lens 12. Optionally, one end of the sleeve 510 is provided with an opening for the magnet 53 to pass through and be embedded into the sleeve 510. The protection member 520 includes a protection layer 523 and a fixing layer 525 connected to the protection layer 523. The protection layer 523 covers the opening of the sleeve 510 to be interposed between the magnet 53 and the optical lens 12. The fixing layer 525 is sleeved inside or outside the sleeve 510 to improve the sealing performance of the second connecting portion 500.

Referring to FIG. 49, in some embodiments, the first connecting portion 101 is provided with a fixing surface 1203, which is disposed opposite to the second connecting portion 500. The fixing surface 1203 is arranged on the same side as a light exit side of the optical engine 400. In some embodiments, the fixing surface 1203 may be a surface of the first connecting portion 101. Since the fixing surface 1203 is disposed on the same side as the light exit side of the optical engine 400, when the near-eye display apparatus is mounted, the near-eye display module 2 is located on the outer side of the optical lens 12, and the second connecting portion 500 can be located on the inner side of the optical lens 12, which reduces the visual intrusion caused by the near-eye display apparatus and improves the comfort of the product.

Different from the foregoing embodiment, in some embodiments, the fixing surface 1203 is arranged away from the light exit side of the optical engine 400. The fixing surface 1203 may be a surface of the first connecting portion 101. Since the fixing surface 1203 is disposed on the side opposite to the light exit side of the optical engine 400, when the near-eye display apparatus is mounted, the near-eye display module 2 is located on the inner side of the optical lens 12, and the second connecting portion 500 can be located on the outer side of the optical lens 12.

Based on the foregoing embodiments of the near-eye display apparatus, the present disclosure further provides an embodiment of a wearable device. The wearable device may be myopia glasses, hyperopia glasses, sports glasses, protective glasses, a helmet, smart glasses, or the like, and includes the near-eye display module or the near-eye display apparatus according to any of the foregoing embodiments.

Since wearable head-mounted devices are usually worn for a long time. smaller and lighter head-mounted devices are a constant pursuit of major manufacturers. Existing modules, such as those using prism technology, are still relatively heavy and bulky, while optical waveguide technology has low optical efficiency. These existing technologies will greatly change the appearance and structure of conventional glasses such as myopia glasses, hyperopia glasses, protective glasses and sunglasses, as well as head-mounted devices such as helmets, making it extremely difficult to combine conventional solutions with traditional glasses, helmets, and other head-mounted devices. In addition, as a device that needs to transmit data to the retina of the human eye, taking head-mounted devices as an example, it is very important that the content within the field of vision of the human retina can be presented clearly and completely. In the scenario of integrating virtual and reality, obtaining virtual information with a wider field of view has become an increasingly important functional requirement. Superior image quality and high optical efficiency are also extremely important. lightweight, small size and compatibility with various head-mounted devices have become urgent challenges to be addressed. Embodiments of the present disclosure provide an optical module 100′ applicable to various relevant embodiments, which will be described in detail below respectively.

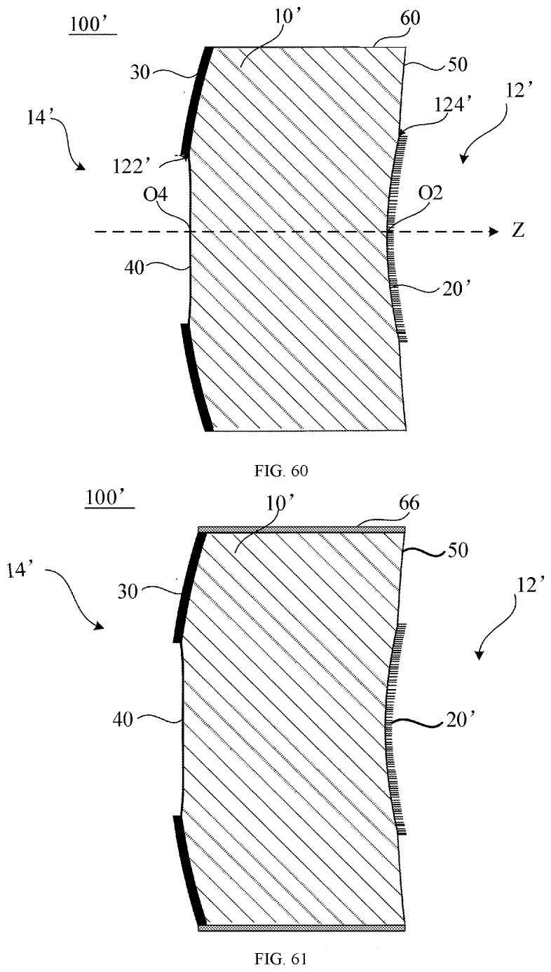

The optical module 100′ can be applied to a near-eye display apparatus 200′, such as Augmented Reality (AR), Virtual Reality (VR), Mixed Reality (MR), Extended Reality (XR), goggles, smart glasses, myopia glasses, hyperopia glasses, sports glasses, contact lenses, helmets and other related near-eye display apparatus. Referring to FIG. 60 to FIG. 74, the optical module 100′ includes a base body 10′. The base body 10′ include a first end 12′ and a second end 14′ opposite to each other. The base body 10′ may be a solid structure. For example, the base body 10′ is made of a transparent or light-transmitting hard and machinable material, such as polymethyl methacrylate (PMMA), polycarbonate (PC) plastic, resin, glass or the like. For example, the base body 10′ may be in a regular shape such as a cylinder, a prism or a frustum, or an irregular shape. In other embodiments, the base body 10′ may also be of a hollow structure. For example, the base body 10′ may be formed by bonding at least two groups of thin walls with optical glue and has a hollow center. A first reflecting surface 20′, a second reflecting surface 30, an incident surface 40, an exit surface 50 and the like may be provided on the thin walls.

The first reflecting surface 20′ is disposed at a first end 12′ of the base body 10′ and configured to reflect light.

The second reflecting surface 30 is disposed at a second end 14′ of the base body 10′ and configured to receive light reflected by the first reflecting surface 20′ and reflect the light again. It can be understood that the first end 12′ and the second end 14′ are two opposite ends. The first reflecting surface 20′ and the second reflecting surface 30 may be provided with a reflective material such as metal or metal alloy, for example, aluminum, silver, or a mixture of aluminum and silver.

The incident surface 40 is disposed at the second end 14′ of the base body 10′ and surrounded by the second reflecting surface 30.

The exit surface 50 is disposed at the first end 12′ of the base body 10′ and arranged to surround the first reflecting surface 20′. The size of the exit surface 50 may be the same as that of a second reflection window 1312. In other embodiments, the size of the exit surface 50 may also be different from that of the second reflection window 1312.

One end of the annular side surface 60 is connected to the second reflecting surface 30, and the other end is connected to the exit surface 50.

Each of the incident surface 40 and the exit surface 50 is configured as one of an aspherical surface, a spherical surface, a freeform surface, or a combination thereof. The incident surface 40 is configured to receive light L of an image from the microdisplay 80. The light enters the base body 10′ through the non-planar (one or a combination of an aspherical surface, a spherical surface, a freeform surface) incident surface 40, is reflected by the first reflecting surface 20′, is further reflected by the second reflecting surface 30, and exits the base body 10′ through the non-planar exit surface 50. The microdisplay 80 may, for example, the technology or combination thereof described in the foregoing related embodiments, which will not be repeated herein. In some embodiments, the optical module can be combined with existing ordinary eyeglasses such as myopia glasses, hyperopia glasses, protective glasses and sports glasses to achieve an augmented display function, enabling ordinary eyeglasses to have the augmented reality function of smart glasses. It should be understood that the black or shaded areas of each reflecting surface (e.g., the first reflecting surface 20′ and the second reflecting surface 30) in the drawings of the present disclosure (e.g., FIG. 1-2, FIG. 8-11) merely schematically indicate a reflective layer, rather than representing the actual thickness design.

It is recognized that in the related art, to better enable the microdisplay 80 to fit against to the incident surface 40 (e.g., using optical adhesive), the incident surface 40 is generally configured as a planar surface. To ensure the integrity of the entire module (e.g., a regular cylinder) during subsequent packaging, the exit surface 50 is also conventionally designed to be planar. Research of the present disclosure finds that, subject to product design requirements such as miniaturization, lightweight and compatibility with existing eyeglasses, the dimensions of the incident surface, the first reflecting surface, the second reflecting surface, the exit surface and the like cannot be arbitrarily increased. In this case, the optical module is limited to a small size within a fixed range, for example, less than 5 mm×5 mm×5 mm or even smaller. In the present disclosure, the conventional planar incident surface and exit surface are changed into one or a combination of an aspherical surface, a spherical surface, a freeform surface, with the structural configuration of each surface fully redesigned. This allows image light L emitted by the microdisplay 80 to enter through the non-planar incident surface 40. The incident surface 40 is configured as one of an aspherical surface, a spherical surface, a freeform surface, or a combination thereof. The light from the microdisplay 80′ to the first reflecting surface 20′ enters the base body 10′ to reach the first reflecting surface 20′, is reflected to the second reflecting surface 30, and exits the base body 10′ through the non-planar exit surface 50. The exit surface 50 is also configured as one of an aspherical surface, a spherical surface, a freeform surface, or a combination thereof. Light L emitted from the edge or a near-edge position of the microdisplay 80 (FIG. 67) can converge toward the optical axis more easily, while light from the edge or a near-edge position of the microdisplay 80 cannot converge toward the optical axis with conventional planar incident and exit surfaces. This effectively improves the utilization rate of light at the edge or the near-edge positon of the microdisplay 80, effectively reduces optical loss and enhances the optical efficiency. In addition, light in the related art is not easy to converge toward the optical axis, resulting in a smaller field of view. However, some embodiments of the present disclosure make full use of the light L from the center and the edge to effectively expand the field of view. On the other hand, the folded optical path greatly reduces the overall size of the optical system, making the entire module more portable. The shorter reflection path reduces light loss and effectively improves the light efficiency, resulting in better overall display quality.

In some embodiments, the transverse dimension of the annular side surface 60 tends to decrease along the direction of a line connecting the second reflecting surface 30 to the exiting surface 50, that is, the maximum outer contour dimension of the exit surface 50 may be smaller than that of the second reflecting surface 30. Such configuration ensures that light L entering from the edge of the incident surface 40 of the microdisplay 80 converges effectively toward the central optical axis Z, further expanding the field of view and optimizing image display quality.

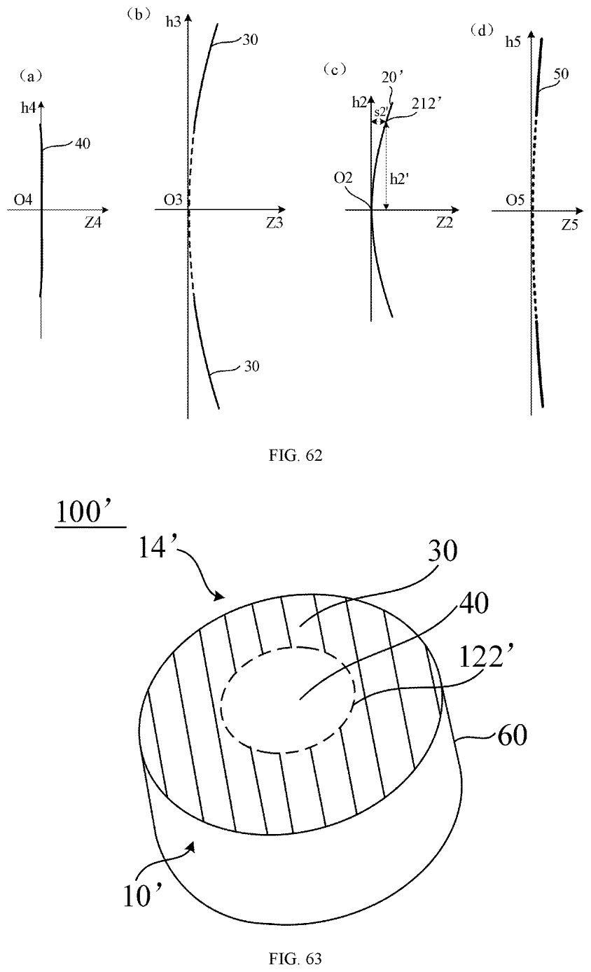

In some embodiments, referring to FIG. 62, each of the first reflecting surface 20′ and the second reflecting surface 30 is configured as one of an aspherical total internal reflection surface, a spherical total internal reflection surface, a freeform total internal reflection surface, or a combination thereof. It can be understood that such reflection arrangement can effectively reduce optical loss and improve optical efficiency and display quality. The incident surface 40 includes a first section and a second section from the center to the periphery. The first section curves toward a first direction of the optical axis Z. The first direction may be the positive direction of the optical axis Z (light exiting direction). The second section curves toward a second direction opposite to the first direction of the optical axis Z. The second direction may be the negative direction of the optical axis Z (opposite to the light exiting direction). The first reflecting surface 20′, the second reflecting surface 30 and the exit surface 50 curve toward the first direction of the optical axis Z, i.e., the positive direction of the optical axis Z. It can be understood that an area of the microdisplay 80 corresponding to the first section of the incident surface 40 corresponds to the center or near-center of the microdisplay 80. An area of the microdisplay 80 corresponding to the second section corresponds to the edge or near-edge area of the microdisplay 80 (relatively far from the center). Therefore, light from the edge or near-edge of the microdisplay 80 can be reflected as much as possible to the edge or near-edge of the first reflecting surface 20, further reflected by the first reflecting surface 20′ to the edge or near-edge of the second reflecting surface 30, and finally converged toward the center of the optical axis Z by the non-planar exit surface 50, effectively improving the light utilization rate of the edge or near-edge of the microdisplay 80 and enhancing the optical efficiency and display quality. The first reflecting surface 20′, the second reflecting surface 30, the exit surface 50 and the incident surface 40 may all be non-planar designs, such as an aspherical surface, a spherical surface, a freeform surface, or a combination thereof. Curvature directions of the first reflecting surface 20′, the second reflecting surface 30 and the exit surface 50 may be different. The first reflecting surface 20′, the second reflecting surface 30 and the exit surface 50 may be the same. As described in Table 1, the sagittal heights of the first reflecting surface 20′, the second reflecting surface 30 and the exit surface 50 are positive. The sagittal heights of the incident surface 40 are positive within the range of 0 to 0.6 mm and negative within the range of 0.65 to 0.85 mm, indicating that the incident surface 40 first curves toward the positive direction of the optical axis and then curves toward the negative direction of the optical axis. Combined with the design of other optical surfaces, such configuration can effectively expand the field of view of exit light, improve optical efficiency and achieve superior image quality.

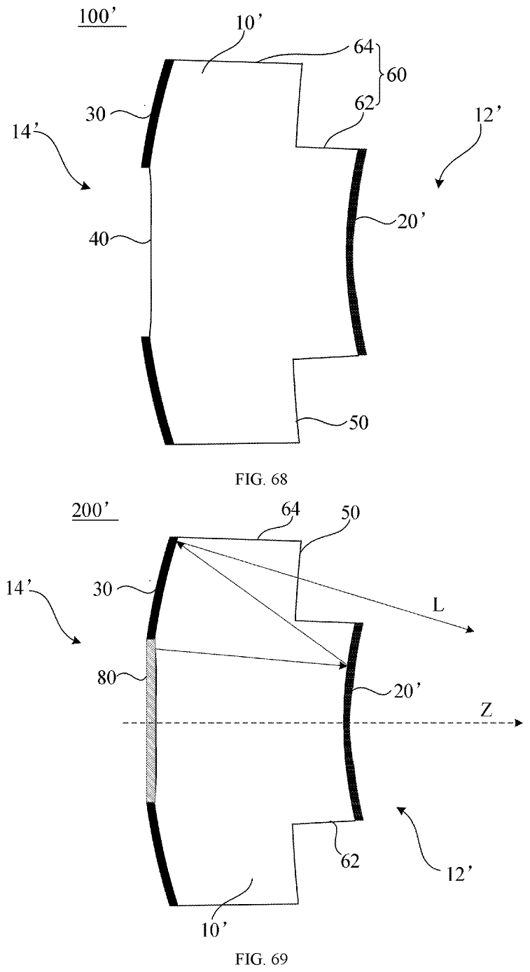

In some embodiments, the second reflecting surface 30, the exit surface 50, the incident surface 40 and the first reflecting surface 20′ each have a projected contour shape on a plane perpendicular to the optical axis Z. The contour shape may be a circle, an ellipse, a polygon, a rounded rectangle, a trapezoid or other geometric figures. The plane perpendicular to the optical axis Z may be, for example, a cross section, or a plane corresponding to a top view or a bottom view viewed from the first end 12′ or the second end 14′. The contour shapes of the incident surface 40 and the first reflecting surface 20′ may be similar to each other. The contour shapes of the second reflecting surface 30 and the exit surface 50 may be similar to each other. In other embodiments, as shown in FIG. 68, the contour shape of the incident surface 40 may be similar to that of the second reflecting surface 30. The contour shape of the exit surface 50 may be similar to that of the first reflecting surface 20′, for example, both being regular polygons, etc. It can be understood that the geometry of the outer contour of each relevant surface can be flexibly designed according to the outer contour of the microdisplay 80 or the overall structure to meet assembly requirements of different sizes and shapes and fully obtain light from the microdisplay 80. On the other hand, the second reflecting surface 30, the exit surface 50, the incident surface 40 and the first reflecting surface 20′ may all be the same, for example, all of them are a circle, an ellipse or a regular polygon, so that light from the microdisplay 80 can be fully reflected and utilized to achieve optimal display quality and light output efficiency.

In some embodiments, referring to FIG. 60 and FIG. 62 to FIG. 64, the first reflecting surface 20′ includes a first vertex O2, the second reflecting surface 30 includes a second vertex O3, the incident surface 40 includes a third vertex O4, and the exit surface 50 includes a fourth vertex O5. The first vertex O2, the second vertex O3, the third vertex O4 and the fourth vertex O5 are located on the optical axis Z. The incident surface 40, the first reflecting surface 20′, the second reflecting surface 30 and the exit surface 50 are symmetrically designed with respect to the cross section of the optical axis, so as to ensure that the optical module 100′ is free from eccentricity, that is, no optical path area on one side is excessively larger or smaller than that on the other side. It can be understood that the second vertex O3 may be a point where the curved surface of the second reflecting surface 30 is extended relative to the center of the incident surface 40 and finally intersects. In FIG. 62(b), the dashed line indicates that its extension towards the center intersects to form the second vertex Q3. Similarly, the fourth vertex O5 may be a point where the curved surface of the exit surface 50 is extended relative to the center of the first reflecting surface 20′ and finally intersects. In FIG. 62(d), the dashed line indicates that its extension towards the center intersects to form the fourth vertex O5. It is understandable that the vertices of the second reflecting surface 30, the exit surface 50, the incident surface 40 and the first reflecting surface 20′ are all located on the same optical axis Z, which can ensure the overall optical path symmetry. The second reflecting surface 30, the exit surface 50, the incident surface 40 and the first reflecting surface 20′ may be symmetrically designed with respect to the optical axis Z, or the above surfaces may be symmetrically designed with respect to a plane passing through the optical axis Z. The second reflecting surface 30, the exit surface 50, the incident surface 40 and the first reflecting surface 20′ are coaxially designed, which can ensure that the entire optical path does not deviate (such as deviation from the optical axis Z), and achieve clearer display and higher display quality.

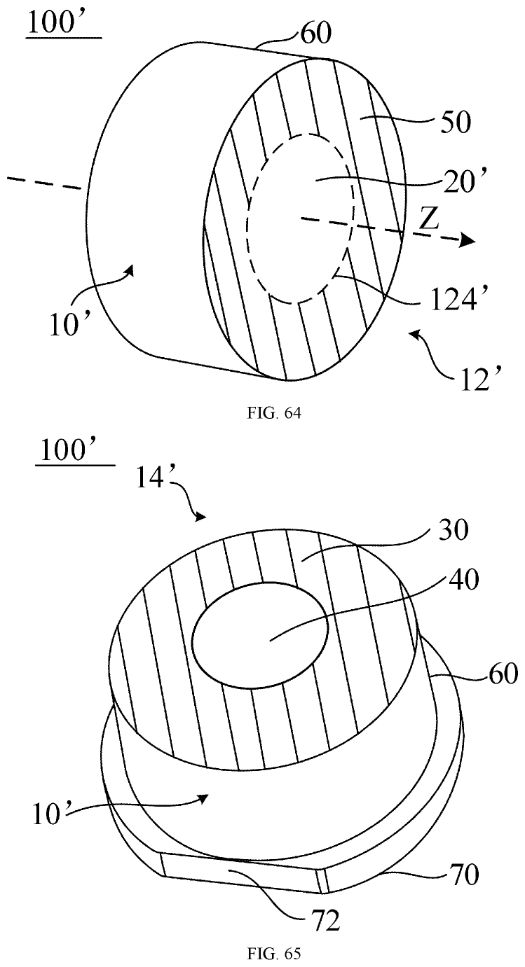

In some embodiments, referring to FIG. 60, FIG. 63 and FIG. 64, the incident surface 40 intersects the second reflecting surface 30 at a first intersection line 122′, and the exit surface 50 intersects the first reflecting surface 20′ at a second intersection line 124′. The first intersection line 122′ and the second intersection line 124′ refer to intersection boundaries of different surfaces, which are indicated by dashed lines in the drawings for ease of understanding. The shape of each intersection line may be determined by the outer contour shapes of the incident surface 40 and the first reflecting surface 20′, or by the inner contour shape of the second reflecting surface 30 or the inner contour shape of the exit surface 50. For example, the intersection lines 122′ and 124′ may be circular, elliptical, polygonal or the like in shape. The incident surface 40 and the first reflecting surface 20′ may also be circular, elliptical, polygonal or the like in shape. In some embodiments, the distance between the first vertex O2 and the third vertex O4 is no greater than 2.8 mm, which is the central thickness of the optical module 100′. For example, the center thickness along the optical axis Z is no greater than 2.8 mm, such as 2.8 mm, 2.5 mm, 2 mm, 1.8 mm, 1.6 mm and the like. In other embodiments, the thickness may also be understood as the average thickness between the exit surface 50 and the incident surface 40, or the average thickness of the entire base body 10′, etc. The distance from the first intersection line 122′ to a connecting line between the second vertex O3 and the third vertex O4 is no greater than 1.35 mm, i.e., the radius of the incident surface 40 is no greater than 1.35 mm, and may be 1.35 mm, 1.2 mm, 1 mm, 0.8 mm, 0.6 mm and the like. The distance from the second intersection line 124′ to a connecting line between the first vertex O2 and the fourth vertex O5 is no greater than 1.5 mm. For example, the radius of the first reflecting surface 20′ is no greater than 1.5 mm, such as 1.5 mm, 1.3 mm, 1 mm, 0.85 mm, 0.75 mm and the like. In some embodiments, the respective radii (perpendicular distance from the outer contour to the vertex) of the annular side surface 60, the exit surface 50 and the second reflecting surface 30 may be each no greater than 3 mm. That is, the radius of the annular side surface 60 is not greater than 3 mm, the radius of the exit surface 50 is not greater than 3 mm, and the radius of the second reflective surface 30 is not greater than 3 mm. For example, each may be 3 mm, 2.8 mm, 2.5 mm, 2 mm and the like. The distance from the second intersection line 124′ to the edge of the exit surface 50 may have the same value in the circumferential direction. For example, the width value of the exit surface 50 is consistent along the circumferential direction of the first reflecting surface 20′. The distance from the second intersection line 124′ to the edge of the exit surface 50 is greater than 0 and no more than 1.6 mm. For example, it may be 1 mm, 1.5 mm, 0.8 mm, 0.7 mm and the like. It can be understood that the above parameters shall not contradict each other when combined. The aforementioned radius may refer to the radius parameter when the projected shape of each surface on a certain plane is circular. In other embodiments, when the projected shape is non-circular, such as a regular polygon, an ellipse or other regular figures, the radius may be defined as its maximum radius. For example, taking an ellipse as an example, its long side can be understood as the aforementioned radius. The dimensional design of the embodiments of the present disclosure enables the entire optical module to achieve smaller volume and lighter weight without affecting optical transmission efficiency, facilitates adaptation to the frame or lens of existing near-eye display apparatus (such as myopia glasses, hyperopia glasses, protective glasses, sports glasses, smart glasses and helmets), avoids major structural modifications to existing display apparatus, realizes compatibility between augmented display and conventional display devices, and improves the portability of the optical module and enrich the application scenarios.

In some embodiments, as shown in FIG. 73, light from the microdisplay passes through the optical module, enters the pupil of the eyeball 300, and reaches the retina to form an image 310. The positional and structural relationship of related components in FIG. 73 (such as the eyeball 300 and the image 310) is merely an exemplary schematic for calculation and understanding. The following calculation process can be performed in one dimension with some approximations, such as small-angle approximation, so as to illustrate various principles. The small-angle approximation is: θ≈sin θ~tan θ. The above calculation can be directly extended to two dimensions for more accurate calculations. The field of view (FOV) can be ultimately displayed onto the human eye/retina by the optical module. From the retinal side, based on the etendue (E_{eye}) calculation formula:

$${E}_{eye} = \int {\int }_{θ , I} {n}_{eye}^{2} cos θ d θ dI \leq {n}_{eye}^{2} {I}_{eye} {θ}_{eye} = {n}_{eye}^{2} {I}_{eye} \frac{min \{ {D}_{p} , {D}_{m} \}}{{D}_{eye}} = {n}_{eye}^{2} FOV {f}_{eye} \frac{min \{ {D}_{p} , {D}_{m} \}}{{D}_{eye}} ; \qquad \{ 1 \}$$

In some embodiments, based on the derivation of the above Formula {1}, the lower limit of the field of view (FOV) can be obtained as:

$$FOV \geq ( \int {\int }_{θ , I} cos θ d θ dI ) \frac{{D}_{eye}}{{f}_{eye} min \{ {D}_{p} , {D}_{m} \}} , \qquad \{ 2 \}$$

$$where , \frac{- {θ}_{eye}}{2} \leq θ \leq \frac{{θ}_{eye}}{2} , 0 \leq I \leq {I}_{eye} ;$$

From the optical module side, based on the etendue(E_{eye}) calculation formula:

$${E}_{eye} = {\int \int }_{{θ}_{eye} , I} {n}_{eye}^{2} cos θ d θ dI \leq {n}_{eye}^{2} {I}_{eye} max \{ {θ}_{eye} \} = {n}_{eye}^{2} FOV {f}_{eye} \frac{min \{ {D}_{p} , {D}_{m} \}}{{D}_{eye}} \leq {E}_{m} = {\int \int }_{{θ}_{m} = 0 , S = 0}^{{θ}_{m} = max \{ {θ}_{m} \} S = {S}_{1}} {n}_{m}^{2} cos θ d θ {dS}_{1} \leq {n}_{m}^{2} {S}_{1} max \{ {θ}_{m} \} = {n}_{m}^{2} {S}_{1} {S}_{2} / {L}_{m} ; \qquad \{ 3 \}$$

In some embodiments, based on the derivation of the above Formula {3}, the upper limit of the field of view (FOV) can be obtained as:

$$FOV \leq \frac{{D}_{eye} {n}_{m}^{2} {S}_{1} {S}_{2}}{{f}_{eye} min \{ {D}_{p} , {D}_{m} \} {n}_{eye}^{2} {L}_{m}} \qquad \{ 4 \}$$

In the above formulas, FOV is the field of view angle, n_{eye} is the refractive index of the eyeball, Dₚ is the pupil diameter, θ_{eye} is the angle at which a point on the retina receives light, I_{eye} is the size of the image 310 formed on the retina, D_{eye} is the diameter of the eyeball, f_{eye} is the focal length of the eyeball, θₘ is the effective exit angle of the microdisplay, Dm is the maximum outer diameter of the optical module (i.e., the maximum outer diameter among the annular side surface 60, the exit surface 50 and the second reflecting surface 30), S₁ is the diameter of the incident surface 40 (i.e., twice the distance from the first intersection line 122′ to the connecting line between the second vertex O3 and the third vertex O4), S₂ is the diameter of the first reflecting surface 20′ (i.e., twice the distance from the second intersection line 124′ to the connecting line between the first vertex O2 and the fourth vertex O5), and Lₘ is the thickness of the base body 10′, which may also be the central thickness along the optical axis, the average thickness of the base body 10′, or the average optical thickness from the microdisplay to the first reflecting surface 20′.

It can be understood that the upper limit of the field of view is mostly determined by the parameters of the optical module. In practical design, the size of the optical module is usually strictly limited (or fixed). For example, the optical module is of a compact size and compatible with conventional head-mounted devices. Therefore, the achievable lower limit of the field of view is more important and can be designed according to actual requirements. In the formula for calculating the lower limit of the field of view (FOV), the first term represents the double integral of the angle over the display size, which exists implicitly in the optical module design. The incident surface 40 and the exit surface 50 are configured as non-planar surfaces. Each non-planar surface may be one of an aspherical surface, a spherical surface, a freeform surface, or a combination thereof. The non-planar surface can increase the value of the double integral, thereby improving the lower limit (i.e., minimum value) of the field of view of the optical module. It is evident that when related parameters such as the size, eyeball parameters are constrained, the field of view is difficult to change within the limited size. Therefore, the present disclosure changes the shape of the incident surface 40 and the exit surface 50, changing the conventional planar design to a non-planar design, so that light from the relative edge of the microdisplay can enter the first reflecting surface 20′ and be projected out of the base body 10′ through the exit surface 50. Effectively, light from the edge of the microdisplay is fully utilized, and projected light with a larger angle relative to the optical axis Z can be formed, thereby achieving a wider field of view, higher optical efficiency and better display quality.

In some embodiments, the aspherical surface, the spherical surface and the freeform surface of the incident surface 40, the first reflecting surface 20′, the second reflecting surface 30 and the exit surface 50 can be described by a polynomial sag equation, which may be calculated using Zernike polynomials. The polynomial sagittal height (sag) equation is expressed as:

$$Z = \frac{{ch}^{2}}{1 + \sqrt{1 + ( 1 + k ) {c}^{2} {h}^{2}}} + {Ah}^{4} + {Bh}^{6} + {Ch}^{8} + {Dh}^{10} ,$$

where

Z is the surface sag, i.e., the distance from the vertex (e.g., s2′ in FIG. 62c); h is the radial distance (the distance from the curved surface to the optical axis, e.g., h2′ in 3c); c is the curvature of the curved surface; k is a coefficient; and A, B, C and D respectively are corresponding high-order coefficients. When k, A, B, C and D are zero, the equation serves as a sag formula for a spherical surface. For a freeform surface, analytical expression fitting can be performed by taking a plurality of reference points. FIG. 62 is a schematic diagram showing the contour of each related surface. FIG. 62(a) is a schematic diagram showing the contour of the incident surface 40. FIG. 62(b) is a schematic diagram showing the contour of the second reflecting surface 30. FIG. 62(c) is a schematic diagram showing the contour of the first reflecting surface 20′. FIG. 62(d) is a schematic diagram showing the contour of the exit surface 50. Taking the contour of the first reflecting surface 20′ in FIG. 62(c) as an example, the first reflecting surface 20′ is provided with a vertex O2 and curves about two orthogonal axes (e.g., the h-Z axis in the figure). The first reflecting surface 20′ has at least one first position 212′ with a radial distance h1 from the Z-axis (optical axis) passing through the vertex O2, and a displacement s2′ relative to the h-axis at the vertex O2. Table 1 below describes some of relevant parameters of some surfaces (some are selected as examples), where h4-Z4 correspond to the parameters of the incident surface 40, h2-Z2 correspond to parameters of the first reflecting surface 20′, h3-Z3 correspond to the parameters of the second reflecting surface 30, and h5-Z5 correspond to the parameters of the exit surface 50.

TABLE 1

| h4 | h2 | h3 | h5 | Z4 | Z2 | Z3 | Z5 |
|---|---|---|---|---|---|---|---|
| 0.3 | 0.3 | 0.3 | 0.3 | 0.001774 | 0.011664 | 0.007824 | 0.002036 |
| 0.6 | 0.6 | 0.6 | 0.6 | 0.000062 | 0.045580 | 0.031323 | 0.008255 |
| 0.70 | 0.70 | 0.70 | 0.70 | −0.005514 | 0.061351 | 0.042651 | 0.011308 |
| 0.80 | 0.80 | 0.80 | 0.80 | −0.016306 | 0.079112 | 0.055734 | 0.014881 |
| — | — | 1.2 | 1.2 | — | — | 0.125726 | 0.034835 |
| — | — | 1.5 | 1.5 | — | — | 0.196975 | 0.056573 |
| — | — | 1.8 | 1.8 | — | — | 0.284581 | 0.085106 |

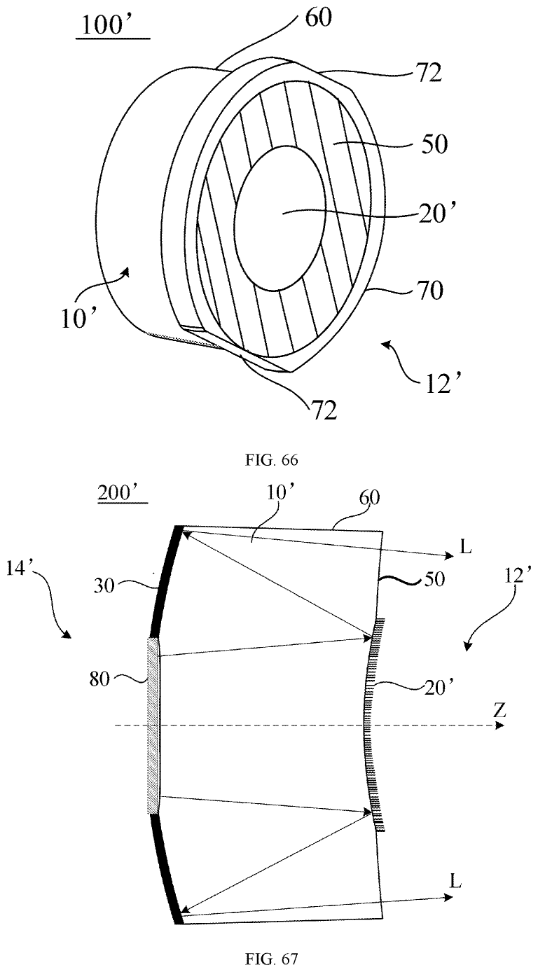

In some embodiments, referring to FIG. 65 to FIG. 66, the optical module further includes an outer rim 70 provided on the annular side surface 60. The height of the outer rim 70 may be greater than that of the annular side surface 60. The outer rim 70 may be a continuous full-circle structure or an intermittently arranged structure in the circumferential direction. The extension of the outer rim 70 along the optical axis Z may not exceed the annular side surface 60, that is, the thickness of the outer rim 70 may be no greater than the height of the annular side surface 60. Thus, the outer rim 70 may be configured as a thin protruding structure, or may be provided with threads or other snapping structures. In some embodiments, the outer rim 70 is located at an end adjacent to the exit surface 50 and configured to be assembled with an external mechanism. The external mechanism may be a clamp, a fixture or the like, facilitating clamping and transportation of the optical module while avoiding damage to the base body 10′ or other optical surfaces. Alternatively, the external mechanism may be a housing for mounting the optical module, which is provided with a fixing groove, and the optical module can be positioned or fixed via the outer rim 70.

In some embodiments, referring to FIG. 65 to FIG. 66, the outer rim 70 is further provided with at least one straight edge 72. For example, when the outer rim 70 is circular, the straight edge 72 may be tangent to the outer rim 70. In other embodiments, the outer rim 70 may be provided with two mutually parallel straight edges 72 or more straight edges. When the outer rim itself is polygonal, the straight side of the polygon may serve as a straight edge 72. The straight edge 72 is configured to cooperate with an external mechanism to position and adjust the rotational angle of the base body 10′. It can be understood that the external mechanism may be a clamp or a fixture, and mutually parallel straight edges facilitate positioning and clamping of the base body 10′. In other embodiments, the external mechanism may be, for example, a mounting housing. Sometimes it is necessary to rotate the entire optical module in the mounting housing, for example, to adjust the light exit angle of the optical module. In this case, the straight edges 72 can serve the functions of foolproof positioning and locating.

In some embodiments, as shown in FIG. 61, the optical module may further include a light shielding layer 66 covering the annular side surface 60. The light shielding layer 66 is configured to block light from the microdisplay 80 from transmitting to the outside of the base body 10′ through the annular side surface 60. The light shielding layer 66 may be a coating or material such as black epoxy resin, black silicone rubber, carbon black, nickel black, black chromium or vantablack, or may be an opaque sealing sleeve. The light shielding layer 66 ensures that light exits the base body 10′ only through the exit surface 50 rather than the annular side surface 60, thereby effectively improving optical efficiency.

In some embodiments, referring to FIG. 68 to FIG. 71, the annular side surface 60 further includes a first annular surface 62 and a second annular surface 64. The circumferential dimension of the first annular surface 62 is smaller than that of the second annular surface 64. A first end of the first annular surface 62 is connected to the first reflecting surface 20′. A second end of the first annular surface 62 is connected to a first end of the exit surface 50. A second end of the exit surface 50 is connected to a first end of the second annular surface 64. A second end of the second annular surface 64 is connected to the second reflecting surface 30. The first end and the second end of the first annular surface 62 are opposite ends, and the first end and the second end of the second annular surface 64 are opposite ends. It can be understood that the exit surface 50 is located between the first annular surface 62 and the second annular surface 64 with different dimensional sizes. In some embodiments, the first annular surface 62 and the second annular surface 64 may have a gradually decreasing trend along the positive direction of the optical axis Z, thereby achieving effective light convergence. It can be understood that there is a large difference in transverse dimensions between the first annular surface 62 and the second annular surface 64, a stepped structure is formed, which further reduces the overall size and weight.

In some embodiments, referring to FIG. 70, the light shielding layer 66 located on the second annular surface 64 extends from the edge of the exit surface 50 in a direction far away from the exit surface 50. An end face of the light shielding layer 66 on the second annular surface 64 is not higher than an end face of the first reflecting surface 20′. The light shielding layer 66 arranged on the second annular surface 64 is sufficiently long to prevent light from prematurely exiting to the outside from the edge of the exit surface 50 and suppress the generation of stray light.

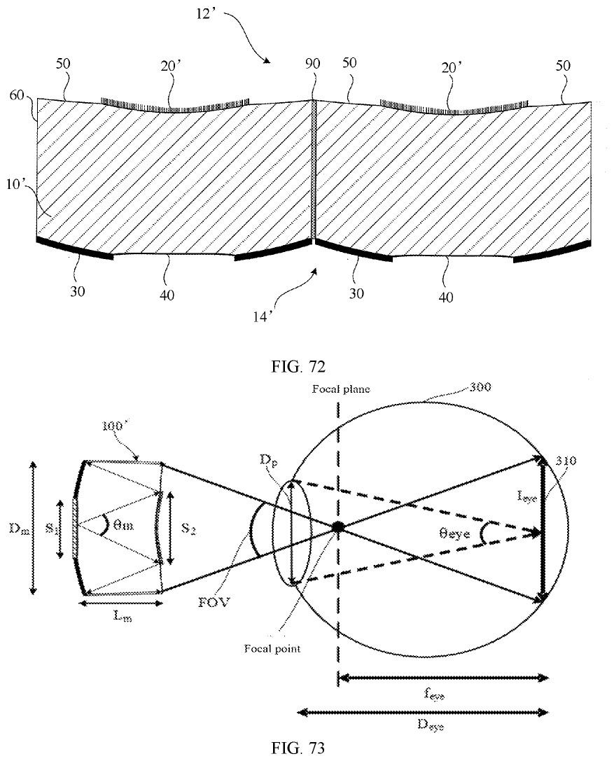

In some embodiments, as shown in FIG. 72, the optical module further includes a light extinction wall 90. The light extinction wall 90 may be made of an opaque material (the same material as the aforementioned light shielding layer 66) or a material capable of blocking light of a specific wavelength. Each of the base body 10′, the first reflecting surface 20′, the second reflecting surface 30 and the exit surface 50 is provided in at least two sets. The light extinction wall 90 is connected between two adjacent base bodies 10′, for example, located between the annular side surfaces 60 of two adjacent optical modules. The light extinction wall 90 is configured to block light from one base body 10′ from entering an adjacent base body 10′. It can be understood that in the two sets of optical modules, the adjacent base bodies 10′ are integrally connected. Each optical module is correspondingly provided with one microdisplay 80, that is, one microdisplay is disposed corresponding to a single incident surface. In other embodiments, one microdisplay may correspond to multiple incident surfaces 40. The height of the light extinction wall 90 is greater than or equal to the distance from the second reflecting surface 30 to the exit surface 50, so as to ensure that no optical crosstalk occurs between adjacent base bodies 10′, effectively reducing stray light.

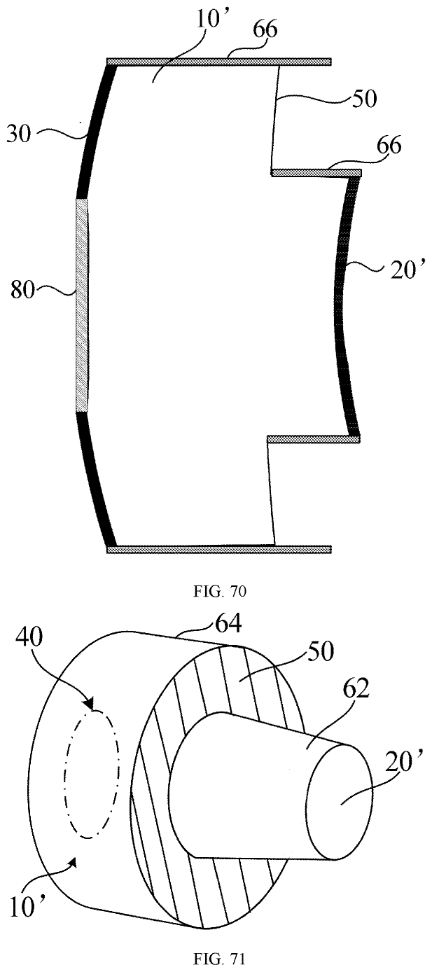

Some embodiments of the present disclosure further provide a near-eye display apparatus 200′. Referring to FIG. 67 and FIG. 69, the near-eye display apparatus 200′ includes:
a microdisplay 80; and
the optical module according to any of the foregoing embodiments. The microdisplay 80 is mounted on the incident surface 40.

In some embodiments, each of the above units or structures may be implemented as an independent entity, or arbitrarily combined and implemented as one or several entities. For specific implementation of the above units or structures, reference may be made to the foregoing embodiments, which will not be repeated herein. It can be understood that the near-eye display apparatus 200′ may further include, for example, a frame, a lens, a circuit board, a power supply, an infrared sensor, a gyroscope, a temperature sensor and(or) the like. Descriptions of components for installation or driving operation will not be repeated herein.

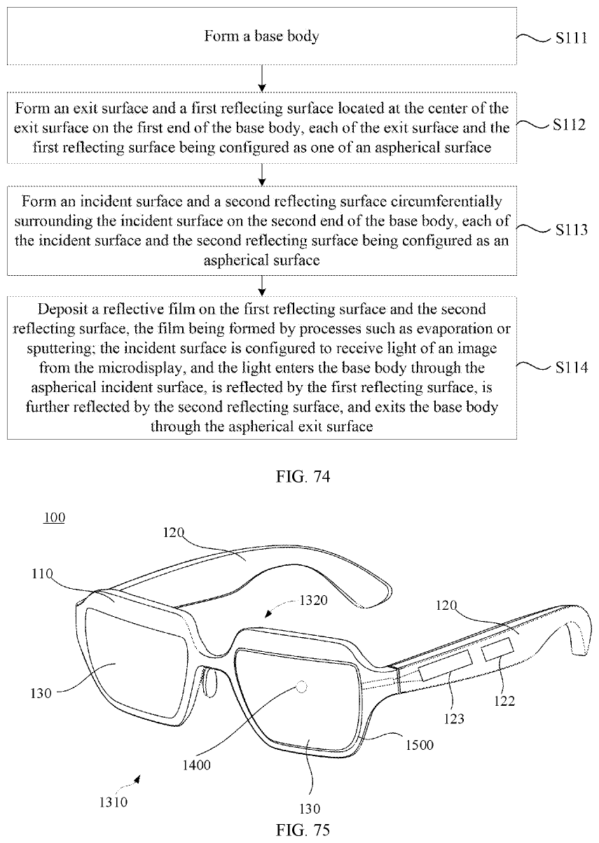

Referring to FIG. 74, some embodiments of the present disclosure further provide a manufacturing method for an optical module. The optical module is the optical module according to the foregoing embodiments. The manufacturing method includes the following steps.

S111: Form a base body 10′. The base body 10′ may be formed by cutting, injection molding or compression molding.

S112: Form an exit surface 50 and a first reflecting surface 20′ located at the center of the exit surface 50 on the first end 12′ of the base body 10′. Each of the exit surface 50 and the first reflecting surface 20′ is configured as one of a spherical surface, an aspherical surface, a freeform surface, or a combination thereof.

S113: Form an incident surface 40 and a second reflecting surface 30 circumferentially surrounding the incident surface 40 on the second end 14′ of the base body. Each of the incident surface 40 and the second reflecting surface 30 is configured as one of a spherical surface, an aspherical surface, a freeform surface, or a combination thereof. The first end and the second end are opposite ends. It can be understood that the corresponding spherical surface, aspherical surface and freeform surface may also be formed by cutting, injection molding, compression molding or other processes.

S114: Deposit a reflective film on the first reflecting surface 20′ and the second reflecting surface 30. The film can be formed by processes such as evaporation or sputtering. The incident surface 40 is configured to receive light of an image from the microdisplay 80. The light enters the base body 10′ through the aspherical incident surface 40, is reflected by the first reflecting surface 20′, is further reflected by the second reflecting surface 30, and exits the base body 10′ through the aspherical exit surface 50. For other descriptions of the optical module, reference may be made to the foregoing embodiments, which will not be repeated herein.

Conventional near-eye display devices generally adopt optical solutions such as optical waveguides or prisms. The light source (or image source) and part of optical structures of such solutions are mostly arranged on the temple of the wearer's temples. In addition, optical solutions such as waveguides have special requirements for lenses, resulting in relatively large volume and weight and poor long-term use experience for a user. Moreover, the display area of the display module of these devices is fixed in position. When the display device needs to move freely or to a specific position in the display state, power supply becomes a difficult problem, since wired electrical connection will interfere with the movement of the display module due to the physical presence of wires.

Please refer to FIG. 75, which is an overall structural schematic diagram showing a near-eye display device according to an embodiment of the present disclosure. It should be noted that the electronic device (near-eye display device) in an embodiment of the present disclosure may be the structure and form of smart glasses including AR, VR, XR, MR and other types. The near-eye display device 100 includes an frame body 110, a temple 120 and a lens 130. The temples 120 are connected to the frame body 110, and the frame body 110 is configured to fix the lens 130. The lens is applicable to myopia glasses, hyperopia glasses, protective glasses, sunglasses, smart glasses, helmets and the like. Relevant features are within the understanding of those skilled in the art and will not be repeated herein.

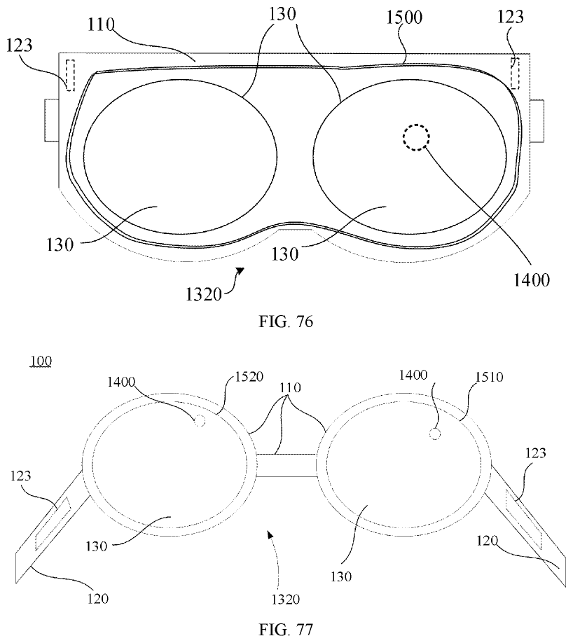

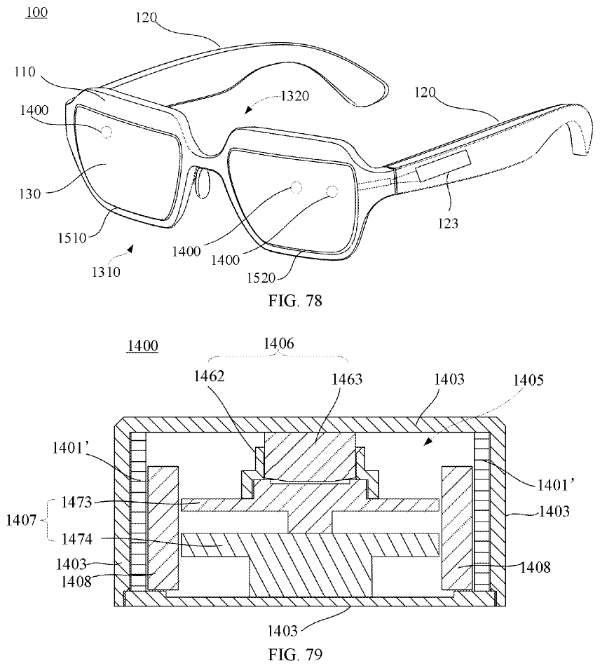

Optionally, please refer to FIG. 76 to FIG. 79. FIG. 76 is a schematic overall structural schematic diagram showing a near-eye display device without a temple according to an embodiment. FIG. 77 is a schematic diagram of the embodiment in FIG. 75 from another perspective. FIG. 78 is a schematic overall structural schematic diagram where a plurality of display modules and a plurality of first coils are provided. FIG. 79 is a schematic cross-sectional structural schematic diagram of an embodiment in which the display module is provided with a coil bracket. The near-eye display device 100 includes a lens 130 and a display module 1400. The lens 130 has an eye side 1320 and an environment side 1310. The display module 1400 is configured to generate light and project the light toward the eye side 1320. The first battery 123 is spaced apart from the display module 1400. A first coil 1500 is arranged around the lens 130. The first coil 1500 surrounds the lens 130 and is electrically connected to the first battery 123. The first coil 1500 forms at least one loop for electromagnetic induction with a second coil 1401′ described in following embodiments. The display module 1400 is detachably mounted at any position on the surface of the lens 130. The display module 1400 is configured to be movable to any position on the surface of the lens 130. A user may move the display module 1400 to any position on the surface of the lens 130 as needed. The display module 1400 is configured to display information and is provided with the second coil 1401′. The second coil 1401′ can be configured to achieve electromagnetic induction with the first coil 1500. For example, the first coil 1500 serves as a transmitting end to convert an electric field into a magnetic field, and the second coil 1401′ serves as a receiving end to convert the magnetic field into an electric field. The size of a loop formed by the second coil 1401′ is smaller than the size of a loop formed by the first coil 1500. It can be understood that the above induction is configured such that wireless induction between the first coil 1500 and the second coil 1401′ enables the first battery 123 to supply power to the display module 1400 when the display module 1400 moves on the lens 130 or is fixed at any preset position on the lens 130. Since the first coil 1500 is arranged surrounding the lens 130, the display module can move freely on the surface of the lens 130 and be fixed at an appropriate viewing position selected by the user. Wireless power supply via electromagnetic induction between the first coil 1500 and the second coil 1401′ is achieved during the movement or at a fixed position of the display module 1400. In some embodiments, the preset area may be an inner ring area of the lens 130 surrounded by the first coil 1500. In other embodiments, the preset area may also be an outer ring area of the lens 130 surrounded by the first coil 1500. The user may freely move and select the position of the preset area as needed. The arbitrary fixed position refers to a certain or arbitrary fixed position where the display module stays after being moved by the user, which may be determined according to user operation or field of view requirements. For example, the position where the lens aligns with the center of the eye's field of view is usually an optimal position. When the user needs to view the real physical world on the environment side 1310, the user may move the display module 1400 far away from the center of the field of view, or even to a position in the blind area of the eye's field of view on the lens 130. At this time, the display module 1400 may be located on the first coil 1500 or on the outer ring of the first coil 1500.

Optionally, in some embodiments, the display module 1400 may be disposed on the lens 130 by clamping, adsorption or other means. In this case, the display module 1400 is movable relative to the lens 130. In other embodiments, the display module 1400 may be fixed to the lens 130 in other manners. Any implementation that enables the display module 1400 to be detachably mounted, fixed and movably disposed at any position on the lens 130 shall fall within the scope of the present disclosure, and no specific limitation is made herein.

Optionally, referring to FIG. 75 to FIG. 77, the first coil 1500 surrounds the lens 130. In some embodiments, the first coil 1500 may be embedded in the outer edge of the lens 130. Optionally, the first coil 1500 may be wound around the outer edge of the lens 130. Optionally, the first coil 1500 may be disposed on the frame body 110 and surround the lens 130. In other embodiments, the first coil 1500 may surround the lens 130 in other ways. Optionally, the first coil 1500 may be located on the side facing the environment side 1310, such as in a groove or on a surface of the frame body 110 facing the environment side. Optionally, the first coil 1500 may be disposed on the side facing the eye side 1320, such as in a groove or on a surface of the frame body 110 facing the eye side 1320. The drawings only illustrate some examples. In other embodiments, those skilled in the art may adjust the position of the first coil 1500 as needed. Any configuration that allows the induced current of the first coil 1500 to form a loop surrounding the lens 130, performs electromagnetic induction with the second coil 1401′, and enables the display module 1400 to be powered and operate at any position on the surface of the lens 130 is encompassed by the present disclosure, with no specific limitation made herein.

Referring to FIG. 75, the near-eye display device 100 is further provided with a first electrical input interface 122. At least one of the first coil 1500 and the first battery 123 is electrically connected to the first electrical input interface 122. The first electrical input interface 122 can directly supply power to the first coil 1500 and the first battery 123. Optionally, the first coil 1500 is electrically connected to the first electrical input interface 122. Optionally, the first battery 123 is electrically connected to the first electrical input interface 122. Optionally, both the first coil 1500 and the first battery 123 may be electrically connected to the first electrical input interface 122. Optionally, the first electrical input interface 122 may be a Micro-USB interface. Optionally, the first electrical input interface 122 may be a Lightning interface. Optionally, the first electrical input interface 122 may be a Type-C interface.

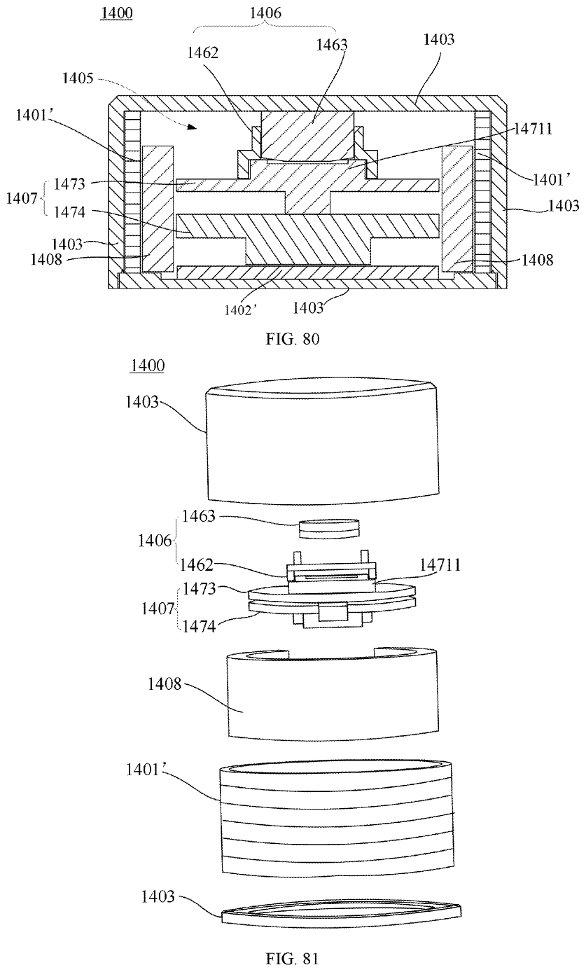

Optionally, referring to FIG. 79 to FIG. 81, FIG. 80 is a schematic diagram the display module in an embodiment of FIG. 79 provided with a second battery. FIG. 81 is an exploded structural schematic diagram showing the display module in the embodiment of FIG. 79. Optionally, the display module 1400 further includes a housing 1403, an optical assembly 1406 and a display unit 1407. The optical assembly 1406 is located at a light output end of the display unit 1407, and the second coil 1401′ is electrically connected to the display unit 1407. The housing 1403 is provided with an accommodating cavity 1405. The optical assembly 1406, the display unit 1407 and the second coil 1401′ are disposed in the accommodating cavity 1405.

Optionally, in some embodiments, the display module 1400 may be columnar, such as a cylinder or a prism. In other embodiments, the display module 1400 may be other irregular shapes, without specific limitation herein. The drawings only take a cylindrical display module as an example, and those skilled in the art may select and adjust the shape as needed in other embodiments. The cross-sectional dimension of the display module 1400 is far smaller than the surface dimension of the lens 130. Optionally, the maximum cross-sectional dimension of the housing 1403 is no more than 12 mm, and the maximum cross-sectional dimension enclosed by the second coil 1401′ is no more than 11 mm. Specifically, the maximum cross-sectional dimension of the display module 1400 may be no more than 12 mm. Optionally, the cross-sectional dimension may be 10 mm, 9 mm, 8 mm, 6 mm, 5 mm or 3 mm. The specific definition of the cross-sectional dimension is related to the cross-sectional shape. For example, for a circular cross section, the cross-sectional dimension refers to the diameter. For a square cross section, the cross-sectional dimension refers to the side length. For a rectangular cross section, the cross-sectional dimension refers to the length of the long side. The cross-sectional size of the display module 1400 is much smaller than the surface size of the lens 130, so that the display module 1400 occupies a small area on the surface of the lens 130, does not block the user's vision or interfere with viewing, and improves user experience.

The display module 1400 is provided with the second coil 1401′, which may be arranged circumferentially around the display module 1400. Optionally, in some embodiments, the first coil 1500 serves as a power transmitting end, and the second coil 1401′ serves as a power receiving end. The second coil 1401′ can generate electromagnetic induction with the first coil 1500 to achieve wireless power supply to the display module 1400, so that the display module 1400 can operate normally with power at any position on the surface of the lens 130. Optionally, in some embodiments, the temple 120 may be further provided with a control circuit electrically connected to the first battery 123. The control circuit converts direct current of the first battery 123 into alternating current and transmits the alternating current to the first coil 1500 to generate magnetic induction. The second coil 1401′ generates alternating current upon receiving the magnetic induction. The display module 1400 may further include a rectifier circuit for converting alternating current into direct current. The display module 1400 may further include a conversion circuit for converting the direct current into a voltage or current suitable for operating the display module 1400. Such circuit configurations are within the understanding of those skilled in the art and will not be elaborated herein.

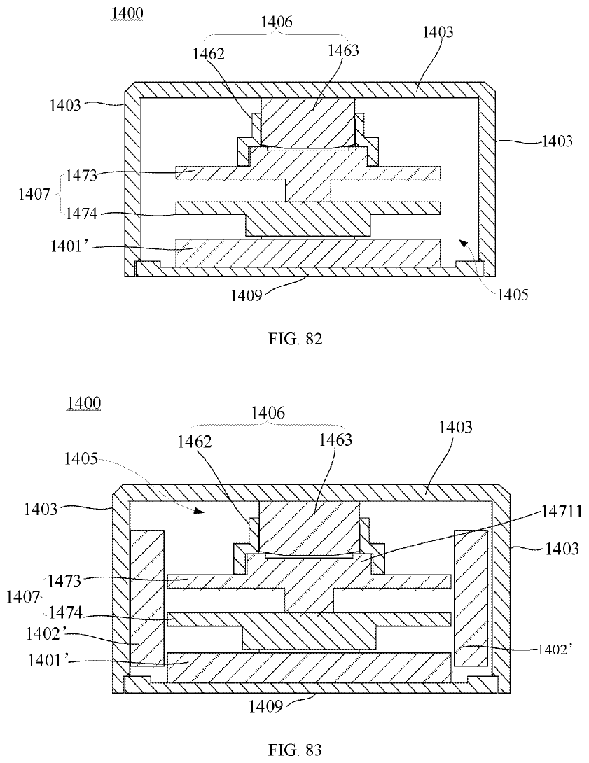

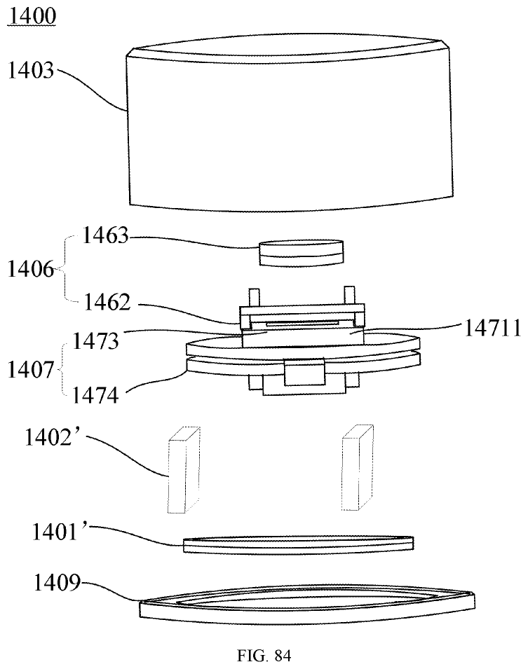

Referring to FIG. 79 to FIG. 84, FIG. 82 is a schematic cross-sectional structural schematic diagram showing a display module according to another embodiment. FIG. 83 is a schematic diagram showing the display module in the embodiment of FIG. 82 provided with a second battery. FIG. 84 is an exploded structural schematic diagram showing the display module in the embodiment of FIG. 83. Optionally, the display unit 1407 includes a display board 1473 and a circuit board 1474 which are electrically connected. In some embodiments, the display board 1473 and the circuit board 1474 may be connected by a plug-in connection. Optionally, the display board 1473 and the circuit board 1474 may be connected by an electrical wire. Optionally, the display board 1473 and the circuit board 1474 may be connected by contact connection. The circuit board 1474 may be an independent circuit board or an external circuit board integrated around the display unit 1407. For example, the circuit board 1474 may be a plug-in board, a driver board or a power supply board. Only partial embodiments are listed herein, and those skilled in the art may make selection and adjustment according to actual requirements. The second coil 1401′ is electrically connected to the circuit board 1474. The display board 1473 is provided with a display 14711 for generating light, which may be located at the middle portion of the display board 1473. The optical assembly 1406 includes an optical module 1463 and a bracket 1462. The bracket 1462 is configured to support and fix the optical module 1463. The optical module 1463 is located at a light output end of the display 14711. The bracket 1462 and the optical module 1463 are located on a side of the display board 1473 far away from the circuit board 1474. The bracket 1462 ensures that the optical module 1463 corresponds to the light output end of the display 14711.

Optionally, referring to FIG. 75 to FIG. 78, there may be at least one first battery 123. Referring to FIG. 75 and FIG. 78, there may be one first battery 123 mounted on either one of temples 120. Optionally, referring to FIG. 77, there may be two first batteries 123 mounted on two temples 120 respectively. Optionally, referring to FIG. 76, two first batteries 123 may be mounted on the frame body 110. Optionally, one first battery 123 may be mounted on one temple 120, and the other first battery 123 may be mounted on the frame body 110. Optionally, one first battery 123 may be mounted on the frame body 110. The drawings merely illustrate partial exemplary mounting positions of the first battery 123. In other embodiments, those skilled in the art may select and adjust the mounting position as needed, and no specific limitation is made herein.

Optionally, in some embodiments, the first battery 123 may be a rechargeable battery. Optionally, the first battery 123 may be charged via an interface or wireless charging. In other embodiments, the first battery 123 may be a disposable replaceable battery. The first battery 123 may be sized to fit the shape of the frame body 110 or the temple 120. Optionally, The first battery 123 may be a single-cell structure, a multi-cell structure, a lithium battery, or the like. Those skilled in the art may select and configure the type as needed, and no specific limitation is imposed herein.

Optionally, referring to FIG. 75 to FIG. 78, the number of the display module 1400 may be one. In an embodiment with a single display module 1400, the display module 1400 may be mounted on any one lens 130. Optionally, the first coil 1500 may only surround the lens 130 where the display module 1400 is disposed. In embodiments with a plurality of display modules 1400, the plurality of display modules 1400 are configured to move within the first coil (150) of the lens 130. The multiple display modules 1400 are detachably mounted on at least one lens 130 and capable of operating independently. The term “a plurality” refers to at least two, such as two, three or four. Optionally, all of the multiple display modules 1400 may all be mounted on any lens 130. Optionally, the multiple display modules 1400 may be mounted on the two lenses 130 respectively. The drawings only show some examples of the display modules on the lens surface. In other embodiments, those skilled in the art may make selections and adjustments according to actual needs, without specific limitation. Optionally, when a plurality of display modules 1400 require the same power, the second coils 1401′ of the plurality of display modules 1400 may be configured with the same number of turns. Optionally, when a plurality of display modules 1400 require different power, the second coils 1401′ may be configured with different numbers of turns. The number of turns of each second coil 1401′ can be set according to the power consumption of the corresponding display module to adapt to different display modules.

Optionally, the near-eye display device 100 may include two lenses 130, each lens 130 corresponding to the field of view of an eye. The first coil 1500 may surround both lenses 130 simultaneously, and the display module 1400 is configured to move within an inner loop of the first coil 1500. Optionally, the lenses are applicable to myopia glasses, hyperopia glasses, sunglasses, smart glasses and the like. Related configurations are well understood by those skilled in the art, thus will not be elaborated further herein.

Optionally, the near-eye display device 100 may include only one lens 130 spanning the field of view of both eyes. The first coil 1500 surrounds the lens 130 and spans the field of view of both eyes. The display module 1400 is configured to move either within an inner loop or an outer loop of the first coil 1500. Optionally, the lens is applicable to protective glasses, helmets and the like. Related configurations are well understood by those skilled in the art, thus will not be elaborated further herein.

Optionally, the first coil 1500 surrounds at least one lens 130. Optionally, referring to FIG. 75, the first coil 1500 surrounds only the single lens 130 equipped with the display module 1400. Optionally, referring to FIG. 76, the first coil 1500 surrounds two lenses 130.

Optionally, the first coil 1500 surrounds at least one lens 130. Optionally, referring to FIG. 77 and FIG. 78, the first coil 1500 includes a first sub-coil 1510 and a second sub-coil 1520. The first sub-coil 1510 and the second sub-coil 1520 each independently surround one corresponding lens 130 to form a loop. In some embodiments, the first sub-coil 1510 and the second sub-coil 1520 may be configured with the same or different numbers of turns. In some embodiments, the first sub-coil 1510 and the second sub-coil 1520 are electrically isolated to avoid mutual crosstalk. In other embodiments, the first sub-coil 1510 and the second sub-coil 1520 may be electrically connected in series or in parallel. Optionally, the first sub-coil 1510 and the second sub-coil 1520 may be respectively electrically connected to the first battery 123 mounted on the two temples 120. Optionally, the first sub-coil 1510 and the second sub-coil 1520 may be respectively electrically connected to two first batteries 123 mounted on the frame body 110. Optionally, the first sub-coil 1510 may be electrically connected to the first battery 123 mounted on one temple 120 while the second sub-coil 1520 is electrically connected to the first battery 123 mounted on the frame body 110. Optionally, the second sub-coil 1520 may be electrically connected to the first battery 123 mounted on the temple 120, and the first sub-coil 1510 is electrically connected to the first battery 123 mounted on the frame body 110. Optionally, the first sub-coil 1510 and the second sub-coil 1520 may also be electrically connected and electrically connected to the same first battery 123 mounted on one temple 120. Optionally, the first sub-coil 1510 and the second sub-coil 1520 may be electrically connected together and electrically connected to the same first battery 123 mounted on the frame body 110.

Optionally, the number of turns of the first coil 1500 may be one turn or multiple turns, and the number of turns of the second coil 1401′ may also be one turn or multiple turns. The number of coil turns can be determined according to the power required by the display module 1400, and such features are well understood by those skilled in the art, thus will not be elaborated further herein.

Optionally, the first sub-coil 1510 and the second sub-coil 1520 may be configured with the same number of turns to provide identical power output. Optionally, the first sub-coil 1510 and the second sub-coil 1520 may be configured with different numbers of turns to provide different power output. The number of turns may be selected according to the power required by the display module 1400 and the number of the display modules 1400, Such features are within the understanding of those skilled in the art and will not be elaborated further herein.

Optionally, referring to FIG. 79 to FIG. 81, the display module 1400 may further include a coil bracket 1408. The housing 1403 is provided with an accommodating cavity 1405. The optical assembly 1406, the display unit 1407, the coil bracket 1408 and the second coil 1401′ are disposed in the accommodating cavity 1405. The second coil 1401′ is electrically connected to the display unit 1407 and disposed on the outer periphery of the coil bracket 1408. The second coil 1401′ surrounds in the height direction from the display unit 1407 to the optical assembly 1406. Specifically, the second coil 1401′ may be arranged in the thickness direction of the display module 1400. Optionally, the height of the coil bracket 1408 at least partially overlaps with the sum of the total height of the bracket 1462, the display board 1473 and the circuit board 1474. The surrounding height of the second coil 1401′ is greater than the overall distance covering the display board 1473, the circuit board 1474 and the spacing between them, so that the second coil 1401′ can be configured with more turns to provide higher output power. Optionally, the number of coil turns can be determined according to the power requirement of the display module 1400. The number of turns of the coil determines the height of the second coil 1401′ and the coil bracket 1408 in the thickness direction of the display module 1400. When the display module 1400 requires high power, i.e., when the number of turns of the second coil 1401′ is large, the coil bracket 1408 may fully surround the display unit 1407 and the optical assembly 1406. When the power requirement is relatively low, i.e., when the number of turns of the second coil 1401′ is low, the coil bracket 1408 may fully surround the display unit 1407 while partially surrounding the optical assembly 1406, or only fully surround the display unit 1407. When the power requirement is even lower, i.e., when the number of turns of the second coil 1401′ is even lower, the coil bracket 1408 may only partially surround the display unit 1407. Optionally, the coil bracket 1408 may partially surround the optical assembly 1406, or fully surround the optical assembly 1406, or fully surround the optical assembly 1406 while partially surrounding the display unit 1407, or fully surround both the optical assembly 1406 and the display unit 1407. The surrounding structure and the full or partial surrounding manner of the coil bracket 1408 are determined by the number of turns of the second coil 1401′. The number of turns is determined by the power demand of the display module 1400. Such features are within the understanding of those skilled in the art and will not be elaborated further herein. Only partial embodiments are listed here, and the drawings merely illustrate the case where the second coil partially surrounds the display unit 1407 and fully surrounds the optical assembly 1406. In other embodiments, those skilled in the art may make selections and adjustments as needed without specific limitation.

The coil bracket 1408 and the second coil 1401′ are disposed circumferentially around the display unit 1407 and/or the optical assembly 1406, which makes full use of the circumferential space and makes the height of the display module 1400 in the thickness direction relatively small. Meanwhile, the circumferential arrangement allows flexible adjustment of coil turns according to the power required by the display module 1400, providing multiple power options for the power of the display module 1400.

Referring to FIG. 80, the display module 1400 may further be provided with a second battery 1402′. The second coil 1401′ is electrically connected to the second battery 1402′ to charge the second battery 1402′ and further supply power to the display module 1400, ensuring that the display module 1400 can operate independently powered by the second battery 1402′ when wireless coil power supply is unavailable. Optionally, the second battery 1402′ is disposed in the accommodating cavity 1405 and located at an end adjacent to the housing 1403 along the thickness direction of the display unit 1407.

Optionally, referring to FIG. 82 to FIG. 84, the display module 1400 further includes a housing 1403, an optical assembly 1406, a display unit 1407 and a cover plate 1409. In some embodiments, the housing 1403 and the cover plate 1409 together form an accommodating cavity 1405. In other embodiments, it can be understood that the cover plate 1409 may be integrally formed with the housing 1403, or configured as two separate components assembled together. Optionally, the cover plate may be located on the environment side 1310 or the eye side 1320. The optical assembly 1406, the display unit 1407 and the second coil 1401′ are disposed in the accommodating cavity 1405. The second coil 1401′ is formed in a flat shape. The second coil 1401′ is disposed on a side of the circuit board 1474 far away from the display board 1473. The second coil 1401′ is arranged parallel to the circuit board 1474. The second coil 1401′ is electrically connected to the display unit 1407.

The flat-shaped second coil 1401′ is disposed in a flat shape on the side of the circuit board 1474 facing away from the display board 1473, which reduces the height of the display module 1400 in the thickness direction and enables a thinner profile of the display module 1400. Meanwhile, the cross-sectional size of the display module 1400 is reduced, so that the display module 1400 occupies a small area on the surface of the lens 130, does not block the user's vision or interfere with normal viewing, and improves user experience.

Referring to FIG. 83, the display module 1400 may also be provided with a second battery 1402′. The second coil 1401′ is electrically connected to the second battery 1402′ to charge the second battery 1402′ and supply power to the display module 1400, ensuring that the display module 1400 can be powered by the second battery 1402′ when there is no coil power supply. The second battery 1402′ is disposed in the accommodating cavity 1405. For example, the second battery 1402′ may be located on one side of the display unit 1407, on one side of the optical assembly 1406, or on one side of both the optical assembly 1406 and the display unit 1407. The height of the second battery 1402′ in the thickness direction of the display module 1400 may at least partially overlap the thickness of the display module 1400. FIG. 83 to FIG. 84 only show simple examples of the second battery 1402′. Electrical connection part and other related structures and other basic components are within the scope of understanding for those skilled in the art and will not be described in detail herein. In other embodiments, the shape and position of the second battery can be selected and adjusted as needed.

The second battery 1402′ may be disposed on the side of the display unit 1407 and/or the optical assembly 1406, or disposed at an end of the display unit 1407 adjacent to the housing 1403 in the thickness direction. Arrangement on the side makes full use of circumferential space, so that the height of the display module 1400 in the thickness direction is relatively small. Arrangement on the end face can reduce the circumferential width.

Optionally, the circuit board 1474 may be provided with a rectifier circuit for converting alternating current into direct current. The circuit board 1474 may be provided with a conversion circuit for converting direct current into a voltage or current suitable for the display 14711 to operate. Such features are within the understanding of those skilled in the art and will not be elaborated further herein.

Optionally, the display 14711 may adopt, but is not limited to, Micro Light-Emitting Diode (Micro-LED), Micro Organic Light-Emitting Diode (Micro-OLED), Liquid Crystal On Silicon (LCoS), Liquid Crystal Display (LCD), Digital Micromirror Device (DMD)/Digital Light Processing (DLP), Laser Beam Scanning (LBS), or any combination thereof.

Optionally, in some embodiments, the light output end of the housing 1403 may be made of a light-transmissive material. In other embodiments, the light output end of the housing 1403 may be provided with a hollow hole for light transmission. Only partial embodiments are listed herein. In other embodiments, those skilled in the art may make selections and adjustments as needed without specific limitation.

Optionally, at least one of the first coil 1500 and the second coil 1401′ is made of a transparent conductive material. Optionally, the first coil 1500 is made of a transparent conductive material. Optionally, the second coil 1401′ is made of a transparent conductive material. Optionally, both the first coil 1500 and the second coil 1401′ may be made of a transparent conductive material. Optionally, the transparent conductive material may be an oxide-based transparent conductive material, such as zinc oxide, tin oxide, indium tin oxide and the like. Oxide-based transparent conductive materials are currently the most widely used, which have light transmittance and high electrical conductivity. Optionally, the transparent conductive material may be a carbon nanotube transparent conductive material, such as carbon nanotubes. Carbon nanotube transparent conductive materials are a new type of material with high conductivity, high transparency, high strength, and excellent flexibility. Optionally, the transparent conductive material may be a conductive polymer material. Conductive polymers are composed of conductive polymer, which have good electrical conductivity and flexibility. The coil uses a transparent conductive material, which not only meets the requirement of wireless electromagnetic induction between the first coil 1500 and the second coil 1401′ to supply power to the display module 1400, but also allows the coils to be integrated with the transparent lens 130, improving the appearance performance of the near-eye display device 100.

In the near-eye display device provided by embodiments of the present disclosure, the display module can generate light and project the light toward the user's eye side and is freely movable on the lens. The first coil is disposed circumferentially on the lens, and the second coil is disposed on the display module to achieve mutual electromagnetic induction. The size of a loop formed by the second coil is smaller than the size of a loop formed by the first coil, thereby effectively reducing the impact of the coils on the field of view of the lens. The first battery supplies power to the display module when the display module moves on the lens or is fixed at a preset position in a preset area of the lens, ensuring the display module can be powered and operate whether in a moving state or a fixed state, effectively avoiding interference between wired power supply and the free movement of the display module.

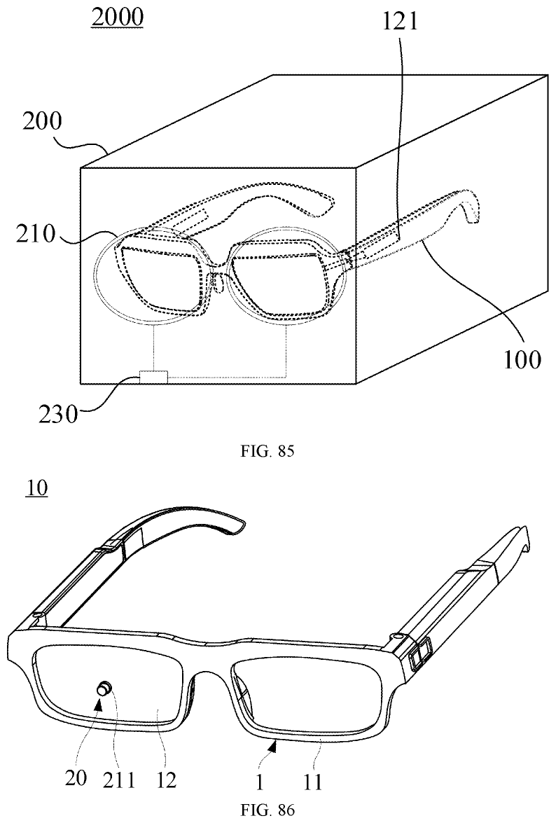

Please refer to FIG. 85, which is an overall structural schematic diagram showing a charging box according to an embodiment. A charging box 2000 provided by an embodiment of the present disclosure is configured to charge the first battery 123 of the near-eye display device 100 according to any one of the foregoing embodiments. The charging box 2000 includes a box body 200 and the near-eye display device 100 according to any one of the foregoing embodiments. The box body 200 includes a third coil 210 and a second electrical input interface 230, and the second electrical input interface 230 is electrically connected to the third coil 210. Optionally, the first coil 1500 can also serve as a power receiving end, and the third coil 210 serves as a power transmitting end. The first coil 1500 and the third coil 210 are configured to achieve wireless electromagnetic induction to charge the first battery 123 via the second electrical input interface 230. The second electrical input interface 230 may be a Micro-USB interface, a Lightning interface, or a Type-C interface.

For the charging box provided by the embodiments of the present disclosure, the first coil serves as a power receiving end to achieve wireless induction with the third coil to charge the first battery, which improves the flexibility, convenience and versatility of the charging box and further enhances user experience. Meanwhile, frequent plugging and unplugging of the charging cable is avoided, so that damage to the charging port of the near-eye display device is prevented, the interface of the near-eye display device is protected, and the service life of the near-eye display device is extended.

A near-eye display apparatus can convert display information into images and project the images into the eyes of a viewer to realize an immersive display experience. The display information can be transmitted to the near-eye display apparatus by an external terminal. In the related art, when a near-eye display apparatus is communicatively connected to an external terminal to transmit display information, the transmission bandwidth is limited, resulting in a small transmission data stream and causing insufficient display smoothness and display delay of the near-eye display apparatus.

Embodiments of the present disclosure provide a near-eye display system. Please refer to FIG. 97. A near-eye display system 1000 includes a near-eye display apparatus 10 and a terminal 6. The near-eye display apparatus 10 is communicatively connected to the terminal 6. The terminal 6 is configured to transmit display information to the near-eye display apparatus 10. The display information may include videos, images, texts and other contents. Exemplarily, the terminal 6 may be a mobile phone, a watch, a computer or other electronic devices. The near-eye display apparatus 10 is configured to convert the display information into optical output and project the optical output toward a user for viewing. The optical output may be light. The communication connection between the near-eye display apparatus 10 and the terminal 6 may be a wired connection via a data cable or a wireless connection without a data cable. In contrast, the wireless connection eliminates the need of data cables, freeing the near-eye display system 1000 from the constraints of data cables and improving the use convenience of the near-eye display system 1000.

Optionally, the communication connection between the near-eye display apparatus 10 and the terminal 6 is a WiFi connection. The WiFi connection has relatively large bandwidth and high data transmission speed, which makes the display of the near-eye display apparatus 10 smoother. Although the WiFi connection can guarantee data transmission speed, the WiFi connection between near-eye display device 10 and terminal 6 relies on an external wireless network. In some application scenarios of the near-eye display system 1000, wireless network coverage may be unavailable, such as when using the near-eye display system 1000 for outdoor sports. To ensure normal operation of the near-eye display system 1000 in scenarios without wireless network coverage, the communication connection between the near-eye display apparatus 10 and the terminal 6 may further be other short-range wireless communication modes in addition to the WiFi connection, such as one or more of Bluetooth, ZigBee and 2.4G. In the aforementioned short-range wireless connection modes, the bandwidth is relatively narrow, and the data transmission speed is limited, which may cause display stuttering, insufficient display smoothness, display delay and other defects of the near-eye display apparatus. Therefore, it has become an urgent challenge to be addressed to provide a near-eye display apparatus capable of realizing smooth display and reducing display delay.

Please refer to FIG. 86. The near-eye display apparatus 10 includes a wearing assembly 1 and a display assembly 20. The wearing assembly 1 is wearable by a user, for example, worn on the head. Exemplarily, the wearing assembly 1 may be glasses, a helmet or the like. The wearing assembly 1 includes a frame body 11, and a lens 12 is mounted on the frame body 11. When the wearing assembly 1 is glasses, the frame body 11 is a frame; when the wearing assembly 1 is a helmet, the frame body 11 is a helmet shell. The lens 12 may be a lens for myopia glasses, hyperopia glasses, protective glasses, sunglasses and fashion glasses, or a lens for a head-mounted device such as a helmet. A user can observe the external environment side through the lens 12 from the eye side.

The display assembly 20 is configured to be movably disposed on the lens 12. Optionally, the display assembly 20 is rotatably connected to the frame body 11 via a bracket (not shown in the figure). The bracket may be a temple or other component. The display assembly 20 may be moved on the lens 12 directly by a user's finger 40. Alternatively, the display assembly 20 is magnetically connected to the lens 12, which facilitates the movement of the display assembly 20 on the lens 12 and prevents the display assembly 20 from falling off the lens 12. In other embodiments, the display assembly 20 may be clamped onto the lens 12 in a clamping manner. Exemplarily, as shown in FIG. 17, the display assembly 20 is movable on the lens 12 in any direction indicated by D1 to D4. In some embodiments, when a user's finger touches the display assembly 20, the display assembly 20 may display interface prompts indicating movable directions such as D1 to D4, so as to facilitate user operation.

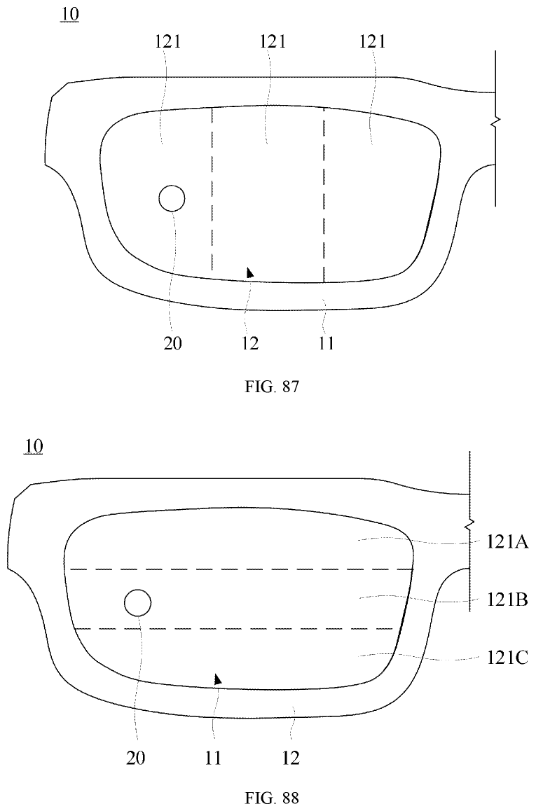

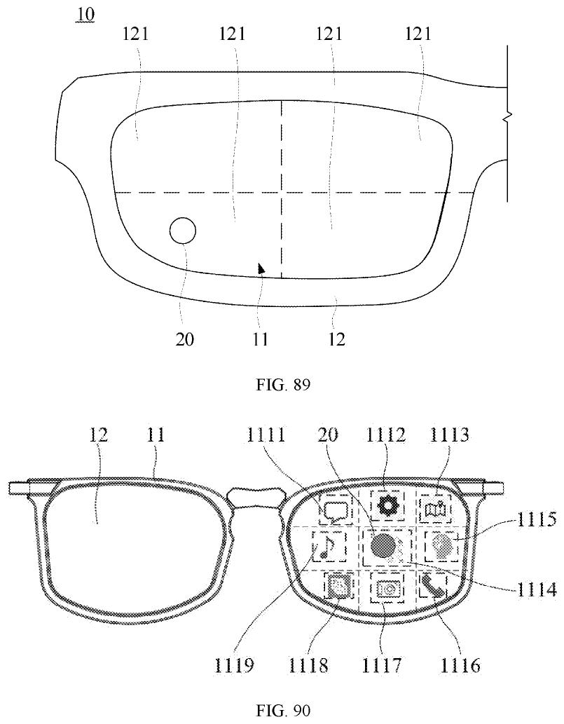

In an embodiment, as shown in FIG. 87 to FIG. 89, the lens 12 is provided with a plurality of movable areas 121, and each movable area 121 corresponds to display content of the external terminal 6. Exemplarily, as shown in FIG. 87, the plurality of movable areas 121 are distributed along the transverse direction of the lens 12. Exemplarily, as shown in FIG. 88, the plurality of movable areas 121 are distributed along the longitudinal direction of the lens 12. Exemplarily, as shown in FIG. 89, the plurality of movable areas 121 are distributed in both the transverse direction and longitudinal direction of the lens 12. In other embodiments, the movable areas 121 may be arranged in a square array, a circular array or other regular layouts. The foregoing embodiments merely illustrate partial optional arrangement manners of the movable areas 121, and the number and positional layout of the movable areas 121 may be other ways without specific limitation herein. Specifically, as shown in FIG. 88, the lens 12 includes a first movable area 121A, a second movable area 121B and a third movable area 121C. The first movable area 121A, the second movable area 121B and the third movable area 121C respectively correspond to the display content of navigation, translation and video application programs of the external terminal 6. Each movable area 121 is configured to correspond to the display content of the external terminal 6 itself, so that the movable area 121 corresponds to the display content of the external terminal 6 itself. Thus, the position of the display assembly 20 on the lens 12 can be changed by moving the display assembly 20 to a target movable area 121, thereby switching the display content of the display assembly 20 to the target display content of the external terminal 6. No additional operation on the external terminal 6 is required, enabling convenient and rapid switching of display content and improving the usability of the near-eye display apparatus 10.

In some embodiments, referring to FIG. 90, the lens 12 is provided with a plurality of movable areas 121. In an operating state, the display assembly 20 can display corresponding image content when located in the movable area 121. The display assembly 20 can present different functions or applications when located in different movable areas 121. Exemplarily, when the display assembly 20 is located in the movable area 121 at the middle position of the lens 12, the displayed function or application may be a main interface 1114. The upper position may be Settings 1112. The left and right sides of Settings 1112 may be Messages 1111 and Navigation 1113 respectively. The left and right sides of the main interface 1114 may be Music 1119 and Smart Assistant 1115. The lower side of the main interface 1114 may be Pictures 1117, and the left and right sides of Picture 1117 may be Translation 1118 and Dialing 1116 respectively Certainly, a user may reorder and customize the above functional interfaces on the terminal as needed, for example, by arranging them according to usage frequency or personal preferences. It can be understood that a storage unit 204 in the display assembly 20 stores first display information including the above functions or applications, and the first display information includes underlying image content of the function or application, such as a background image, background color, font color and the like corresponding to the functions or applications. In some embodiments, considering that full-color display of the display assembly 20 tends to cause high power consumption and impose strict requirements on the size and design of the optical module, the display assembly 20 may be configured to display only a single color such as green. Correspondingly, the storage unit 204 stores single-color font information or background image information. In some embodiments, a user's eyes can view content on the environment side through the movable areas 121 of the lens 12; that is, the movable areas 121 of the lens 12 contain no content that interferes with user viewing. FIG. 90 is merely for ease of illustration and understanding. When the display assembly 20 moves to different positions of the lens 12, the content that needs to be displayed on the display assembly 20 itself rather than on the movable area 121 of the lens 12. For example, when the display assembly 20 moves to the movable area 121 at the middle position, the display assembly 20 may display the main interface 1114. The main interface may include information such as time or weather. Of course, the main interface can also be customized by the user. When the display assembly 20 is located at the movable area 121 corresponding to the main interface, other movable areas 121 corresponding to Messages 1111, Settings 1112, Navigation 1113, Smart Assistant 1115, Dialing 1116, Pictures 1117 and Translation 1118 are not displayed, and the user cannot see corresponding static or dynamic content on the lens 12. That is, when the display assembly 20 is not moved to a corresponding movable area 121, function or application images of other movable areas 121 will not be displayed on the lens 12. Only when the user moves the display assembly 20 to the position of a corresponding movable area 121 can the image content of the function or application corresponding to such movable area 121 be displayed on the display assembly 20.

Referring to FIG. 87, in an embodiment, the size of the display assembly 20 is smaller than that of the lens 12. Optionally, the orthographic projection area of the display assembly 20 on the lens 12 is far smaller than the area of the lens 12. For example, the maximum orthographic projection area of the display assembly 20 on the lens 12 is no more than 6 mm². In some embodiments, the maximum outer diameter of the display assembly 20 may not exceed 15 mm, that is, the maximum outer diameter of the housing 211 described below is no more than 15 mm. For example, the maximum outer diameter of the housing 211 described may be 15 mm, 12 mm, 10 mm, 8.5 mm, 5 mm and the like. Such size design reduces the volume of the display assembly 20, which is convenient for the display assembly 20 to be adapted to the wearing assembly 1, and can also reduce the impact of the display assembly 20 on the field of view of the lens 12.

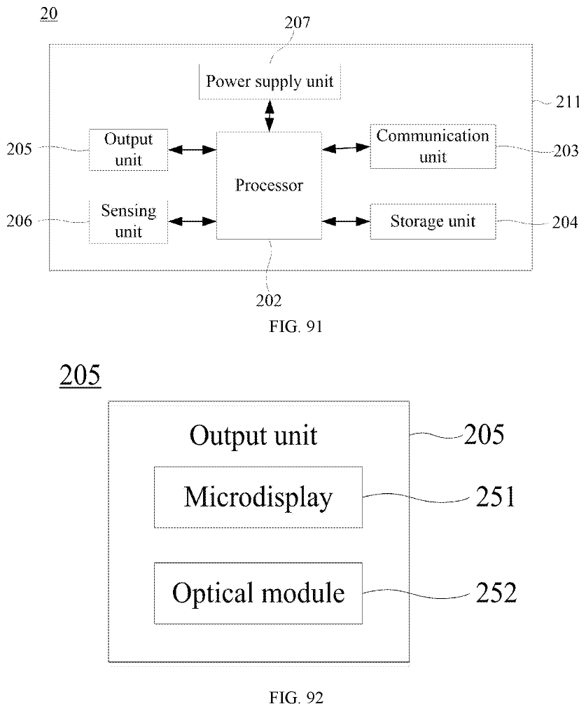

In an embodiment, as shown in FIG. 86, FIG. 91 and FIG. 94, the display assembly 20 includes a housing 211, and a processor 202, a communication unit 203, a storage unit 204, an output unit 205 and a sensing unit 206 disposed in the housing 211. The communication unit 203, the storage unit 204, the output unit 205 and the sensing unit 206 are each electrically connected to the processor 202. The processor 202, the communication unit 203 and the storage unit 204 may be disposed on a circuit board module 220. For example, the circuit board module 220 may include a first circuit board 221 and a second circuit board 222. The processor 202 and the communication unit 203 may be located on the first circuit board 221, and the storage unit 204 may be located on the second circuit board 222. In some embodiments, the first circuit board 221 and the second circuit board 222 may be arranged parallel to each other. The housing 211 is provided with an internal space for accommodating a component. The height of the housing 211 is no more than 20 mm. As shown in FIG. 94, the distance between a top portion of the housing 211 and the cover 212 may not exceed 20 mm, such as 18 mm, 15 mm, 12 mm or 10 mm. The maximum outer diameter of the housing 211 may not exceed 15 mm. Optionally, the processor 202, the communication unit 203, the storage unit 204, the output unit 205 and the sensing unit 206 are at least partially disposed in the housing 211, so that the housing 211 can provided protection for each component and reduce the risk of component damage. The display assembly 20 may further include a power supply unit 207 for supplying operating power to the display assembly 20. The power supply unit 207 may include a rechargeable battery. The power supply unit 207 can be reusable after multiple charging cycles. Compared with disposable power supplies, the power supply unit 207 is more energy-efficient and environmentally friendly.

The processor 202 may be an integrated circuit chip with signal processing capability. The processor 202 may also be implemented by a plurality of integrated circuit chips in combination. Exemplarily, the processor 202 may be a general-purpose processor, a Digital Signal Processor (DSP), an Application Specific Integrated Circuit (ASIC), a Field-Programmable Gate Array (FPGA), or other programmable logic device, discrete gate or transistor logic device, or discrete hardware component. The general-purpose processor may be a microprocessor.

The communication unit 203 includes one or more of the following: a Bluetooth communication module, a ZigBee communication module and a 2.4G communication module. The foregoing short-range wireless communication modules do not rely on an external wireless network, enabling the near-eye display system 1000 to operate normally in scenarios without wireless network coverage and improving the applicability of the near-eye display system 1000.

The storage unit 204 includes a readable storage medium. Specifically, the readable storage medium may be a hard disk, a read-only memory (ROM), a random access memory (RAM), a magnetic disk, an optical disc, a portable hard disk, a USB flash drive, or any other data storage medium. Optionally, the readable storage medium is built into the housing 211, so that the storage unit 204 and the housing 211 form an integrated structure, making it easy to carry, thus improving the usability of the near-eye display apparatus 10. Optionally, the readable storage medium may be detachably disposed on the housing 211, so that the volume of the storage unit 204 is not limited by the housing 211, thereby increasing the storage capacity of the storage unit 204.

Referring to FIG. 92 and FIG. 94, in an embodiment, the output unit 205 includes a microdisplay 251 and an optical module 252. Exemplarily, the microdisplay 251 and the optical module 252 are fixed via a fixing bracket 208. The fixing bracket 208 may include a first connecting portion (not shown in the figure) and a second connecting portion (not shown in the figure). The first connecting portion is provided with a first mounting portion, and the second connecting portion is provided with a second mounting portion. The first mounting portion is configured as a hole structure or a groove structure, and the second mounting portion is configured as a hole structure or a groove structure. The first mounting portion is in communication with the second mounting portion. In an embodiment, the first mounting portion adopts a groove structure, and the second mounting portion adopts a hole structure. The microdisplay 251 is mounted in the first mounting portion, and the optical module 252 is partially mounted in the second mounting portion. The microdisplay 251 is electrically connected to the processor 202. The optical module 252 is located on a light exit side of the microdisplay 251. The microdisplay 251 receives information from the processor 202 and converts the information into optical output. The optical module 252 receives the optical output and transmits it to the user side for the user to view.

The microdisplay 251 may adopt technologies such as Micro Light-Emitting Diode (Micro-LED), Micro Organic Light-Emitting Diode (Micro-OLED), Liquid Crystal On Silicon (LCoS), Liquid Crystal Display (LCD), Digital Micromirror Device (DMD)/Digital Light Processing (DLP), Laser Beam Scanning (LBS), or any combination thereof. The optical module 252 may be made of resin, glass or the like. The first circuit board 221, the second circuit board 222 and the microdisplay 251 may be arranged parallel to each other. The sensing unit 206 may be electrically connected to the circuit board module 220 and is arranged around the outer peripheries of the microdisplay 251 and the optical module 252. The display assembly 20 may further include a sleeve 214. The microdisplay 251 and the optical module 252 are disposed in the sleeve 214. The sleeve 214 may be made of opaque resin, metal or other materials, which can prevent external light from interfering with the optical signal emitted by the microdisplay 251 and avoid light leakage of the optical signal from the microdisplay 251.

In some embodiments, as shown in FIG. 94, the display assembly 20 further includes a cover 212 for closing an opening structure of the housing 211. The cover 212 may be mounted to the opening structure by threaded connection, snap-fit, interference fit or other manners. The cover 212 is provided with a groove 2121, and an attraction member 213 capable of being magnetically attracted is mounted in the groove 2121. The attraction member 213 may be magnetized or possess magnetic properties. The attraction member 213 may be made of magnetizable ferritic stainless steel or the like, or the attraction member 213 may be made directly of a magnet. The attraction member 213 may be a sheet-like structure. The attraction member 213 may be fixed in the groove 2121 by means of bonding or other fixing methods. The attraction member 213 is configured to magnetically attract with an external attraction member to assemble the display assembly 20 onto the wearing assembly 1. The external attraction member may be made of the same material as the attraction member 213, and the two can magnetically attract each other, so as to clamp and fix the display assembly 20 on the wearing assembly 1 such as the lens 12 or the frame body 11.

In some embodiments, as shown in FIG. 94, the power supply unit 207 includes a battery, which may be arc-shaped or annular. The power supply unit 207 is provided with a central accommodating cavity 271. The output unit 205 and the circuit board module 220 are located at the center of the central accommodating cavity 271. The battery surrounds the outer peripheries of the microdisplay 251 and the circuit board module 220. The axial direction of the microdisplay 251 and the optical module 252 is substantially parallel to the height direction of the power supply unit 207, achieving central alignment and facilitating assembly. The cross-sectional shape of the outer contour of includes an arc or annular shape, and the cross-section of the central accommodating cavity 271 perpendicular to the height direction of the power supply unit 207. The output unit 205 and the circuit board module 220 are sequentially arranged along the height direction of the power supply unit 207. In other embodiments, the power supply unit 207 may be a button cell, which may be arranged parallel to the circuit board module 220 or parallel to the attraction member 213. In further embodiments, when a button cell is adopted, the attraction member 213 may be omitted, and the button cell may be used directly as the power supply unit 207 to magnetically attract external magnets or other attraction members.

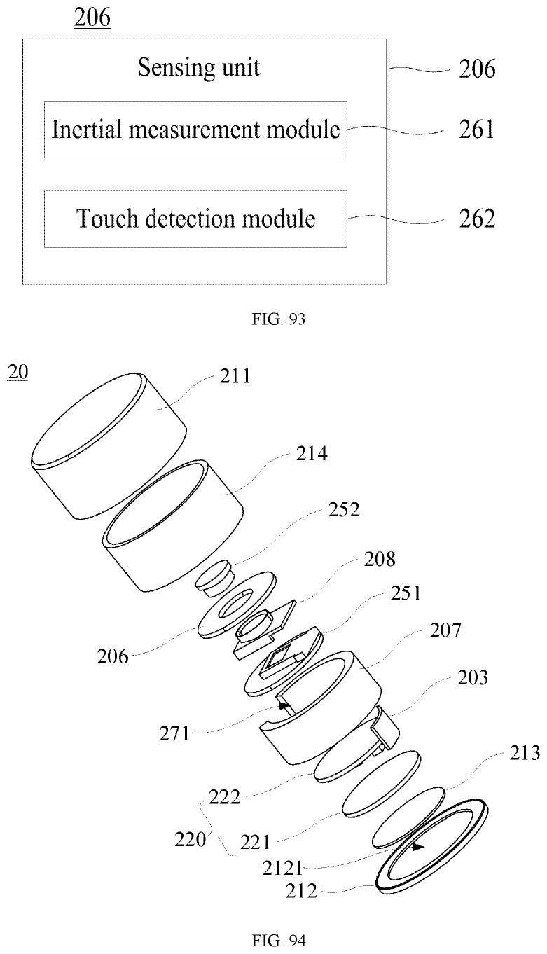

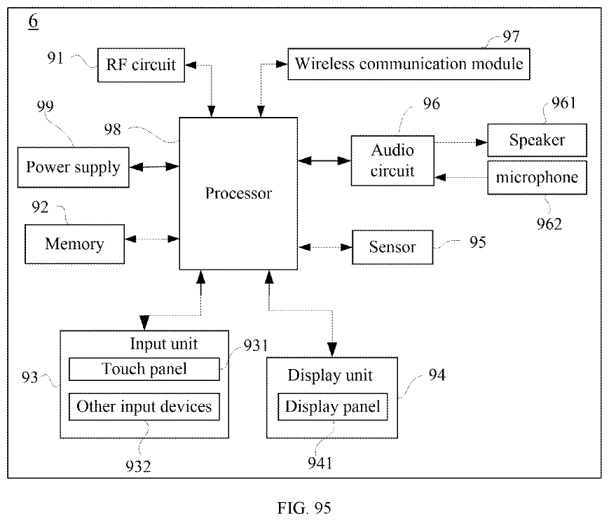

In an embodiment, as shown in FIG. 93, the sensing unit 206 includes an inertial measurement module 261 electrically connected to the processor 202. The inertial measurement module 261 may be located on the first circuit board 221. The inertial measurement module 261 is configured to obtain movement information of the display assembly 20 relative to the lens 12. The processor 202 obtains the movement information from the inertial measurement module 261 and transmits the movement information to the external terminal 6 via the communication unit 203. The movement information may be one or a combination of movement parameters such as movement speed, acceleration, displacement, displacement component in a preset direction, or rotation angle. After obtaining the movement information transmitted by the communication unit 203, the external terminal 6 may determine the position of the movable area 121 of the display assembly 20 on the lens 12 according to the movement information, so as to transmit display content corresponding to the movable area 121 of the external terminal 6 to the near-eye display apparatus 10. For example, as shown in FIG. 88, when the external terminal 6 determines that the display assembly 20 is located on the second movable area 121B on the lens 12 based on the movement information, the external terminal 6 transmits the display content of the translation application corresponding to the second movable area 121B to the near-eye display apparatus 10.

When the display assembly 20 is magnetically connected to the lens 12, the position of the display assembly 20 on the lens 12 can be moved manually. The inertial measurement module 261 obtains the movement information of the display assembly 20 relative to the lens 12. The external terminal 6 determines the position of the movable area 121 where the display assembly 20 is located on the lens 12 based on the movement information, so as to achieve the display of different content on the external terminal 6. In some application scenarios, shaking of the user's head may cause movement of the display assembly 20 relative to the lens 12 even if the user does not intend to switch display content. In this case, the inertial measurement module 261 may still obtain the movement information of the display assembly 20 relative to the lens 12, which may cause the external terminal 6 to misjudge the position of the movable area 121 of the display assembly 20 on the lens 12 and switch display content, causing inconvenience to the user.

In an embodiment, as shown in FIG. 93, the sensing unit 206 further includes a touch detection module 262 electrically connected to the processor 202. The touch detection module 262 is configured to obtain touch operation information of the user on the display assembly 20 and transmit the touch operation information to the processor 202. Specifically, when a user holds the display assembly 20 and manually moves it, the touch detection module 262 is triggered, thereby enabling the touch detection module 262 to detect the user's touch operation information on the display assembly 20. When a preset condition is met, for example, when the processor 202 confirms that the user has manually moved the display assembly 20 based on the received touch operation information, the processor 202 sends a detection instruction to the inertial measurement module 261. The inertial measurement module 261 responds to the detection instruction to obtain the movement information of the display assembly 20 relative to the lens 12. Such arrangement enables the inertial measurement module 261 to detect the movement information of the display assembly 20 relative to the lens 12 only when it is detected that the user manually moves the display assembly 20 thereby reducing the probability of misjudging the position movement of the display component 20 and ensuring that the switching operation of the displayed content is consistent with the user's expectation.

Optionally, the touch detection module 262 includes one or both of a touch panel and an optical sensor. The touch panel may be mounted on the housing 211. At least a partial area of the touch panel is located on the outer surface of the housing 211, so that the user can touch the touch panel when holding and moving the display assembly 20 manually, thereby enabling the touch panel accordingly to detect the user's touch operation information on the display assembly 20. The optical sensor may be a sensor based on the photoelectric effect, which converts changes in optical signals into changes in electrical signals, thereby enabling the detection of touch operation information. Specifically, the optical sensor may be a reflective photoelectric sensor, including a light source and a photoelectric element. The light source is mounted in the housing 211, and a partial area of the housing 211 is configured as a light-transmitting area. The light-transmitting area is located at a position that the user can touch when manually moving the display assembly 20. Light emitted by the light source irradiates the light-transmitting area. When the user holds the light-transmitting area, the light emitted by the light source is reflected back to the photoelectric element due to the blockage. The photoelectric element detects the touch operation information by detecting the change in light intensity. Compared with other sensors, both the touch panel and the optical sensor have advantages such as mature process, high reliability and relatively low cost.

To address the challenges of insufficient display smoothness and display delay of the near-eye display apparatus 10, in an embodiment, the storage unit 204 is configured to store first display information, the communication unit 203 is configured to establish first communication connection with the external terminal 6. The first communication includes second display information from the external terminal 6. The processor 202 is configured to merge the first display information and the second display information to obtain third display information. The output unit 205 is configured to convert the third display information into optical output and project the optical output to the user side. Specifically, the first display information may be stored in a readable storage medium. The microdisplay 251 receives the third display information from the processor 202 and converts it into optical output. The optical module 252 receives the optical output and transmits it to the user side for the user to view.

In the near-eye display apparatus 10 provided by the present disclosure, the display assembly 20 includes the processor 202, the communication unit 203, the storage unit 204 and the output unit 205. The output unit 205 converts the third display information into optical output and projects it to the user. The third display information is obtained by the processor 202 merging the first display information and the second display information. That is, the third display information is divided into the first display information and the second display information. The first display information may be pre-stored in the storage unit 204, and the second display information comes from the external terminal 6. When the near-eye display apparatus 10 is displaying, only the second display information needs to be transmitted between the communication unit 203 and the terminal 6, which reduces the amount of data transmission between the communication unit 203 and the external terminal 6. Under the same bandwidth condition, the communication unit 203 can receive data from the external terminal 6 more quickly, thereby making the display of the near-eye display apparatus 10 smoother and reducing display delay.

In an embodiment, the first display information includes previously displayed data, and the second display information includes subsequently displayed data. Specifically, taking display content of a video application as an example, the first display information includes video data corresponding to earlier playback time, and the second display information includes video data corresponding to later playback time. The video data with the earliest playback time is pre-stored in the storage unit 204. When the near-eye display apparatus 10 is displaying, the communication unit 203 and the external terminal 6 only need to transmit the video data with the latest playback time, which reduces the amount of data transmission between the communication unit 203 and the external terminal 6, thereby making the display of the near-eye display apparatus 10 smoother and reducing display delay.

In an embodiment, the first display information includes image or text data that does not change with display time, and the second display information includes image or text data that changes with display time during the display process. For example, when information display of a navigation application of the external terminal 6 is required, the first display information may include fixed navigation icons that do not change with display time, and the second display information may include navigation content that changes that changes with display time during the display process. For another example, when information display of a translation application of the external terminal 6 is required, the first display information may include shared menu icons of the translation application that do not change with display time, and the second display information may include specific translated content that changes with display time during the display process. With such configuration, image or text data that does not change with display time is pre-stored in the storage unit 204. When the near-eye display apparatus 10 is displaying, the communication unit 203 and the external terminal 6 only need to transmit image or text data that changes with display time during the display process, which reduces the amount of data transmission between the communication unit 203 and the external terminal 6, thereby making the display of the near-eye display device 10 smoother and reducing display delay.

In an embodiment, the third display information includes a graphical interface of an application program on the external terminal 6, the first display information includes static display information, and the second display information includes dynamic display information. The third display information includes the application graphical interface of the external terminal 6, so that the output unit 205 can display the application graphical interface corresponding to the movable area 121 when the display assembly 20 changes between various movable areas 121. This allows the user to quickly select a desired application and improves the usability of the near-eye display apparatus 10. The static display information may be data such as background image and background color when the application is displayed, while the dynamic display information may be data such as changing text or colors. Static display information is pre-stored in storage unit 204. When the near-eye display apparatus 10 is displaying, the communication unit 203 and the external terminal 6 only need to transmit dynamic display information, which reduces the amount of data transmission between the communication unit 203 and the external terminal 6, thereby making the display of the near-eye display device 10 smoother and reducing display delay.

Applications are usually iterated and upgraded. to improve user experience. Display information such as graphical interfaces and menu icons of applications may be changed during the upgrade. If the first display information stored in the storage unit 204 fails to match the second display information, it may be difficult to merge the first display information and the second display information to obtain the third display information, resulting in incorrect display of the near-eye display apparatus 10. In an embodiment, the communication unit 203 is configured to establish second communication with the external terminal 6. The second communication includes updated display information from the external terminal 6, and the updated display information is configured to replace at least part of the first display information. The storage unit 204 is configured to store the updated display information. By replacing at least part of the first display information with the updated display information, the first display information stored in the storage unit 204 can be matched with the second display information. Even if the application is iterated and upgraded, the first display information can still be merged with the second display information to obtain the third display information, ensuring that the near-eye display apparatus 10 can display correctly.

Optionally, in an embodiment, the second display information includes display content of the external terminal 6 generated based on the movement changes of the display assembly 20 relative to the movable areas 121. For example, as shown in FIG. 88, the first movable area 121A, the second movable area 121B and the third movable area 121C respectively correspond to display content of navigation, translation and video applications of the external terminal 6. Before the display assembly 20 moves, the display assembly 20 is located in the first movable area 121A. At this time, the external terminal 6 transmits display content of the navigation application of the external terminal 6 corresponding to the first movable area 121A to the near-eye display apparatus 10. When the display assembly 20 moves from the first movable area 121A to the second movable area 121B, the external terminal 6 transmits display content of the translation application of the external terminal 6 corresponding to the second movable area 121B to the near-eye display apparatus 10, thereby switching the display content of the near-eye display apparatus 10 from the navigation application to the translation application. Such configuration allows the display assembly 20 to display the content of the external terminal 6 corresponding to the movable area 121 when the display assembly 20 switches between different movable areas 121. The user can switch display content of the external terminal 6 directly via the near-eye display apparatus 10 without additional operation on the external terminal 6, improving the usability of the near-eye display apparatus 10.

Optionally, in an embodiment, the second display information further includes display content generated based on changes of movement information and movable areas 121. For example, as shown in FIG. 88, the first movable area 121A, the second movable area 121B and the third movable area 121C respectively correspond to navigation, translation and video applications of the external terminal 6. During the movement of the display assembly 20 from the first movable area 121A to the second movable area 121B, the external terminal 6 may transmit prompt information of switching from the navigation application to the translation application to the near-eye display apparatus 10. Exemplarily, the second display information may include text prompts such as “switching from navigation application to translation application”, or include icons of the navigation application and the translation application, enabling the user to timely aware that the movement operation will cause the display content of the near-eye display apparatus 10 to switch from the navigation application to the translation application. Such design allows the display assembly 20 to display the movement process of the display component 20 on the lens 12, making the movement process visual and providing real-time operation feedback to the user, thus improving the user experience.

To address the challenges of insufficient display smoothness and display delay of the near-eye display apparatus 10, as shown in FIG. 97 and FIG. 91, a near-eye display system 1000 provided by the present disclosure includes the above-described near-eye display apparatus 10 and a terminal 6. The near-eye display apparatus 10 is communicatively connected to the terminal 6. The terminal 6 is configured to establish first communication with the communication unit 203 of the near-eye display apparatus 10. The first communication includes the second display information transmitted from the terminal 6. The near-eye display apparatus 10 is configured to merge the pre-stored first display information and the second display information to obtain the third display information, convert the third display information into optical output, and project the optical output toward the user side.

The near-eye display system 1000 provided by the present disclosure includes a near-eye display apparatus 10 and a terminal 6. The near-eye display apparatus 10 is communicatively connected to the terminal 6. The third display information is divided into first display information and second display information. The first display information may be pre-stored in the near-eye display apparatus 10, and the second display information comes from the terminal 6. When the near-eye display apparatus 10 is displaying, only the second display information needs to be transmitted between the communication unit 203 and the terminal 6, which reduces the amount of data transmission between the communication unit 203 and the external terminal 6. Under the same bandwidth condition, the communication unit 203 can receive data from the terminal 6 more quickly, thereby making the display of the near-eye display apparatus 10 smoother and reducing display delay.

Referring to FIG. 15, in an embodiment, the terminal 6 may include an RF circuit 91, a memory 92, an input unit 93, a display unit 94, a sensor 95, an audio circuit 96, a wireless communication module 97, a processor 98, a power supply 99, and the like. The RF circuit 91, the memory 92, the input unit 93, the display unit 94, the sensor 95, the audio circuit 96 and the wireless communication module 97 are each electrically connected to the processor 98. The power supply 99 is configured to supply power to the terminal 6.

Specifically, the RF circuit 91 is configured to transmit and receive signals. The memory 92 is configured to store data and instruction information. The input unit 93 is configured for information input, and may specifically include a touch panel 931 and other input devices 932 such as operation keys. The display unit 94 may include a display panel 941. The sensor 95 includes an infrared sensor, a laser sensor and the like, and is configured to detect a user proximity signal, a distance signal and the like. A speaker 961 and a microphone 962 are connected to the processor 98 via the audio circuit 96 for transmitting and receiving an audio signal. The wireless communication module 97 is configured to transmit and receive a wireless communication signal to enable communication connection between the terminal 6 and the near-eye display apparatus 10. The processor 98 is configured to process data and information of the terminal 6. The above terminal structure merely only one embodiment of the present disclosure, and any other terminal capable of transmitting wireless communication signals shall fall within the protection scope of the present disclosure. The specific internal structure of the terminal will not be described in detail.

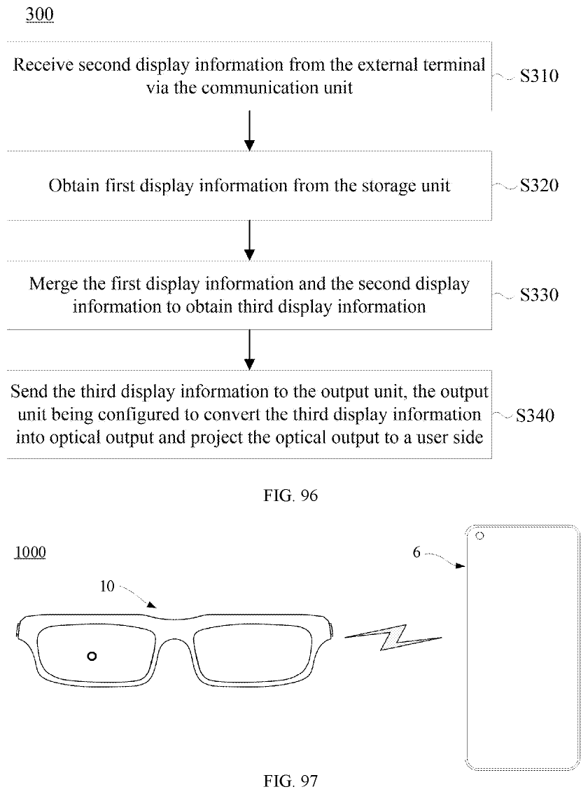

The present disclosure provides a control method for a near-eye display apparatus. The control method 300 is configured to control a near-eye display apparatus 10. The near-eye display apparatus 10 includes a lens 12 and a display assembly 20. The display assembly 20 is movably disposed on the lens 12. The display assembly 20 includes a housing 211, and a processor 202, a communication unit 203, a storage unit 204 and an output unit 205 arranged in the housing 211. The communication unit 203, the storage unit 204 and the output unit 205 are each electrically connected to the processor 202. The communication unit 203 is communicatively connected to an external terminal 6 via one or more communication modes of Bluetooth, ZigBee and 2.4G wireless communication. The control method 300 is executed by the processor 202. Referring to FIG. 96, the control method 300 includes steps S310 to S340.

S310: Receive second display information from the external terminal 6 via the communication unit 203.

Optionally, the second display information may include image or text data that changes with display time during a display process.

S320: Obtain first display information from the storage unit 204.

Optionally, the first display information includes image or text data that does not change with display time; or the first display information includes static display information.

S330: Merge the first display information and the second display information to obtain third display information.

S340: Send the third display information to the output unit 205, wherein the output unit 205 is configured to convert the third display information into optical output and project the optical output to a user side.

For the control method 300 provided by the present disclosure, the third display information is divided into first display information and second display information. The first display information is pre-stored in the storage unit 204, and the second display information is received via the communication unit 203. When the near-eye display apparatus 10 is displaying, only the second display information needs to be transmitted between the communication unit 203 and the external terminal 6, which reduces the amount of data transmission between the communication unit 203 and the external terminal 6. Under the same bandwidth condition, the communication unit 203 can receive data from the terminal 6 more quickly, thereby making the display of the near-eye display apparatus 10 smoother and reducing display delay.

The foregoing description merely illustrates exemplary embodiments of the present disclosure, and is not intended to limit the patent scope of the present disclosure. The specific embodiments described above are illustrative rather than restrictive. Inspired by the disclosure of the specification and accompanying drawings of the present disclosure, those skilled in the art may make various equivalent structural or procedural modifications, or directly or indirectly apply the technical solution to other related technical fields. All such variations and modifications shall fall within the patent protection scope of the present disclosure without departing from the spirit and scope defined by the claims.

What is claimed is:

1. A control method for a display module configured to be provided on an optical lens and output image content; the method comprising:
monitoring a motion state of the display module on a currently connected lens; and
controlling the display module to display a graphical interface corresponding to a target logical function on the lens when a target motion state is detected; wherein the target motion state is preset as a trigger condition for triggering the target logical function.

2. The method according to claim 1, wherein the target motion state comprises that movement of the display module on the lens satisfies a first preset condition; the target logical function comprises a first logical function; that the movement of the display module on the lens satisfies the first preset condition is preset as a trigger condition for triggering the first logical function; the step of controlling the display module to display the graphical interface corresponding to the target logical function on the lens when the target motion state is detected comprises:
controlling the display module to display the first graphical interface corresponding to the first logical function on the lens when it is detected that the movement of the display module on the lens satisfies the first preset condition.

3. The method according to claim 2, wherein the first preset condition comprises one or a combination of the following:
a displacement distance of the movement is no less than a preset first threshold length;
the displacement distance of the movement is no less than the preset first threshold length, and a displacement direction of the movement is a preset first direction;
the displacement distance of the movement is no less than the preset first threshold length, and a starting point of the movement is a preset first position, the first position being a fixed position selected on the lens;
the displacement distance of the movement is no less than the preset first threshold length, the displacement direction of the movement is the preset first direction, and the starting point of the movement is the first position;
an endpoint of the movement is a preset second position, the second position being a fixed position selected on the lens;
a shape similarity between a movement trajectory and a preset trajectory is no less than a preset first threshold.

4. The method according to claim 1, wherein the target motion state comprises that the display module is stationary at a third position on the lens, the third position being a fixed position selected on the lens; the target logical function comprises a second logical function; that the display module is stationary at the third position on the lens is preset as a trigger condition for triggering the second logical function; the step of controlling the display module to display the graphical interface corresponding to the target logical function on the lens when the target motion state is detected comprises:
controlling the display module to display a second graphical interface corresponding to the second logical function on the lens when it is detected that the display module is stationary at the third position on the lens.

5. The method according to claim 1, wherein the target motion state comprises that the display module rotates about an axis; the target logical function comprises a third logical function, and the third logical function is a logical function currently running in the foreground; the step of controlling the display module to display the graphical interface corresponding to the target logical function on the lens when the target motion state is detected comprises:
controlling the display module to update a target area in a third graphical interface currently displayed on the lens when it is detected that the display module rotates about the axis; wherein the third graphical interface is a graphical interface corresponding to the third logical function, and the target area is a graphical area corresponding to a sub-function of the third logical function; that the display module rotates about an axis is preset as a trigger condition for triggering the sub-function of the third logical function.

6. The method according to claim 5, wherein the step of controlling the display module to update the target area in the third graphical interface currently displayed on the lens when it is detected that the display module rotates about the axis comprises:
controlling the display module to update the target area in the third graphical interface currently displayed on the lens when it is detected that a rotation angle of the display module rotating about an axis is no less than a preset first threshold angle.

7. The method according to claim 1, wherein the method further comprises:
detecting contact on a touch portion of the display module;
the step of controlling the display module to display the graphical interface corresponding to the target logical function on the lens when the target motion state is detected comprises:
controlling the display module to display the graphical interface of the target logical function on the lens when a touch duration of the touch portion being touched is detected to be no less than a preset first threshold duration and the target motion state is detected.

8. The method according to claim 7, wherein the method further comprises:
activating an anti-false-touch mode when the touch duration of the touch portion being touched is detected to be no less than a preset second threshold duration and the display module is detected to remain stationary on the lens, or when it is not detected that the touch duration of the touch portion being touched is greater than or equal to a third threshold duration; wherein the anti-false-touch mode refers to a mode in which the display module is controlled to maintain, on the lens, displaying of a graphical interface corresponding to a logical function currently running in the foreground;
the first threshold duration is less than the second threshold duration.

9. The method according to claim 8, wherein the method further comprises:
deactivating the anti-false-touch mode when, under the anti-false-touch mode, it is detected again that the touch duration of the touch portion being touched is no less than a fourth threshold duration; wherein the fourth threshold duration is less than or equal to the first threshold duration.

10. The method according to claim 9, wherein the method further comprises:
outputting a prompt indicating that the anti-false-touch mode has been activated while the anti-false-touch mode is activated; and
outputting a prompt indicating that the anti-false-touch mode has been deactivated while the anti-false-touch mode is deactivated.

11. The method according to claim 7, wherein the method further comprises:
when it is detected that the display module is stationary on the lens and the touch portion is touched, controlling the display module to display movement prompt content around the display module on the lens.

12. The method according to claim 7, wherein the method further comprises:
when it is detected that the display module is stationary on the lens and the touch portion is touched according to a target touch mode, controlling the display module to display the graphical interface corresponding to the target logical function on the lens, or controlling the display module to update a target area in a third graphical interface currently displayed on the lens; wherein the third graphical interface is a graphical interface corresponding to a third logical function, the third logical function is a logical function currently running in the foreground, and the target area is a graphical area corresponding to a sub-function of the third logical function; the target touch mode is preset as a trigger condition for triggering the target logical function or a trigger condition for the sub-function of the third logical function.

13. The method according to claim 1, wherein the method further comprises:
obtaining multimedia data; and
when it is detected that the display module is stationary on the lens and a target instruction is identified from the multimedia data, controlling the display module to display the graphical interface corresponding to the target logical function on the lens, or controlling the display module to update a target area in a third graphical interface currently displayed on the lens; wherein the third graphical interface is a graphical interface corresponding to a third logical function, the third logical function is a logical function currently running in the foreground, and the target area is a graphical area corresponding to a sub-function of the third logical function; the target instruction is preset as a trigger condition for triggering the target logical function or a trigger condition for the sub-function of the third logical function.

14. The method according to claim 1, wherein the method further comprises:
obtaining eye tracking data; and
when it is detected that the display module is stationary on the lens and a target eye movement pattern is identified from the eye tracking data, controlling the display module to display the graphical interface corresponding to the target logical function on the lens, or controlling the display module to update a target area in a third graphical interface currently displayed on the lens; wherein the third graphical interface is a graphical interface corresponding to a third logical function, the third logical function is a logical function currently running in the foreground, and the target area is a graphical area corresponding to a sub-function of the third logical function; the target eye movement pattern is preset as a trigger condition for triggering the target logical function or a trigger condition for the sub-function of the third logical function.

15. The method according to claim 1, wherein the step of controlling the display module to display the graphical interface corresponding to the target logical function on the lens when the target motion state is detected comprises:
controlling the display module to display the graphical interface corresponding to the target logical function on the lens when the target motion state is detected within a preset display area on the lens;
the method further comprises:
activating a low-power mode when it is detected that the display module moves out of the preset display area.

16. A control apparatus for a display module, wherein the display module is configured to be connected to a lens of eyeglasses and configured to perform display on the connected lens; the control apparatus comprises:
a first monitoring module, configured to monitor a motion state of the display module on a currently connected lens; and
a first control module, configured to control the display module to display a graphical interface corresponding to a target logical function on the lens when a target motion state is detected; wherein the target motion state is preset as a trigger condition for triggering the target logical function.

17. The control apparatus according to claim 16, wherein the target motion state comprises that movement of the display module on the lens satisfies a first preset condition; the target logical function comprises a first logical function; that the movement of the display module on the lens satisfies the first preset condition is preset as a trigger condition for triggering the first logical function; the first control module comprises:
a first control sub-module, configured to control the display module to display the first graphical interface corresponding to the first logical function on the lens when it is detected that the movement of the display module on the lens satisfies the first preset condition.

18. The control apparatus according to claim 17, wherein the first preset condition is at least one of the following:
a displacement distance of the movement is no less than a preset first threshold length;
the displacement distance of the movement is no less than the preset first threshold length, and a displacement direction of the movement is a preset first direction;
the displacement distance of the movement is no less than the preset first threshold length, and a starting point of the movement is a preset first position, the first position being a fixed position selected on the lens;
the displacement distance of the movement is no less than the preset first threshold length, the displacement direction of the movement is the preset first direction, and the starting point of the movement is the first position;
an endpoint of the movement is a preset second position, the second position being a fixed position selected on the lens;
a shape similarity between a movement trajectory and a preset trajectory is no less than a preset first threshold.

19. The control apparatus according to claim 16, wherein the display module is stationary at a third position on the lens, the third position being a fixed position selected on the lens; the target logical function comprises a second logical function; that the display module is stationary at the third position on the lens is preset as a trigger condition for triggering the second logical function; the first control module comprises:
a second control sub-module, configured to control the display module to display a second graphical interface corresponding to the second logical function on the lens when it is detected that the display module is stationary at the third position on the lens.

20. A near-eye display device, wherein the near-eye display device comprises a processor and a memory; the memory stores a program or an instruction executable on the processor, and the program or the instruction, when executed by the processor, causes the processor to perform a control method for a display module; wherein, the method comprises:
monitoring a motion state of the display module on a currently connected lens; and
controlling the display module to display a graphical interface corresponding to a target logical function on the lens when a target motion state is detected; wherein the target motion state is preset as a trigger condition for triggering the target logical function.
